(19) United States
(12) Patent Application Publication
(10) Pub. No.: US 2026/0177521 A1
(43) Pub. Date: Jun. 25, 2026

(54) QUALITY METRIC AND METHODS OF USE THEREOF

(71) Applicant: ARIZONA BOARD OF REGENTS ON BEHALF OF ARIZONA STATE UNIVERSITY, Scottsdale, AZ (US)

(72) Inventors: Saivineeth Penukula, Tempe, AZ (US); Nicholas Rolston, Phoenix, AZ (US)

(21) Appl. No.: 19/423,281

(22) Filed: Dec. 17, 2025

Related U.S. Application Data
(60) Provisional application No. 63/736,078, filed on Dec. 19, 2024.

(51) Int. Cl. G01N 27/333; G01N 27/14

(52) U.S. Cl. CPC G01N 27/333; G01N 27/14

(57) ABSTRACT

The invention relates to material quality metrics and methods of use thereof. Mobile ion characteristics of a material are measured via administration of a stability test. The stability test comprises an assessment of current voltage characteristics and transient current response conducted at a series of temperatures with varying device architectures.

This application claims priority to U.S. Provisional Application No. 63/736,078 filed on Dec. 19, 2024, the entire contents of which are incorporated herein by reference.

### GOVERNMENT INTERESTS

This invention was made with government support under 2339233 awarded by the National Science Foundation. The government has certain rights in the invention.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records but otherwise reserves any and all copyright rights.

### FIELD OF THE INVENTION

The present invention relates to material quality metrics and methods of use thereof.

### BACKGROUND OF THE INVENTION

Metal-halide perovskites (MHPs) incorporated into perovskite solar cells (PSCs) have achieved significant commercial interest in the renewable energy market based on rapid PSC efficiency improvements achieving lab efficiencies of as high as 26.7%. However, ion migration that is both present intrinsically in the MHP or caused by extrinsic sources, such as by environmental stressors of heat and light is a concern. This affects the reliability and lifetime of the solar cells and limits their introduction to the market.

### SUMMARY OF THE INVENTION

A method for determining mobile ion characteristics of a material is described herein comprising attaching the material to a measurement device, wherein the measurement device is configured to administer a stability test to the material, wherein the first test assesses current voltage characteristics, wherein the second test measures transient current response, determining for each administration of the stability test a mobile ion concentration (Nₒ) of the material using information of the second test, iteratively administrating the stability test at a series of temperatures increasing at intervals until detecting the material's transition to a failed state using information of the administered stability tests, and identifying at least one of the temperature and corresponding mobile ion concentration (Nₒ) at transition to the failed state as a threshold operating condition of the material.

In embodiments, each stability test is conducted in a forward bias configuration.

In embodiments, the first test is conducted at a voltage range of 0-1.5 volts.

In embodiments, the first test is conducted over a sweep of three light intensity values of 0%, 50%, and 100%.

In embodiments, the second test is conducted at light intensity of zero.

In embodiments, the second test comprises sweep offset voltage values of 0, 0.8, and 0.

In embodiments, the second test is conducted using a light pulse length of 10 milliseconds with a follow up and settling time of 1 millisecond each.

In embodiments, the first temperature of the series comprises room temperature.

In embodiments, the interval of increase comprises 10 degrees Kelvin.

In embodiments, the determining the mobile ion concentration (Nₒ) comprises isolating a negative current response in the transient current response graph.

In embodiments, the determining the mobile ion concentration (Nₒ) comprises replotting the negative current response graph to plot drift current by time.

In embodiments, the determining the mobile ion concentration (Nₒ) comprises integrating the replotted graph to determine ionic charge (Qᵢₒₙ).

In embodiments, the determining the mobile ion concentration (Nₒ) comprises solving the following equation:

$${Q}_{i o n} = \frac{\sqrt{q {N}_{o} {ε}_{o} {ε}_{r} {V}_{T}}}{8} * [ \sqrt{1 + 16 * ( \frac{{V}_{b i}}{{V}_{T}} )} - \sqrt{1 + 16 * \frac{{V}_{b i} - {V}_{a p p}}{{V}_{T}}} ]$$

wherein q comprises electronic charge,
wherein εₒ comprises permittivity of free space,
wherein εᵣ comprises permittivity of material,
wherein V_{T} comprises thermal voltage (0.026),
wherein V_{bi} comprises built in potential (1.2V), and
wherein Vₐₚₚ comprises applied bias (0.8V).

In embodiments, the failed state comprises a current (mA)/voltage (V) plot with substantially constant slope.

In embodiments, the failed state comprises a square wave current (mA)/time (μS) plot.

In embodiments, the stability test comprises a third test, wherein the third test is a repeat of the first test, wherein the third test assesses changes in the material's current voltage characteristics after administration of the second test, wherein the third test comprises a repeat of the first test, wherein the detecting the material's transition to a failed state uses information of the third test.

In embodiments, the material comprises a perovskite solar cell.

In embodiments, the material comprises a memristor.

In embodiments, the material comprises mining ore.

In embodiments, the material comprises battery material.

### BRIEF DESCRIPTION OF THE FIGURES

FIG. 1A shows a non-limiting, exemplary diagram of top electrode chemistry on ion migration in control PSC device stack structure in p-i-n configuration with Ag, Au, and C top electrode on the same substrate.

FIG. 1B shows a non-limiting, exemplary diagram of device stack structure of PSCs with a barrier layer between the Ed and top electrode is the SnO₂ PSC with SnO₂ barrier layer.

FIG. 1C shows a non-limiting, exemplary diagram of device stack structure of PSCs with a barrier layer between the Ed and top electrode is the O₃—SnO₂ PSC with ozone nucleated SnO₂ barrier layer.

FIG. 1D shows a non-limiting, exemplary initial Nₒ measurements for control PSC, SnO₂ PSC, and O₃—SnO₂ PSC with Ag, Au, and C top electrodes.

FIG. 2A shows a non-limiting, exemplary graph of percentage change in Nₒ for control PSC, SnO₂ PSC, and O₃—SnO₂ PSC with Ag top electrodes after exposure of the PSCs to 50° C. for 120 h.

FIG. 2B shows a non-limiting, exemplary graph of change in RBS atomic concentration of Ag after aging in the MHP layer and ETL for control PSC, along with barrier layer for SnO₂ PSC, and O₃—SnO₂ PSC.

FIG. 3A shows a non-limiting, exemplary device stack structure in p-i-n configuration for control and SAM-based PSC with an HTL of NiOx and SAM respectively.

FIG. 3B shows a non-limiting, exemplary device stack structure in p-i-n configuration for SnO₂ PSC and O₃—SnO₂ PSC with a barrier layer of SnO₂ and O₃—SnO₂ respectively between ETL and the top electrode.

FIG. 3C shows a non-limiting, exemplary graph of Nₒ of PSCs versus temperature, showing threshold operating points of the devices at higher temperatures and also the threshold in Nₒ for operation.

FIG. 4A shows non-limiting, exemplary X-ray diffraction plots in q-space at incidence angles 0.3° (representing the top surface) and 5° (representing the bulk) of unaged control PSC.

FIG. 4B shows non-limiting, exemplary X-ray diffraction plots in q-space at incidence angles 0.3° (representing the top surface) and 5° (representing the bulk) of unaged SnO₂ PSC.

FIG. 4C shows non-limiting, exemplary X-ray diffraction plots in q-space at incidence angles 0.3° (representing the top surface) and 5° (representing the bulk) of unaged O₃—SnO₂ PSC.

FIG. 4D shows non-limiting, exemplary X-ray diffraction plots in q-space at incidence angles 0.3° (representing the top surface) and 5° (representing the bulk) of control PSC subjected to 50° C. for 120 h.

FIG. 4E shows non-limiting, exemplary X-ray diffraction plots in q-space at incidence angles 0.3° (representing the top surface) and 5° (representing the bulk) of SnO₂ PSC subjected to 50° C. for 120 h.

FIG. 4F shows non-limiting, exemplary X-ray diffraction plots in q-space at incidence angles 0.3° (representing the top surface) and 5° (representing the bulk) of O₃—SnO₂ PSC subjected to 50° C. for 120 h.

FIG. 5 shows non-limiting, exemplary graphs of percentage change in Nₒ for control PSC, SnO₂ PSC, and O₃—SnO₂ PSC with C, Ag, and Au top electrodes after exposure of the PSCs to 50° C. for 120 h.

FIG. 6 shows non-limiting, exemplary graphs of percentage change in Nₒ for control PSC, SnO₂ PSC, and O₃—SnO₂ PSC with C, Ag, and Au top electrodes after exposure of the PSCs to 50° C. for 120 h.

FIG. 7 shows non-limiting, exemplary graphs of Nₒ for control PSC, SnO₂ PSC, and O₃—SnO₂ PSC with C, Ag, and Au top electrodes before and after exposure of the PSCs to 50° C. for 120 h.

FIG. 8A shows non-limiting, exemplary RBS spectra of control PSCs with experimental spectra and SIMNRA simulation fits of unaged control PSC.

FIG. 8B shows non-limiting, exemplary RBS spectra of control PSCs with experimental spectra and SIMNRA simulation fits of aged control PSC.

FIG. 9A shows non-limiting, exemplary RBS spectra of SnO₂ PSCs with experimental spectra and SIMNRA simulation fits of unaged control PSC.

FIG. 9B shows non-limiting, exemplary RBS spectra of SnO₂ PSCs with experimental spectra and SIMNRA simulation fits of aged SnO₂ PSC.

FIG. 10A shows non-limiting, exemplary RBS spectra of O₃—SnO₂ PSCs with experimental spectra and SIMNRA simulation fits of unaged control PSC.

FIG. 10B shows non-limiting, exemplary RBS spectra of O₃—SnO₂ PSCs with experimental spectra and SIMNRA simulation fits of aged O₃—SnO₂ PSC.

FIG. 11 shows a non-limiting, exemplary graph of unaged vs aged atomic concentration of iodine (I) as determined using RBS in the MHP layer, BCP layer, and Ag layer for control PSC.

FIG. 12A shows non-limiting, exemplary graphs of IV response over temperature sweep from 300K to 450K of Control PSC.

FIG. 12B shows non-limiting, exemplary graphs of IV response over temperature sweep from 300K to 450K of SAM-based PSC.

FIG. 12C shows non-limiting, exemplary graphs of IV response over temperature sweep from 300K to 450K of SnO₂ PSC.

FIG. 12D shows non-limiting, exemplary graphs of IV response over temperature sweep from 300K to 450K of O₃—SnO₂ PSC.

FIG. 13A shows a non-limiting, exemplary device stack structure used for the performance measurements of Control PSC.

FIG. 13B shows a non-limiting, exemplary device stack structure used for the performance measurements of SnO₂ PSC.

FIG. 13C shows a non-limiting, exemplary device stack structure used for the performance measurements of O₃—SnO₂ PSC.

FIG. 13D shows a non-limiting, exemplary graph of Nₒ of PSCs versus temperature.

FIG. 14A shows a non-limiting, exemplary graph of IV response over temperature sweep from 300K to 450K of Control PSC.

FIG. 14B shows a non-limiting, exemplary graph of IV response over temperature sweep from 300K to 450K of SnO₂ PSC.

FIG. 14C shows a non-limiting, exemplary graph of IV response over temperature sweep from 300K to 450K of O₃—SnO₂ PSC.

FIG. 15 shows a non-limiting, exemplary graph of Nₒ vs time for control PSC with and without BCP layer after being exposed to a heat of 50° C. for 120 hours.

FIG. 16A shows a non-limiting, exemplary graph of Temperature-dependent responses of PSCs in the range of 300K to 450K. Light JV response of O₃—SnO₂ PSC.

FIG. 16B shows a non-limiting, exemplary graph of temperature-dependent responses of PSCs in the range of 300K to 450K. Light JV response of O₃—SnO₂ PSC.

FIG. 16C shows a non-limiting, exemplary graph of temperature-dependent responses of PSCs in the range of 300K to 450K. O₃—SnO₂ PSC vs control PSC PCE.

FIG. 16D shows a non-limiting, exemplary graph of temperature-dependent responses of PSCs in the range of 300K to 450K. O₃—SnO₂ PSC vs control PSC V_{OC}.

FIG. 16E shows a non-limiting, exemplary graph of temperature-dependent responses of PSCs in the range of 300K to 450K. O₃—SnO₂ PSC vs control PSC J_{SC}.

FIG. 16F shows a non-limiting, exemplary graph of temperature-dependent responses of PSCs in the range of 300K to 450K. O₃—SnO₂ PSC vs control PSC FF.

FIG. 17A shows a non-limiting, exemplary graph of temperature-dependent responses of O₃—SnO₂ PSC in the range of 300K to 450K of EQE.

FIG. 17B shows a non-limiting, exemplary graph of temperature-dependent responses of O₃—SnO₂ PSC in the range of 300K to 450K of EQE zoomed in.

FIG. 17C shows a non-limiting, exemplary graph of temperature-dependent responses of O₃—SnO₂ PSC in the range of 300K to 450K of the Bandgap.

FIG. 18 shows a non-limiting, exemplary graph of Nₒ vs PCE of O₃—SnO₂ and control PSC in the range of 300K-450K.

FIG. 19 shows a non-limiting, exemplary graph of Activation energy (E_{A}) with R² values of Control PSC, O₃—SnO₂ PSC, and SAM-based PSC.

FIG. 20A shows a non-limiting, exemplary graph of activation energy fits of Control PSC.

FIG. 20B shows a non-limiting, exemplary graph of activation energy fits of O₃—SnO₂ PSC.

FIG. 20C shows a non-limiting, exemplary graph of activation energy fits of SAM-based PSC.

FIG. 21 shows a non-limiting, exemplary transient dark current measurement (TDC) showing the applied voltage to the device and the transient current response recorded with isolated peaks of diffusion current and drift current.

FIG. 22 shows a non-limiting, exemplary schematic of Rutherford Backscattering Spectroscopy (RBS) setup for target characterization.

FIG. 23 shows a non-limiting, exemplary reduced chi-square vs Ag concentration graph.

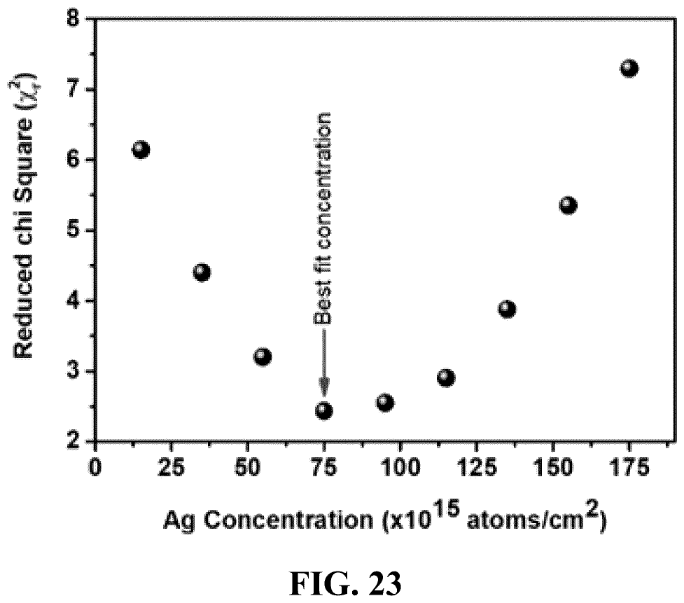

FIG. 24 shows a non-limiting, exemplary photo of PAIOS (an all-in-one characterization equipment for the solar cells, batteries, and OLEDs) which can be used to make the measurements on the sample.

FIG. 25 shows a non-limiting, exemplary image of instructions to switch on the equipment (equipment-specific steps) and open characterization suite 4.4 (software used to connect with the PAIOS equipment).

FIG. 26 shows a non-limiting, exemplary image of the experiment list tab.

FIG. 27 shows a non-limiting, exemplary image of the measurement types of an embodiment.

FIG. 28 shows a non-limiting, exemplary image of the measurement parameters of an embodiment.

FIG. 29 shows a non-limiting, exemplary image of measurement parameters and output of an embodiment.

FIG. 30 shows non-limiting, exemplary graphs of a good transient dark current response and corresponding dark IV response.

FIG. 31 shows non-limiting, exemplary graphs of a bad transient dark current response and corresponding dark IV response.

FIG. 32 shows a non-limiting, exemplary text file copied into Ion migration calculator.

FIG. 33 shows non-limiting, exemplary graph, diagram, and data of mobile ion concentration calculated using transient dark current measurements.

FIG. 34 shows a non-limiting, exemplary photo of the temperature-controlled stage attached to PAIOS with sample placed on stage.

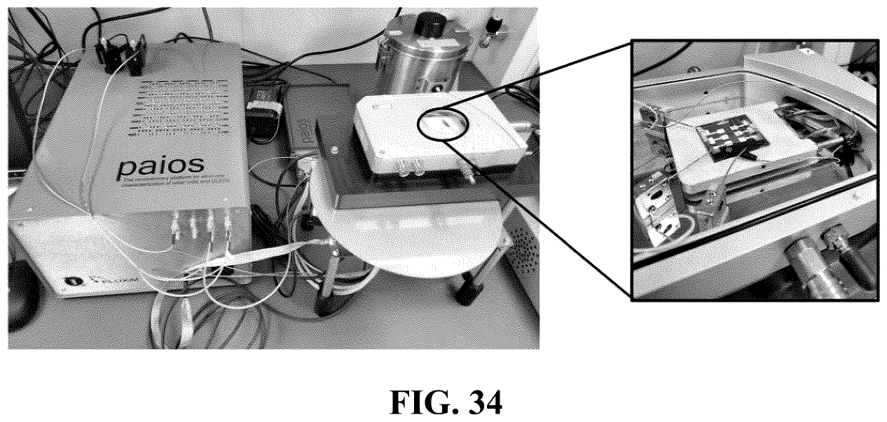

FIG. 35 shows non-limiting, exemplary data output for PAIOS series measurement.

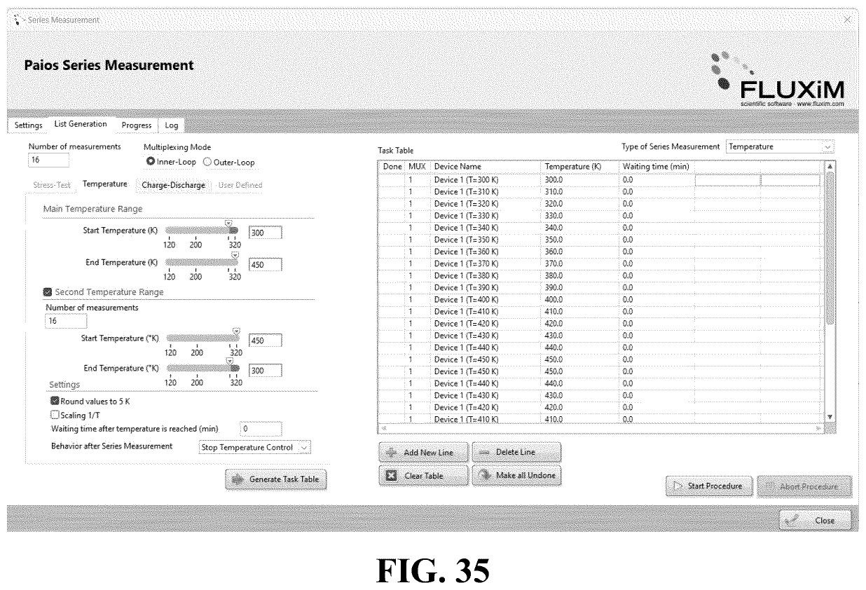

FIG. 36 shows non-limiting, exemplary recipe for measurement of an embodiment.

FIG. 37 shows a non-limiting, exemplary sample Nyquist plot.

FIG. 38 shows a non-limiting, exemplary sample equivalent circuit fit.

FIG. 39 shows a non-limiting, exemplary recipe adapted from “Jordi Sastre et. al., Blocking lithium dendrite growth in solid-state batteries with an ultrathin amorphous Li—La—Zr—O solid electrolyte, Commun Mater 2, 76 (2021). https://doi.org/10.1038/s43246-021-00177-4”.

FIG. 40 shows a non-limiting, exemplary transient current response used to calculate the mobile ion concentration.

FIG. 41A shows non-limiting, exemplary ligand structures BAI, 4TmI, and Br4TmI.

FIG. 41B shows a non-limiting, exemplary schematic of the as-formed 2D RP phase perovskite.

FIG. 41C shows non-limiting, exemplary XRD spectra tracking of 2D perovskite thin films for (BA)₂PbI₄ at 85° cheating under light illumination in air (RH %=68%).

FIG. 41D shows non-limiting, exemplary XRD spectra tracking of 2D perovskite thin films for (4Tm)₂PbI at 85° cheating under light illumination in air (RH %=68%).

FIG. 41E shows non-limiting, exemplary XRD spectra tracking of 2D perovskite thin films for (Br4Tm)₂PbI at 85° cheating under light illumination in air (RH %=68%).

FIG. 41F shows non-limiting, exemplary UV-vis spectra tracking of 2D perovskite thin films for (BA)₂PbI₄ at 85° C. heating under light illumination in air (RH %=68%).

FIG. 41G shows non-limiting, exemplary UV-vis spectra tracking of 2D perovskite thin films for (4Tm)₂PbI₄ at 85° C. heating under light illumination in air (RH %=68%).

FIG. 41H shows non-limiting, exemplary UV-vis spectra tracking of 2D perovskite thin films for (Br4Tm)₂PbI at 85° C. heating under light illumination in air (RH %=68%).

FIG. 42A shows a non-limiting, exemplary graph of fracture energy of (4Tm)₂PbI₄, (Br4Tm)₂PbI₄, and (BA)₂PbI₄2D MHP films, compared to 3D MHPs, insets are representative sample photographs taken after measurements.

FIG. 42B shows non-limiting, exemplary schematic illustrations of samples and fracture propagation for fracture energy measurement using double cantilever beam (DCB) method.

FIG. 43A shows a non-limiting, exemplary schematic illustration of perovskite solar cell configurations and mobile ion concentration measurement.

FIG. 43B shows a non-limiting, exemplary graph of statistics of PCE based on devices without interlayers, with BAI-2D, with 4TmI-2D, with Br4TmI-2D interlayers. Statistics are from 16 devices.

FIG. 43C shows a non-limiting, exemplary graph of mobile ion concentration (Nₒ) evolution under 85° C. heat exposure.

FIG. 43D shows a non-limiting, exemplary graph of mobile ion concentration (Nₒ) evolution under light exposure.

FIG. 43E shows a non-limiting, exemplary graph of device PCE evolution under 85° C. heat exposure.

FIG. 43F shows a non-limiting, exemplary graph of device PCE evolution under light exposure.

FIG. 44A shows non-limiting, exemplary photographs of spin-coated 2D perovskite films.

FIG. 44B shows a non-limiting, exemplary photograph of an experimental set-up for 2D perovskite stability tracking under 85° C. heating+light (1 sun)+air (Relative Humidity (RH) %=68%).

FIG. 45 shows a non-limiting, exemplary enlarged XRD spectrum view of (BA)₂PbI₄2D perovskite before and after 85° C. heating+light (1 sun) in air for 15 min. New peak at 12.65° is attributed to PbI2. This is only observed in (BA)₂PbI₄2D perovskite films. (4Tm)₂PbI₄ and (Br4Tm)₂PbI₄2D perovskite films did not show any PbI2 signal because they were still stable after the stress tests.

FIG. 46 shows non-limiting, exemplary loading-unloading curves of G_{c} test for 4TmI 2D thin films specimens, 4 repeated experiments.

FIG. 47 shows non-limiting, exemplary 4Tm 2D MHP thin film specimen after G_{c} measurement, with microscope images on both sides.

FIG. 48 shows non-limiting, exemplary loading-unloading curves of G_{c} test for Br4TmI 2D thin films specimens, 4 repeated experiments.

FIG. 49 shows non-limiting, exemplary Br4TmI 2D MHP thin film specimen after G_{c} measurement, with microscope images on both sides.

FIG. 50 shows non-limiting, exemplary loading-unloading curves of G_{c} test for BAI 2D thin films specimens, 3 repeated experiments.

FIG. 51 shows non-limiting, exemplary BAI 2D MHP thin film specimen after G_{c} measurement, with microscope images on both sides.

FIG. 52A shows a non-limiting, exemplary SEM image of 2D (BA)₂PbI₄ thin films coated on ITO/SnO₂.

FIG. 52B shows a non-limiting, exemplary SEM image of 2D (BA)₂PbI₄ thin films coated on ITO/SnO₂.

FIG. 52C shows a non-limiting, exemplary SEM image of 2D (Br4Tm)₂PbI₄ thin films coated on ITO/SnO₂.

FIG. 52D shows a non-limiting, exemplary SEM image of 2D (4Tm)₂PbI₄ thin films coated on ITO/SnO₂.

FIG. 53A shows a non-limiting, exemplary UV-vis spectrum of the perovskite materials in devices.

FIG. 53B shows a non-limiting, exemplary photoluminescence spectrum of the perovskite materials in devices.

FIG. 54A shows non-limiting, exemplary J-V curves of control, BAI, 4TmI, Br4TmI.

FIG. 54B shows non-limiting, exemplary device parameters of control, BAI, 4TmI, Br4TmI.

FIG. 55 shows non-limiting, exemplary representative J-V curves of control devices, with both reverse and forward scan.

FIG. 56 shows non-limiting, exemplary representative J-V curves of BAI devices, with both reverse and forward scan.

FIG. 57 shows non-limiting, exemplary representative J-V curves of 4TmI devices, with both reverse and forward scan.

FIG. 58 shows non-limiting, exemplary representative J-V curves of Br4TmI devices, with both reverse and forward scan.

FIG. 59A shows non-limiting, exemplary device statistics of PCE based on 16 devices.

FIG. 59B shows non-limiting, exemplary device statistics of FF based on 16 devices.

FIG. 59C shows non-limiting, exemplary device statistics of VOC based on 16 devices.

FIG. 59D shows non-limiting, exemplary device statistics of JSC based on 16 devices.

FIG. 60A shows non-limiting, exemplary Nₒ VS PSC with aging for 192 h when subjected to 85° C. heat showing the least change in Nₒ for PSC with 4Tml 2D interlayer based on the clustering of Nₒ.

FIG. 60B shows non-limiting, exemplary Nₒ VS PSC with aging for 192 h when subjected to 1-Sun light showing the least change in Nₒ for PSC with Br4Tml 2D interlayer and second least change in Nₒ for PSC with 4Tml 2D interlayer based on the clustering of Nₒ.

FIG. 61 shows a non-limiting, exemplary graph of activation energy of the PSCs with R-square values.

FIG. 62A shows a non-limiting, exemplary activation energy fit of control PSC.

FIG. 62B shows a non-limiting, exemplary activation energy fit of PSC with Br4TmI 2D interlayer.

FIG. 62C shows a non-limiting, exemplary activation energy fit of PSC with BAI 2D interlayer.

FIG. 62D shows a non-limiting, exemplary activation energy fit of PSC with 4TmI 2D interlayer.

FIG. 63A shows non-limiting, exemplary In-situ Ionic measurements vs Temperature of control PSC mobile ion concentration.

FIG. 63B shows non-limiting, exemplary In-situ Ionic measurements vs Temperature of control PSC ionic conductivity. c) ionic mobility

FIG. 63C shows non-limiting, exemplary In-situ Ionic measurements vs Temperature of control PSC ionic mobility.

FIG. 64A shows non-limiting, exemplary In-situ Ionic measurements vs Temperature of PSC with Br4Tml 2D interlayer mobile ion concentration.

FIG. 64B shows non-limiting, exemplary In-situ Ionic measurements vs Temperature of PSC with Br4Tml 2D interlayer ionic conductivity.

FIG. 64C shows non-limiting, exemplary In-situ Ionic measurements vs Temperature of PSC with Br4Tml 2D interlayer ionic mobility.

FIG. 65A shows non-limiting, exemplary In-situ Ionic measurements vs Temperature of PSC with BAI 2D interlayer mobile ion concentration.

FIG. 65B shows non-limiting, exemplary In-situ Ionic measurements vs Temperature of PSC with BAI 2D interlayer ionic conductivity.

FIG. 65C shows non-limiting, exemplary In-situ Ionic measurements vs Temperature of PSC with BAI 2D interlayer ionic mobility.

FIG. 66A shows non-limiting, exemplary In-situ Ionic measurements vs Temperature of PSC with 4TmI 2D interlayer mobile ion concentration.

FIG. 66B shows non-limiting, exemplary In-situ Ionic measurements vs Temperature of PSC with 4TmI 2D interlayer ionic conductivity.

FIG. 66C shows non-limiting, exemplary In-situ Ionic measurements vs Temperature of PSC with 4TmI 2D interlayer ionic mobility.

FIG. 67A shows non-limiting, exemplary I-V response of pristine MAPbI₃ films with voltage applied from 0 to 1.5 V.

FIG. 67B shows non-limiting, exemplary transient dark current response of pristine MAPbI₃ films.

FIG. 67C shows non-limiting, exemplary I-V response after 24 h exposure at 85° C.

FIG. 67D shows non-limiting, exemplary transient dark current response after 24 h exposure at 85° C., where no ionic response is detectable after degradation.

FIG. 68 shows non-limiting, exemplary graph of Nₒ vs. time of Cs_{0.2}FA_{0.8}PbI₃ films after exposure to heat at 45 and 65° C. with black scatter points representing exposure to 45° C. and blue scatter points representing exposure to 65° C. respectively. An initial increase in Nₒ is observed due to vacancy activation with exposure to heat and an eventual decrease in Nₒ due to degradation of Cs_{0.2}FA_{0.8}PbI₃ films with exposure to heat for the temperatures 45 and 65° C., respectively. Inset—Device stack structure of Cs_{0.2}FA_{0.8}PbI₃ films in the form of ITO-Glass/MHP/solvent-C, with the arrows representing the contact points for probes and the signs representing polarity of the bias (forward bias).

FIG. 69 shows non-limiting, exemplary graph of Nₒ vs. temperature in the range of 230 to 340 K of PSCs with an Ag top electrode and solvent-free C top electrode. The PSC with C top electrode displayed lower Nₒ throughout the tested temperature range when compared to PSC with Ag top electrode. Inset—Top left—Device stack structure of PSC with Ag top electrode-ITO-Glass/Poly-TPD/PFN/Cs_{0.22}FA_{0.78}Pb(I_{0.85}Br_{0.15})₃+4% MAPbC₁₃/C₆₀/Ag, Bottom right—Device stack structure of PSC with C top electrode-ITO-Glass/SnO₂/Cs_{0.05}FA_{0.81}MA_{0.14}PbI_{2.55}Br_{0.45}/PEAI (2D MHP)/solvent-free C.

FIG. 70A shows non-limiting, exemplary graph of Nₒ vs. time of PSC after exposure to 65° C. for 72 h with grey scatter points representing Nₒ measured from Ag top electrode and black scatter points representing Nₒ measured from C top electrode on the same substrate with in-situ and ex-situ measurements having circle and square shapes respectively. The C top electrode displays lower and more consistent Nₒ values when compared to Ag top electrode throughout the tested period. Inset-Device stack structure of PSC-ITO-Glass/NiOx/MAPbI₃/C₆₀/Ag or C, both the electrodes are deposited on the same substrate.

FIG. 70B shows non-limiting, exemplary I-V response vs. time of the PSC when measured from the Ag top electrode showing degradation with aging.

FIG. 70C shows non-limiting, exemplary I-V response vs. time of the PSC when measured from the C top electrode showing good current response throughout the tested period.

FIG. 71A shows non-limiting, exemplary device stack structure of PSC used for Nₒ measurement. ITO-Glass/NiOₓ/MAPbI₃/C₆₀/Ag electrode. Arrows represent probe contact points while performing the measurement.

FIG. 71B shows non-limiting, exemplary device stack structure of PSC used for Nₒ measurement. ITO-Glass/NiOₓ/MAPbI₃/C₆₀/solvent or solvent-free C electrode. Arrows represent probe contact points while performing the measurement.

FIG. 71C shows non-limiting, exemplary graph of Gc vs. Nₒ of PSCs with C or Ag top electrodes showing lower Nₒ and higher Gc with Ag top electrode. Inset—Device stack structure (sandwich structure) used for Gc measurements—Glass/ITO/NiOₓ/MAPbI₃/C₆₀/Ag or C electrode/epoxy/glass.

FIG. 72 shows non-limiting, exemplary graph of Nₒ vs. composition of MHP thin films with black dotted line distinguishing Nₒ values of 3D and 2D perovskite compositions. Inset—Device stack structure of MHP thin films in the form of ITO-Glass/MHP/solvent C.

FIG. 73 shows non-limiting, exemplary Processing schematic of preheating, deposition, and annealing for forming CsPbI₃ films with PVP added into the precursor solution.

FIG. 74 shows non-limiting, exemplary graph of stress measurements of 0%-PVP (control), 3%-PVP, and 5%-PVP added into CsPbI₃, demonstrating reduced tensile residual stresses at 3%-PVP and compressive residual stresses at 5%-PVP. Post-IPA submersion for-PVP removal is also shown for 3%-PVP and 5%-PVP, demonstrating an increase in tensile stresses at 3%-PVP and a slight decrease in compression at 5%-PVP after submersion.

FIG. 75A shows non-limiting, exemplary PL responses for CsPbI₃ films aged under thermal cycling from—40 to 85° C. for 150 cycles with 50 cycle interval measurements with PVP concentrations of 3%.

FIG. 75B shows non-limiting, exemplary PL responses for CsPbI₃ films aged under thermal cycling from—40 to 85° C. for 150 cycles with 50 cycle interval measurements with PVP concentrations of 5%.

FIG. 75C shows non-limiting, exemplary PL responses for CsPbI₃ films aged under thermal cycling from—40 to 85° C. for 150 cycles with 50 cycle interval measurements with PVP concentrations of 3% submerged in IPA.

FIG. 75D shows non-limiting, exemplary PL responses for CsPbI₃ films aged under thermal cycling from—40 to 85° C. for 150 cycles with 50 cycle interval measurements with PVP concentrations of 5% submerged in IPA.

FIG. 75E shows non-limiting, exemplary PL responses of CsPbI₃ films aged under 1 sun of light induced aging for 96 h with 24-h interval measurements are shown with PVP concentrations of 3%.

FIG. 75F shows non-limiting, exemplary PL responses of CsPbI₃ films aged under 1 sun of light induced aging for 96 h with 24-h interval measurements are shown with PVP concentrations of 5%.

FIG. 75G shows non-limiting, exemplary PL responses of CsPbI₃ films aged under 1 sun of light induced aging for 96 h with 24-h interval measurements are shown with PVP concentrations of 3% submerged in IPA.

FIG. 75H shows non-limiting, exemplary PL responses of CsPbI₃ films aged under 1 sun of light induced aging for 96 h with 24-h interval measurements are shown with PVP concentrations of 5% submerged in IPA.

FIG. 76A shows non-limiting, exemplary graph of mobile ion concentration of 3% PVP-CsPbI₃ devices with aging under exposure to heat at 60° C. and exposure to light at 1.0 sun illumination for a period of 96 h with periodic measurements at 24-h mark for the devices without IPA submersion.

FIG. 76B shows non-limiting, exemplary graph of Mobile ion concentration of 3% PVP-CsPbI₃ devices with aging under exposure to heat at 60° C. and exposure to light at 1.0 sun illumination for a period of 96 h with periodic measurements at 24-h mark for the devices with IPA submersion.

FIG. 77 shows non-limiting exemplary visual representation of MHP thin films at different time stamps (24 h, 48 h, 72 h, 96 h) captured using a camera. These films were aged at 85° C. for a period of 96 h on a hot plate. The pictures show evident degradation in the MHP films in the form of yellowing even after aging for just 48 h. Hence it was decided that the temperature of 85° C. is too damaging for the MHP thin films.

FIG. 78 shows non-limiting exemplary photoluminescence (PL) plots of Cs_{0.2}FA_{0.8}PbI₃ films aged at 45° C. for a period of 96 h without a glass substrate on top. There is a visible redshift after aging in the films. However, there is no consistent change in the intensity with aging. Hence it was decided to place a glass substrate on top of the thin films to emulate a device-like structure. Panel A) PL after 24 h at 45° C. Panel B) PL after 48 h at 45° C. Panel C) PL after 72 h at 45° C. Panel D) PL after 96 h at 45° C.

FIG. 79 shows non-limiting exemplary PL plots of Cs_{0.2}FA_{0.8}PbI₃ films aged at 65° C. for a period of 96 h without a glass substrate on top. There is a visible redshift after aging in the films. However, there is no consistent change in the intensity with aging. Hence it was decided to place a glass substrate on top of the thin films to emulate a device-like structure. Panel A) PL after 24 h at 65° C. Panel B) PL after 48 h at 65° C. Panel C) PL after 72 h at 65° C. Panel D) PL after 96 h at 65° C.

FIG. 80 shows non-limiting exemplary PL plots of Cs0.2FA0.8PbI3 films aged at 45° C. for a period of 96 h with a glass substrate on top of them. Changes in the PL are much more consistent with a glass substrate on top of thin film while aging. Panel A) PL after 24 h at 45° C. Panel B) PL after 48 h at 45° C. Panel C) PL after 72 h at 45° C. Panel D) PL after 96 h at 45° C.

FIG. 81 shows non-limiting exemplary PL plots of Cs_{0.2}FA_{0.8}PbI₃ films aged at 65° C. for a period of 96 h with a glass substrate on top of them. Changes in the PL are much more consistent with a glass substrate on top of thin film while aging. Panel A) PL after 24 h at 65° C. Panel B) PL after 48 h at 65° C. Panel C) PL after 72 h at 65° C. Panel D) PL after 96 h at 65° C.

FIG. 82 shows non-limiting exemplary Ionic and electronic properties of PSCs with Ag electrode as shown in FIGS. 70A-70C after exposure to 65° C. for 72 hours Panel A) Mobile ion concentration (No) vs time Panel B) Ionic Conductivity (a) vs time Panel C) Ionic Mobility (μ) vs time Panel D) JSC vs time Panel E) VOC vs time Panel F) Fill Factor vs time

FIG. 83 shows film images of panel a) ITO/NiOx/CsPbI₃/C60/Ag devices, panel b) ITO/CsPbI₃/PMMA/epoxy/glass before thermal cycling aging, and panel c) ITO/CsPbI₃₋/PMMA/epoxy/glass after thermal cycling aging.

FIG. 84 shows microscopy images of varying concentrations of PVP in 0.6 M CsPbI₃ with panel a) 0% (Control), panel b) 3.4%, and c) 6.5% concentrations.

FIG. 85 shows tables of arithmetic mean heigh (Sa), maximum height (Sz), texture aspect ratio (Str), and arithmetic mean peak curvature of panel a) 0% (control), panel b) 3%, and panel c) 5% PVP in 0.8 M CsPbI₃.

FIG. 86 shows profilometry profile images of CsPbI₃ with concentrations of panel a) 0% (control), panel b) 3%, and panel c) 5% PVP.

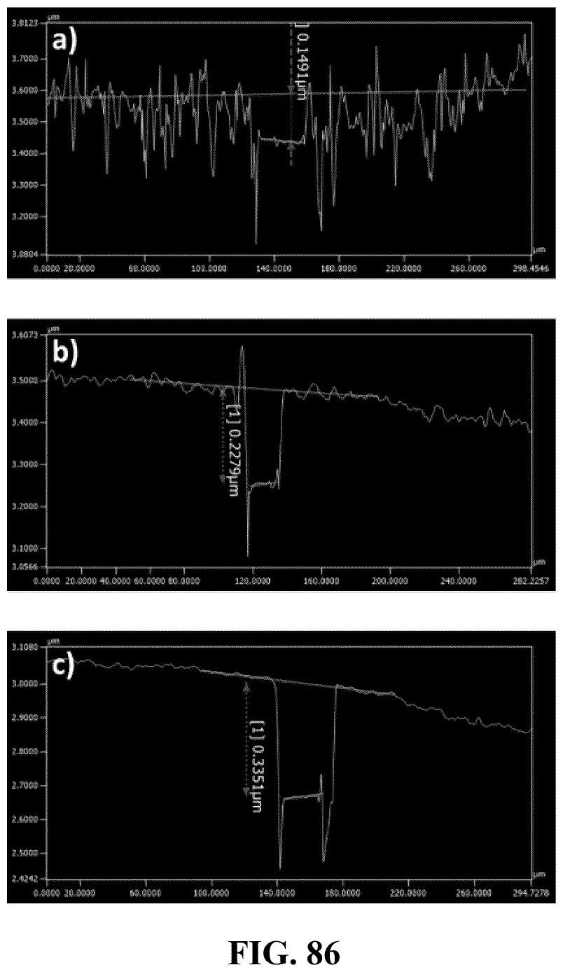

FIG. 87 shows External Radiative Efficiency of 0.6 M CsPbI₃ films of 3.4%, 6.5%, 12.3% PVP.

FIG. 88 shows Residual Stress measurements of 0.6 M CsPbI₃ films of 0% (control), 3.4%, 6.5%, 12.3% PVP and a comparison of black phase vs. yellow phase residual stresses when blade coated.

FIG. 89 shows PL responses for CsPbI₃ films on glass with thermal cycling aging from −40° C. to 85° C. for 150 cycles with 50 cycle interval measurements with PVP concentrations of panel a) 3%, panel b) 5%, panel c) 3% submerged in IPA, and panel d) 5% submerged in IPA. PL responses of CsPbI₃ films aged under 1 sun of light induced aging for 96 hours with 24-hour interval measurements are also shown with PVP concentrations of panel e) 3%, panel f) 5%, panel g) 3% submerged in IPA, panel h) 5% submerged in IPA.

FIG. 90 Table of ratios between 3%, 5%, 3% submerged in IPA, 5% submerged in IPA PVP CsPbI3₃ films for panel a) Thermal cycling on ITO, panel b) thermal cycling on glass, panel c) light induced aging on ITO, and panel d) light induced aging on glass.

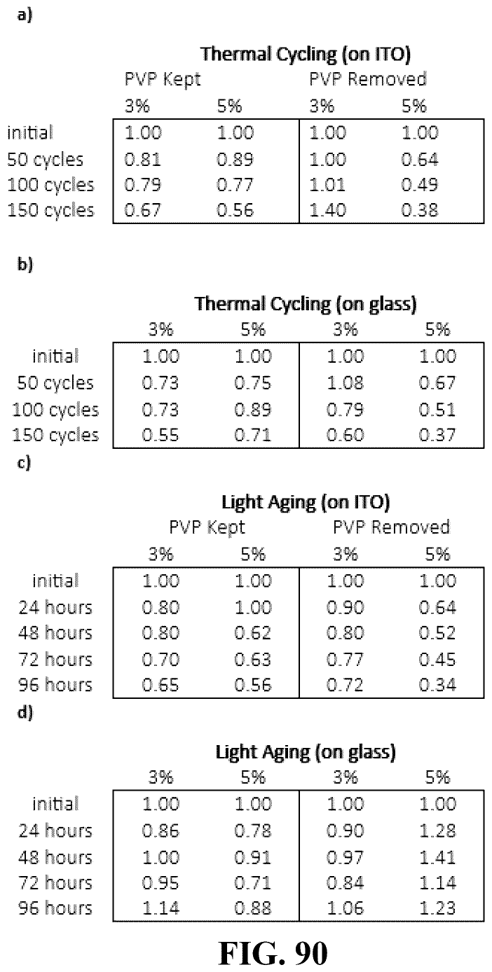

### DETAILED DESCRIPTION OF THE INVENTION

Detailed descriptions of one or more embodiments are provided herein. It is to be understood, however, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, it is to be understood that the disclosure is not necessarily limited in its application to the details set forth in the following description or exemplified by the examples. The disclosure is capable of other embodiments or of being practiced or carried out in various ways. Other compositions, compounds, methods, features, and advantages of the present disclosure will be or become apparent to one having ordinary skill in the art upon examination of the following drawings, detailed description, and examples. All such additional compositions, compounds, methods, features, and advantages can be included within this description, and be within the scope of the present disclosure.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### Barrier Layer Design Reduces Top Electrode Ion Migration in Perovskite Solar Cells

### Non-Limiting Summary

We report on an examination of mobile ion concentration (Nₒ) in perovskite solar cells (PSCs) as a function of temperature and device architecture. We find that lower initial Nₒ is correlated to devices with higher thermal performance through in-situ measurements up to 450K. Changes in Nₒ are observed upon thermal aging and are impacted by the changes made at the electron collecting interface. We examine the extent to which various top electrode materials (Ag, Au, carbon) impact Nₒ as well as the effects of tin oxide (SnO₂) or an ozone-nucleated SnO₂ (O₃—SnO₂) barrier layer between the ETL and top electrode. Upon thermal aging, we confirm the involvement of Ag ion diffusion through the ETL dependent on the device details. We are able to quantify the degree to which Ag ions migrate or are blocked from migrating into the underlying device layers in the PSC stack. X-ray scattering shows improved suppression of the degradation products formed in the bulk of the perovskite when a blocking layer, particularly the O₃—SnO₂ is employed.

### Broader Context

Ion migration is one of the important factors that affect the operational lifetime and stability of perovskite solar cells (PSCs). Even though different methodologies have been employed to show the effects of ion migration, the techniques are varied and often qualitative. Furthermore, there is no simple, quantitative method that provides a consistent correlation to the stability of PSCs. This work shows that mobile ion concentration (Nₒ) can be correlated to PSC stability in state-of-the-art devices. Nₒ is a metric that can serve as a consistent and straightforward approach to quantifying migration-related degradation modes on PSC stability.

### INTRODUCTION

Metal-halide perovskite (MHP) solar cells have achieved significant commercial interest in the renewable energy market based on rapid efficiency improvements(1,2) achieving lab efficiencies of 26.7%.(3) Additional advantages include the use of earth-abundant precursors, affordable manufacturing, and tunability of optoelectronic properties.(4-7) However, the ion migration and chemical reactions observed under the influence of environmental stressors such as heat and light are a concern.(8,9) The pace of perovskite solar cell (PSC) advances has made it difficult for field testing studies to keep pace with reports in excess of 10000 h limited to older devices and architectures.(10) Limited field lifetimes (<1 year) for the majority of PSC modules tested by the perovskite PV accelerator for commercializing technologies (PACT)(11) indicates this challenge of demonstrating sufficient reliability to bring PSCs to market. This rapid development cycle creates a need for more rapid testing methods and metrics as well as mechanistic insight related to stability and reliability issues in PSCs. Of the variety of mechanisms believed to be responsible for a change in efficiency in operation, without wishing to be bound by theory, ion migration can be a primary cause of this degradation via phase separation and reactions with charge transport layers. While these correlations have been identified, the mechanism that ultimately leads to electronic losses and irreversible corrosion of electrodes is still being revealed.(12-15) Here we undertake studies to examine changes in mobile species and how these relate to device stability. Specifically, we use our previously reported measurement approach to study the change in mobile ion concentration (Nₒ). These measurements are sensitive to mobile charges induced directly or indirectly by mobile ions and chemical reactions, providing a basis from which to see how this changes as devices are stressed, and subsequently examine the specific origins of degradation for a given device architecture.

Recent work has shown that the top metal electrodes in PSCs spontaneously react(15) or can react under electrochemical(16,17) or photochemical stress.(18) One strategy to prevent reactions and the formation of mobile ions is to employ a physical barrier layer.(19) However, this barrier layer must be of very high quality (i.e. chemically stable and pinhole-free) to be effective. The best barrier layers can be created by atomic layer deposition (ALD) of metal oxides such as SnO₂ on top of the fullerene-based electron transport layer (ETL) in the p-i-n structure of PSCs.(20) The barrier properties of ALD oxides are further enhanced by ozone-nucleation (O₃) of the SnO₂ by exposing the C₆₀ layer to ozone through an ultrathin (˜5 nm)non-conformally grown SnO₂ which functionalizes C₆₀ to better nucleate subsequent ALD growth and enable more robust internal barriers in PSCs that can prevent chemical reactions and block the motion of ions, water vapor, and solvents.(20) The deposition of the ozone-nucleated barrier layers does not induce any new degradation modes observed under light and heat testing with T₉₀ lifetimes of 500 h and 575 h for PSCs with SnO₂ and O₃—SnO₂ layers, respectively, at 65° C. under approximately 1-sun illumination and quasi-maximum power point (quasi-MPP) set by a static load resistor (ISOS-L2-2I).(20) Furthermore, this 03 nucleation approach was also shown to reduce the water-vapor transmission rate through the barrier layer and reduce gas, solvent, and halide migration, in turn enhancing PSC stability compared to control devices(20) as well as the mechanical robustness of PSCs compared to SnO₂.(21)

Ion migration in PSCs can be quantified in terms of Nₒ, which is defined as the number of mobile ions present in the MHP, whereby a significant variation in Nₒ (5 orders of magnitude) was observed across different samples depending on the composition and chemistry of the top electrode.(22) The reasons for the variation were not well understood at the time. Here, we leverage additional characterization such as Rutherford Backscattering Spectrometry (RBS), a powerful, fast, and non-destructive technique for quantifying elemental motion throughout a PSC. RBS can be used to quantify the depth profile of Pb and I in a film stack comprising TiO₂/MAPbI₃.(23) RBS has been utilized to study the radiation hardness and elemental migration, where the RBS results clearly showed the signs of elemental migration of species such as iodine diffusing from the perovskite to the top electrode.(24) In this work, RBS is used to demonstrate that the migration of Ag ions (and of iodine out of the MHP) can be largely mitigated with a thin ALD SnO₂ barrier layer between the C₆₀ layer and the top Ag electrode. This work also describes several other considerations and implications of Nₒ that connect to material and device stability, including PSC thermal stability and bulk structural stability.

### Non-Limiting, Exemplary Results and Discussion

### Impact of Top Electrode Chemistry on Ion Migration

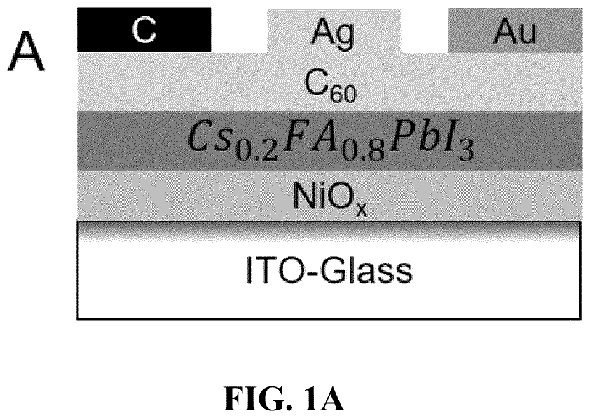

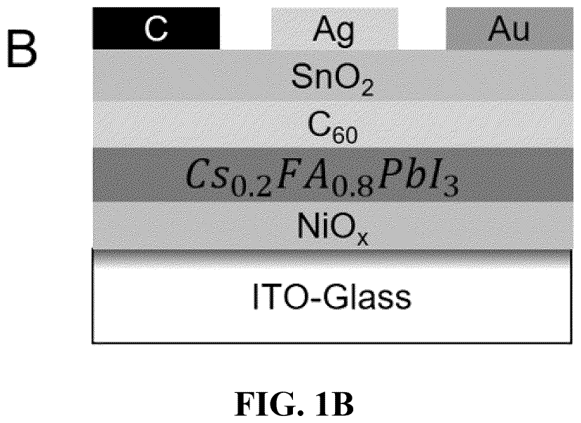

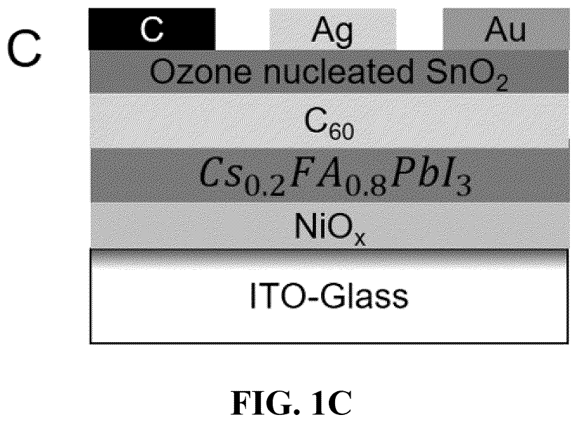

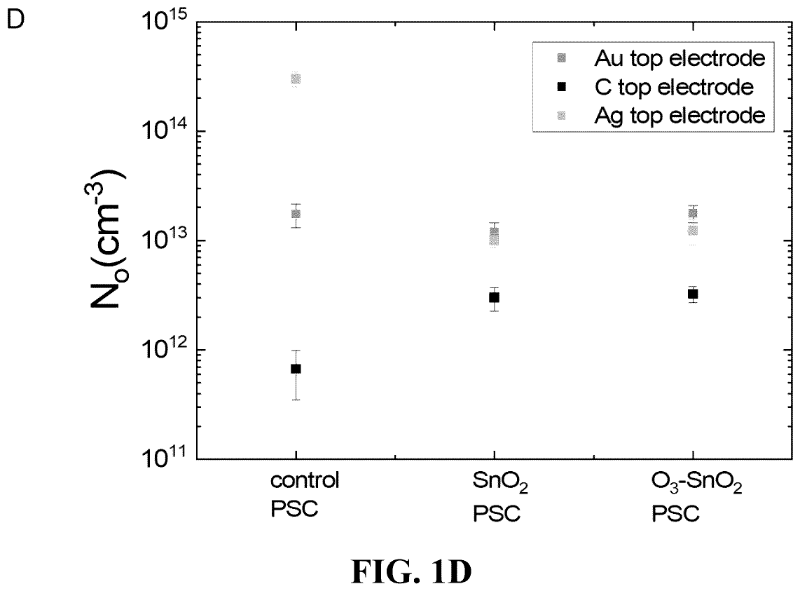

Without wishing to be bound by theory, metal electrodes are contributing/impacting Nₒ in PSCs with p-i-n architectures by the diffusion of metal ions into the active layer over time or under the influence of environmental stressors such as heat, and that this diffusion can be blocked by barrier layers. Nₒ measurements of PSCs with and without barrier layers between the device stack and the top electrode were performed using a transient dark current measurement.(22) The control PSC device stack was glass-ITO/NiOₓ/Cs_{0.2}FA_{0.8}PbI₃/C₆₀/(Ag or Au or C), as shown in FIG. 1A. A SnO₂ layer was introduced for the SnO₂PSC and O₃—SnO₂ PSC between the C₆₀ ETL and the top electrode (Ag or Au or C) (FIGS. 1B and 1C) deposited on the same substrate to reduce potential variability from different MHP morphologies/microstructures.

Starting with the Ag electrode case, from the square data points in FIG. 1D, the Nₒ of the Ag-control PSC was 3.0*10¹⁴ cm⁻³. The introduction of barrier layers results in a decreased Nₒ value of 1.0*10¹³ cm⁻³ for the Ag—SnO₂ PSC and 1.2*10¹³ cm⁻³ for the Ag—O₃—SnO₂ PSC. Without wishing to be bound by theory, the more than 10× increase in Nₒ for the control PSC is due to the diffusion of mobile Ag ions into the MHP lattice through the C₆₀ layer. By contrast, when the denser SnO₂ barrier layers (both SnO₂ and O₃ nucleated SnO₂) were used in the device stack, the diffusion of Ag ions was more effectively blocked. This phenomenon has been validated using other characterization methods where diffusion barriers were employed in the device stack to prevent the diffusion and corrosion of the top electrode.(25-27) In this work, the reduction in ion migration is evident by the reduction of Nₒ values to a magnitude similar to that of the Nₒ values of the considerably more inert Au top electrode both in the case of SnO₂ PSC and O₃—SnO₂ PSC. As such, all 3 device configurations exhibited similar Nₒ values for the Au electrode of ˜1.7*10¹³ cm⁻³, whereas the control PSC with C top electrode had a Nₒ of 6.7*10¹¹ cm⁻³ and both the device configurations with barrier layers and C top electrode had a Nₒ of 3*10¹² cm⁻³. The slightly reduced value of Nₒ in the control PSC when compared to the SnO₂ PSC and O₃—SnO₂ PSC with the C electrode is explained due to two factors. The first is the inertness and chemical stability of C electrodes. The second is the C electrode improving the MHP/C₆₀ interface through mechanical toughening an effect that we have previously demonstrated from interfacial fracture energy measurements(28) which results in a more physically dense barrier that possibly suppresses the formation of halide vacancies.(29)

### Effectiveness of SnO₂ Barrier Layer in the Prevention of Ag Ion Diffusion

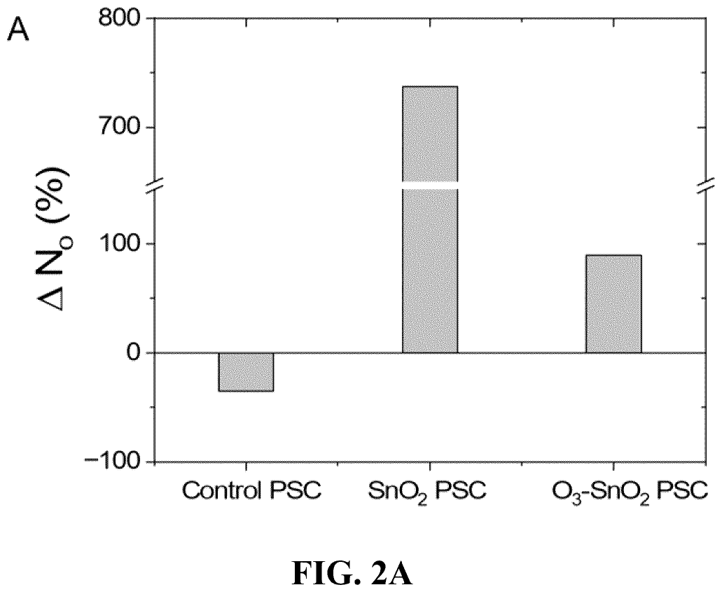

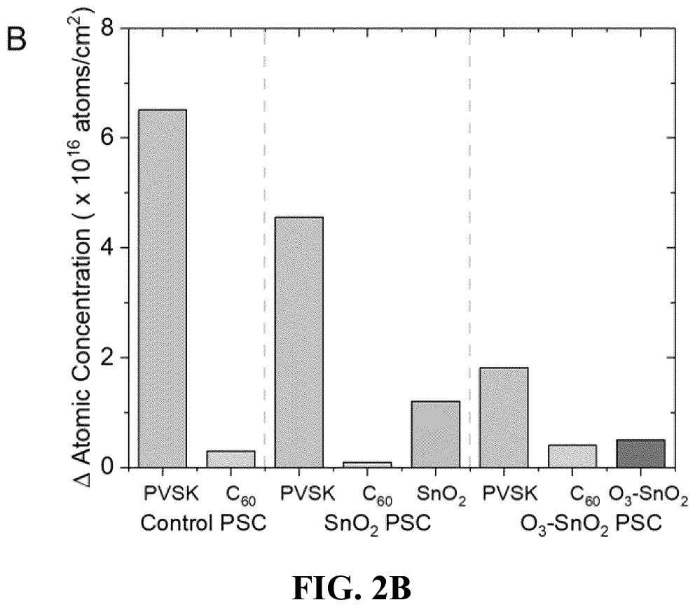

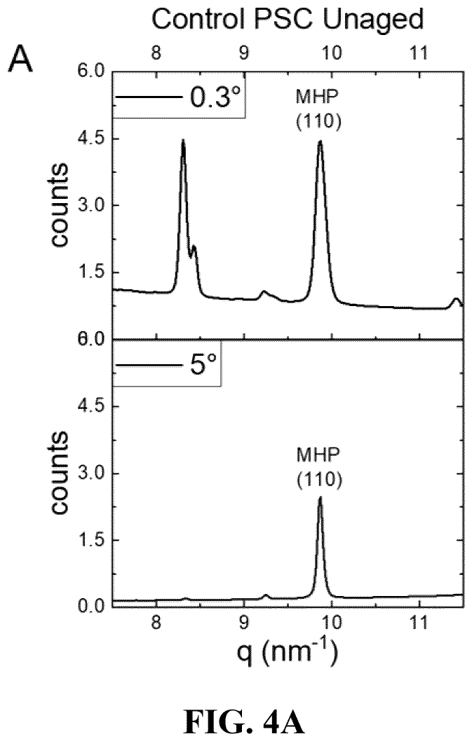

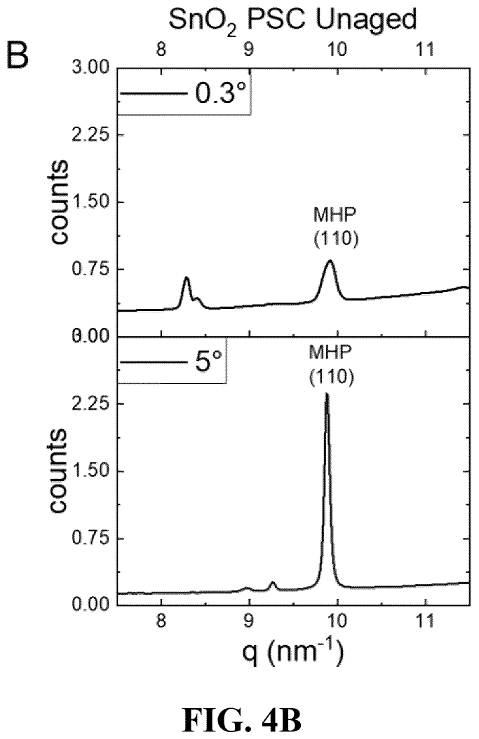

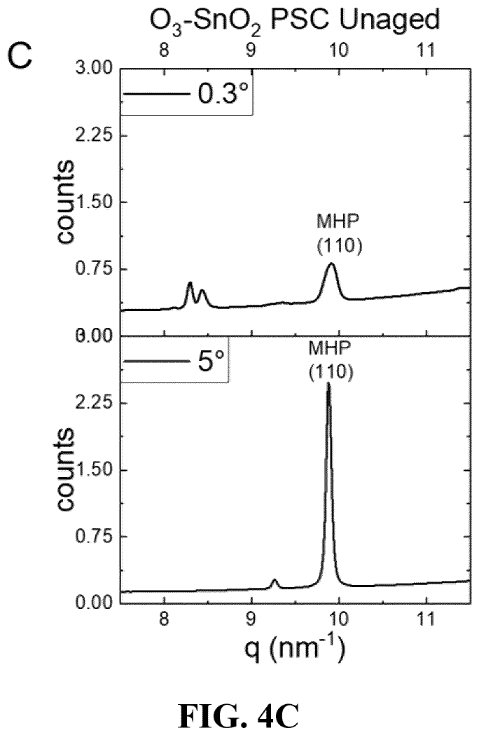

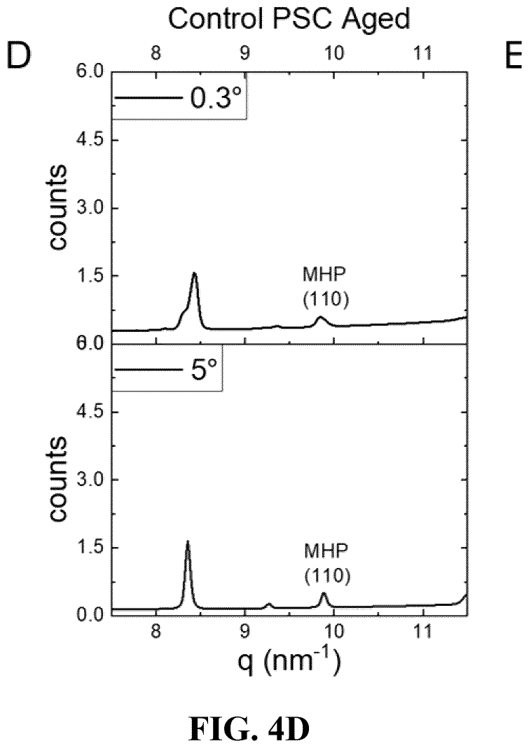

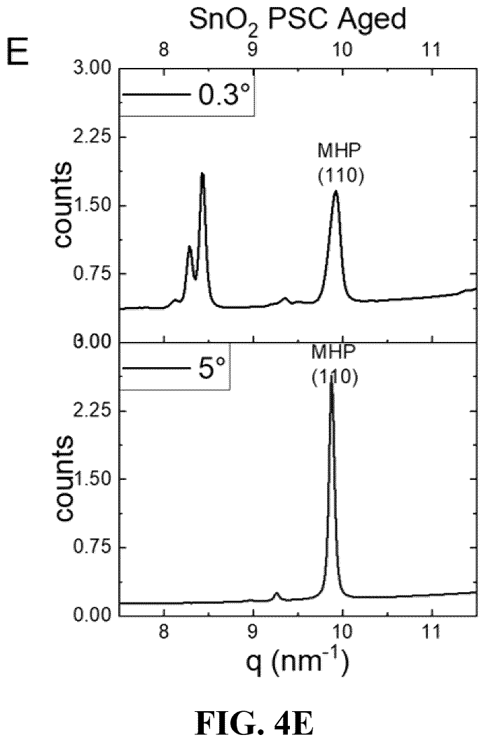

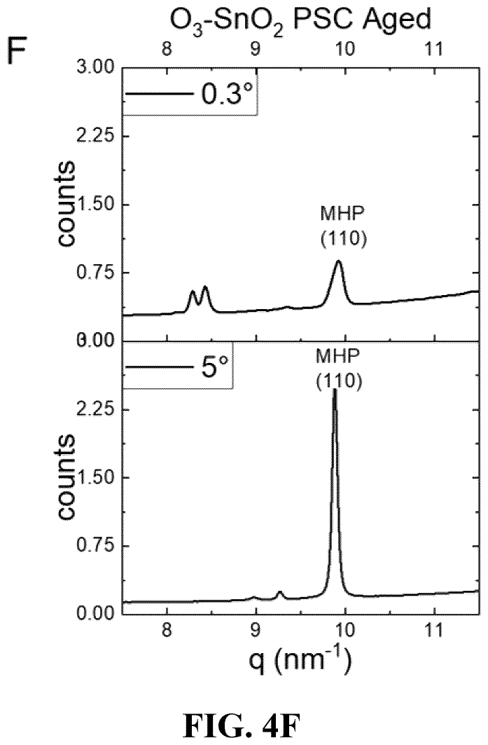

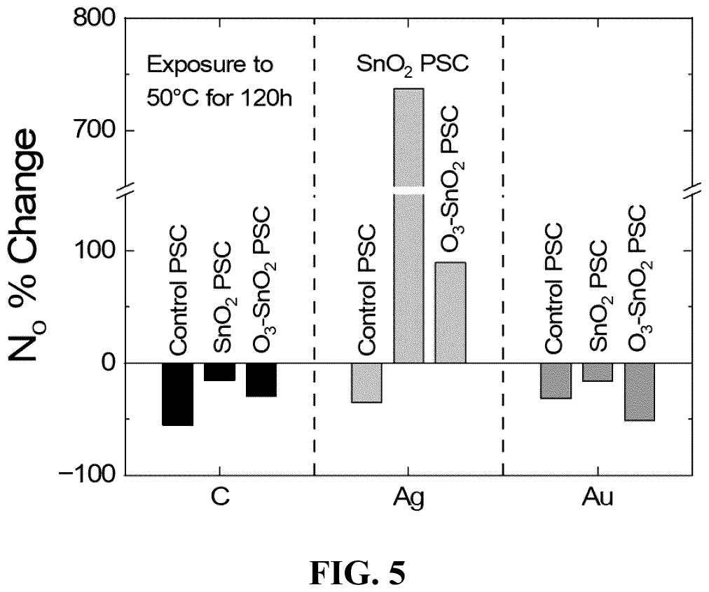

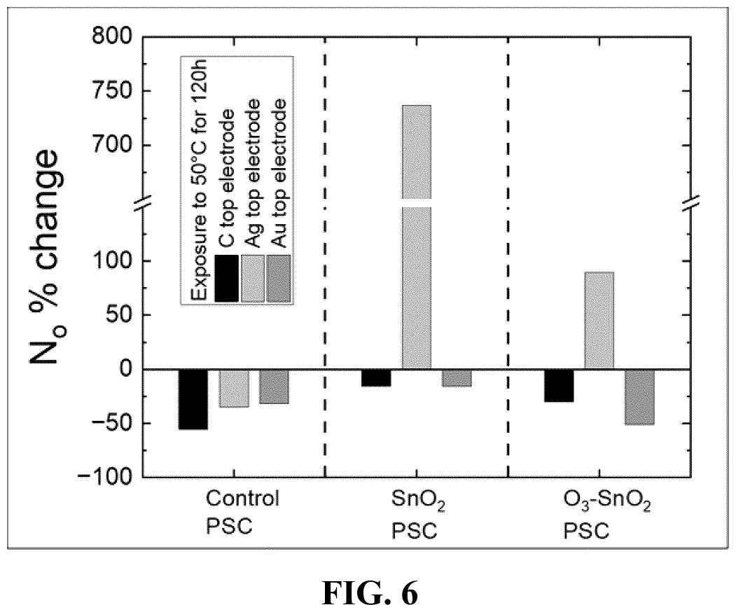

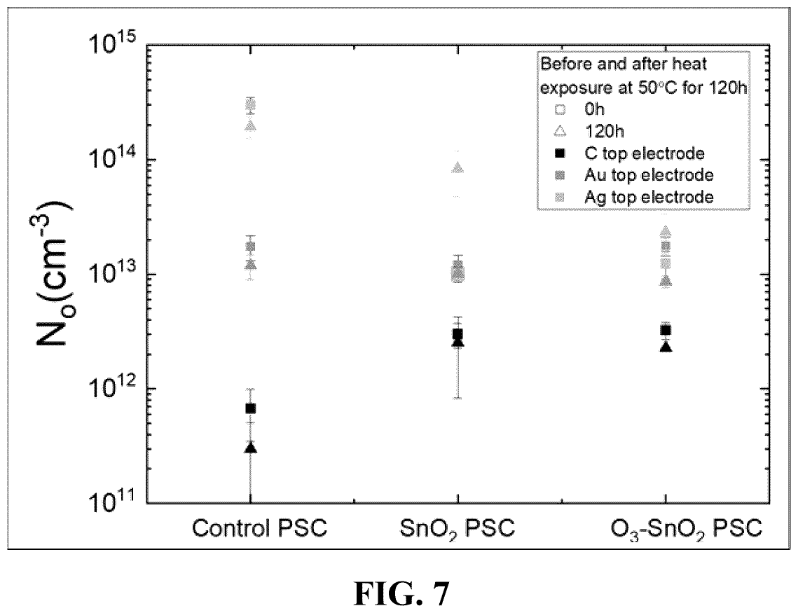

In addition to the initial Nₒ, we measured ion evolution under elevated temperatures to study the extent to which additional ion diffusion occurs in the MHP layer. Aging was performed on the PSCs by subjecting them to 50° C. for a period of 120 h. The percentage change in Nₒ for all 3 PSC device configurations with respect to the 3 top electrodes was observed after aging (FIG. 5, FIG. 6, and FIG. 7). The Ag—SnO₂ and Ag—O₃—SnO₂ PSCs had an increase of approximately 740±335% and 90±46% in Nₒ, respectively, while the Nₒ of the Ag-control PSC decreased by 35±9% (FIG. 2A). The Nₒ value is believed to be a result of the combination of opposing effects from Ag species reacting with the MHP to generate additional mobile ions and halide ions escaping the MHP lattice to reduce mobile ions after mild thermal aging. This can be seen by the reduction of Nₒ measured after thermal aging in the control sample without a SnO₂ barrier layer an effect we attribute to halide ions escaping the MHP lattice and triggering chemical reactions with adjacent layers along with decomposition of the MHP in the bulk, an effect which is shown in FIG. 4A-4F. However, without wishing to be bound by theory, in the case of Ag—SnO₂ and Ag—O₃—SnO₂ PSC where a barrier layer is present, the measured increase in Nₒ after aging is indicative of metal diffusion into the MHP. In absolute terms, the measured Nₒ for aged Ag-control PSCs was still markedly higher than the Nₒ of aged Ag—SnO₂ and Ag—O₃—SnO₂ PSCs. After aging, no significant changes in Nₒ were observed for PSCs with Au and C top electrodes. A relatively minor decrease (<50% A Nₒ) is one that we previously observed in MHPs with C electrodes. Without wishing to be bound by theory, the mechanism for the minor decrease is due to the possible onset of film degradation based on a slight redshift in photoluminescence after aging under these conditions(28), which can correspond with mobile ions escaping the MHP lattice.

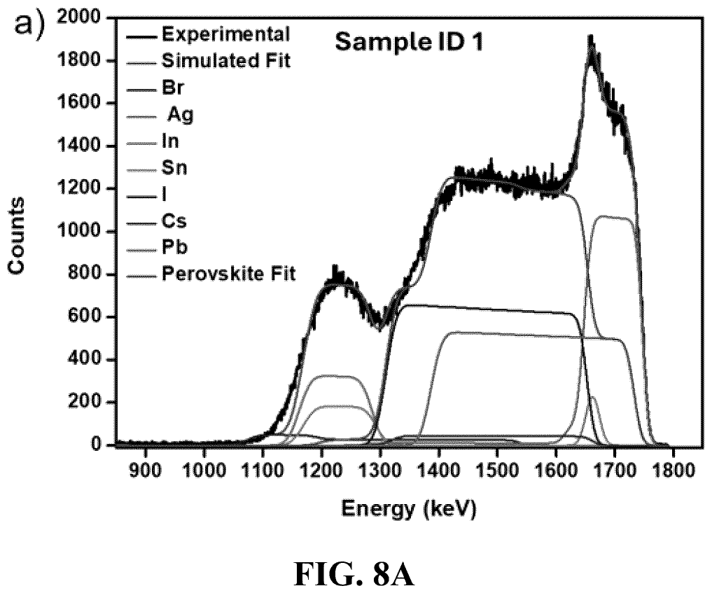

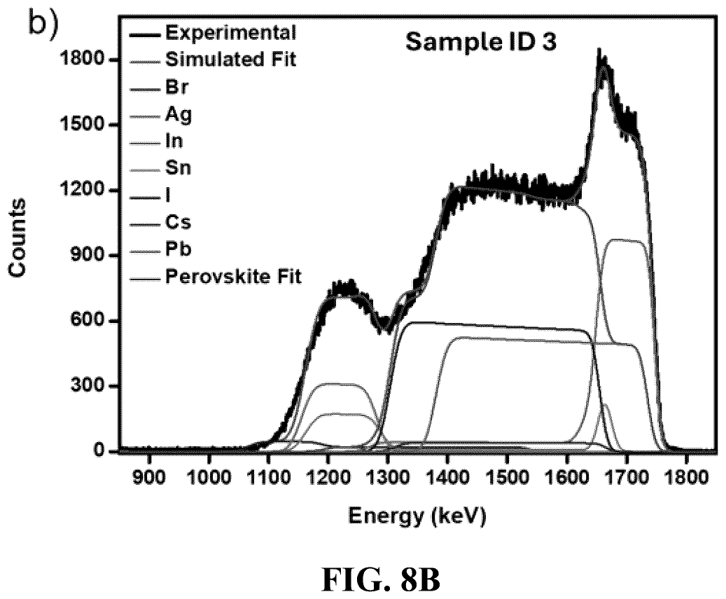

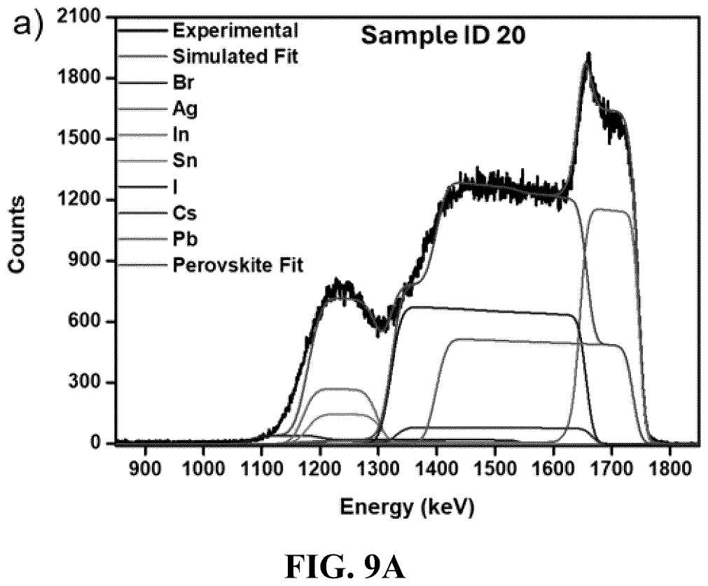

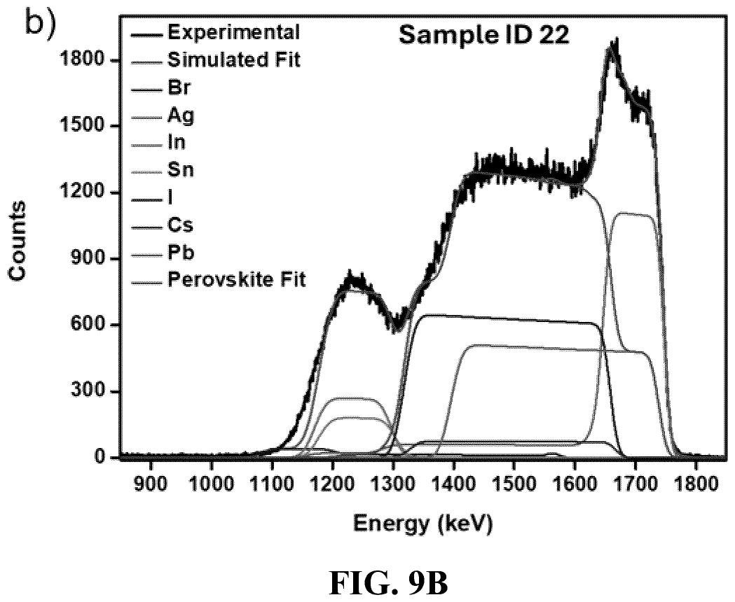

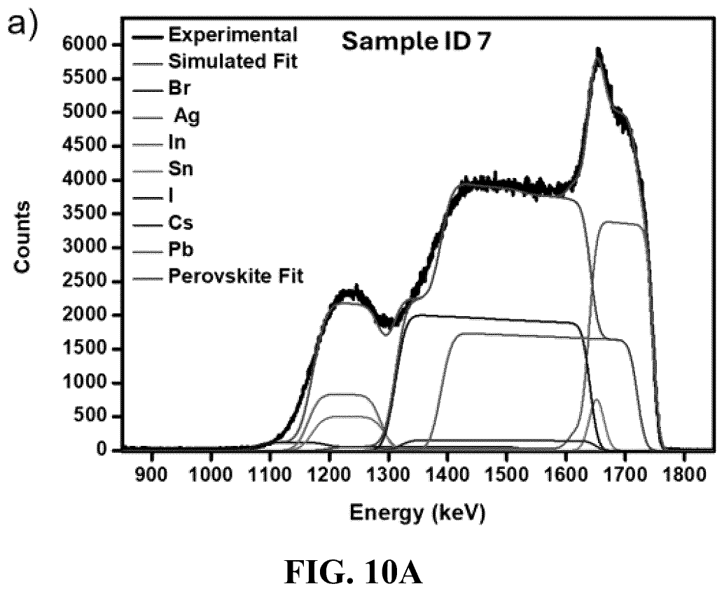

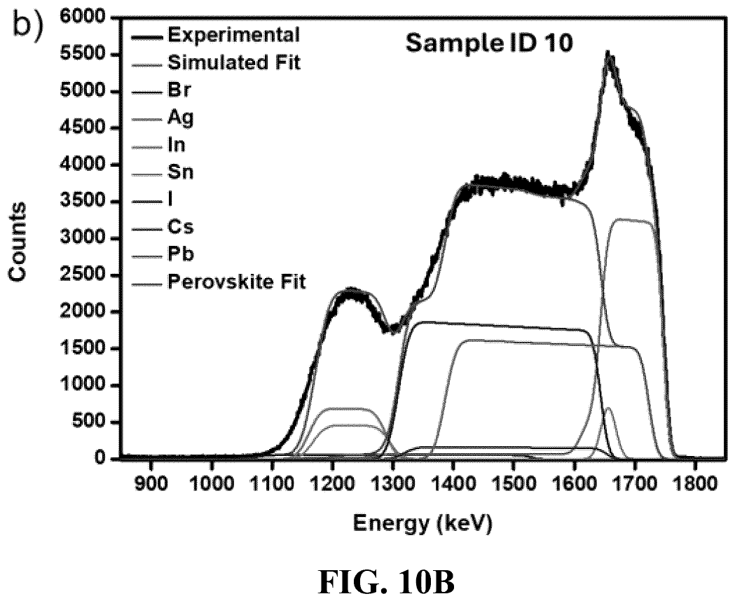

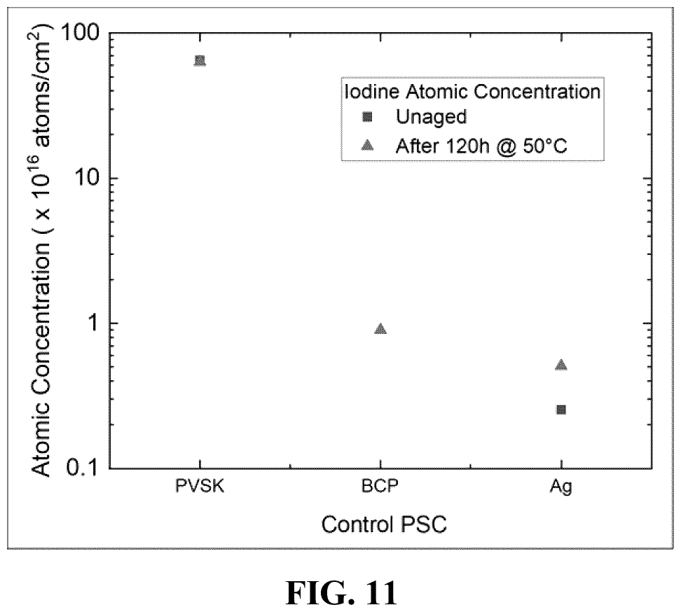

The above observations indicate that mobile Ag species and MHP-Ag reactions are responsible for the changes in Nₒ. To probe the redistribution of elements in the devices and confirm the observations, RBS was performed on Ag devices for unaged samples and for thermally aged samples that were subjected to the same thermal aging (50° C. for 120 h) (FIG. 8A-8B, FIG. 9A-9B, FIGS. 10A-10B, and Table 1-6). Subsequently, the atomic concentration of elements in all the layers of the device stack was used to understand the roles of Ag and barrier layers affecting ion diffusion in PSCs. FIG. 2B depicts the atomic concentration of Ag in the MHP layer and other PSC layers (C₆₀ layer for Ag-control PSC, Co and SnO₂ layer for Ag—SnO₂ PSC, and Co and O₃—SnO₂ layer for Ag—O₃—SnO₂ PSC) between the MHP and the top electrode for both unaged and aged samples. Note the unaged and aged sample measurements were not performed on the exact same sample before and after aging, which can lead to minor discrepancies in the absolute numbers between samples. There was no significant change in the atomic concentration of Ag in the ETL layers before and after aging with a maximum increase in the atomic concentration of ˜0.5*10¹⁶ atoms/cm² (FIG. 2B) with the amount of uncertainty as explained in Supplementary Note 1. However, a significant increase in the atomic concentration of Ag in the MHP layer was found based on model fitting for all PSCs after aging with almost an eight-fold increase for Ag-control PSC from 1.0*10¹⁶ to 7.5*10¹⁶ atoms/cm², approximately a four-fold increase for Ag—SnO₂ PSC from 1.4*10¹⁶ to 6.0*10¹⁶ atoms/cm², and approximately a two-fold increase for Ag—O₃—SnO₂ PSC from 1.2*10¹⁶ to 3.0*10¹⁶ atoms/cm². Additionally, even though the atomic concentration of Ag increased in the Ag-control PSC after aging, the atomic concentration of iodine is simultaneously reduced (FIG. 11) in the MHP layer. As previously discussed, these opposing effects on Nₒ likely lead to the overall reduction in Nₒ observed in FIG. 2A. The increase in the atomic concentration of Ag in the MHP layer for all 3 device configurations after aging confirms that the MHP is reacting with Ag without a SnO₂ barrier layer, and Ag ions are diffusing into the MHP layer over time. It is also clear that O₃—SnO₂ PSC is most effective in reducing the diffusion of Ag into the MHP. The RBS data also shows that no iodine is evident in the layers above the MHP after aging in either the SnO₂ or O₃—SnO₂ device configurations (Table 4 and 6), a further indication of the mechanism for Nₒ increase in both of those cases being in part due to Ag diffusion into the MHP and doping the material.

Threshold in Nₒ for Operation and Improved Thermal Stability of PSCs with Barrier Layer

Accelerated thermal stability tests in the form of in-situ Nₒ-temperature measurements were performed for Ag devices, to evaluate the correlation between ion migration and thermal stability. The in-situ Nₒ measurements were undertaken from 300 K to 450 K with a temperature ramp rate of 10K/min, a tolerance of 0.5K, and a settling time of 20 s. We note that thermal tests in the dark were selected to directly probe metal diffusion rather than other forms of instability that arise with heat+light.

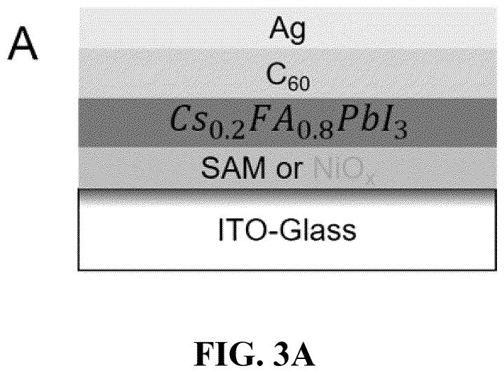

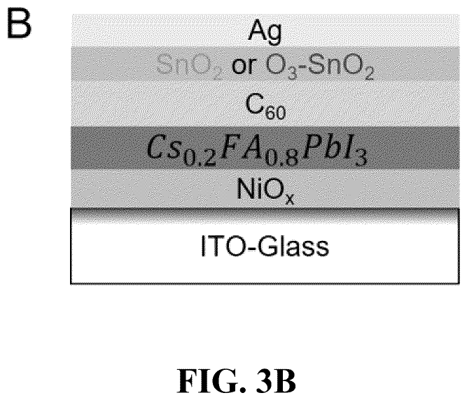

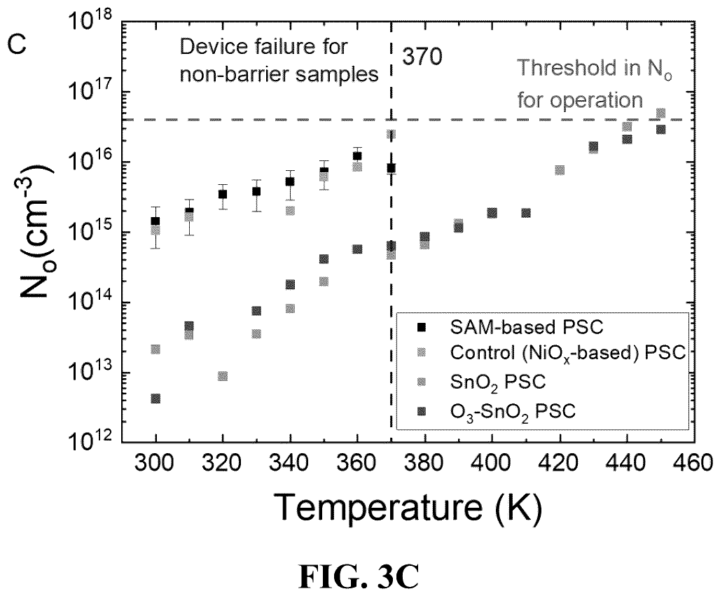

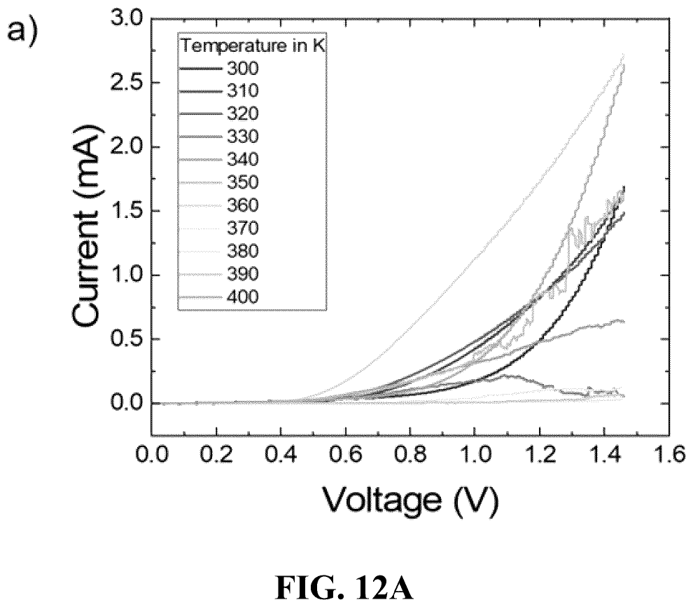

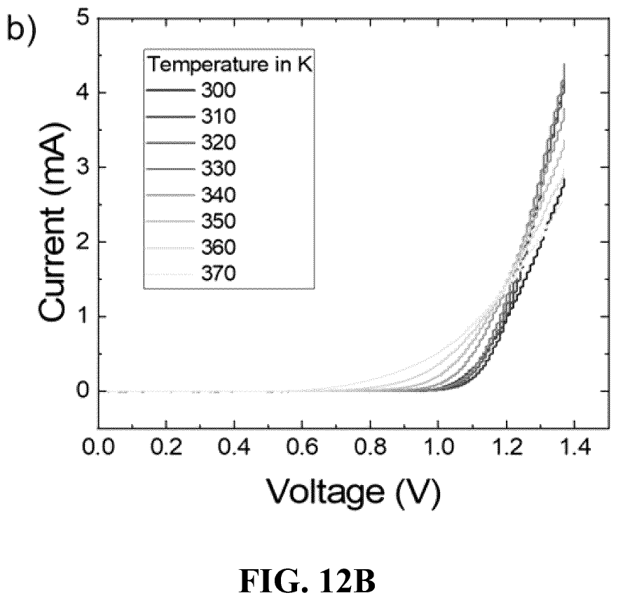

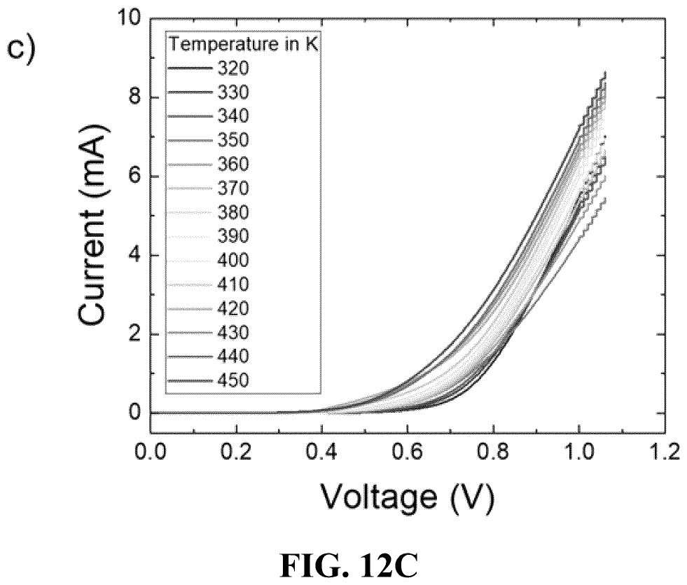

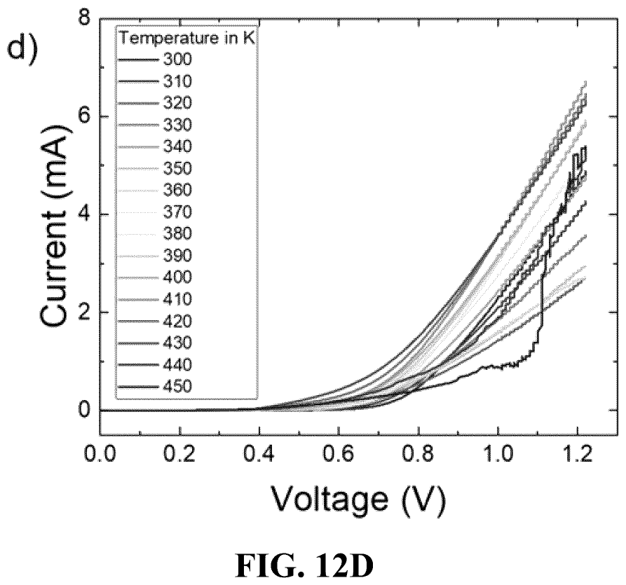

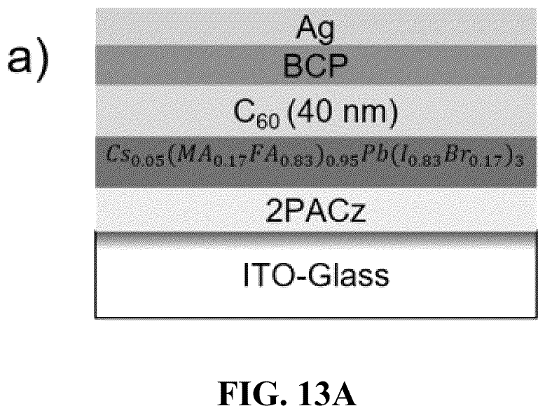

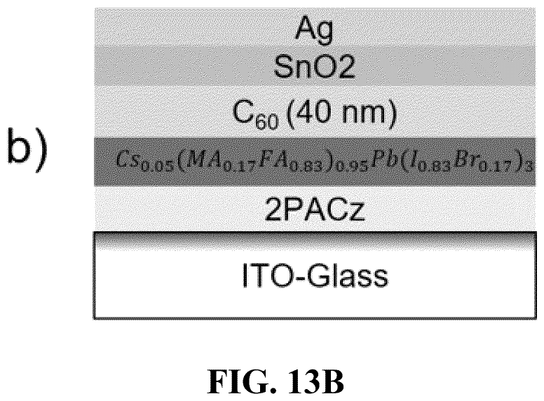

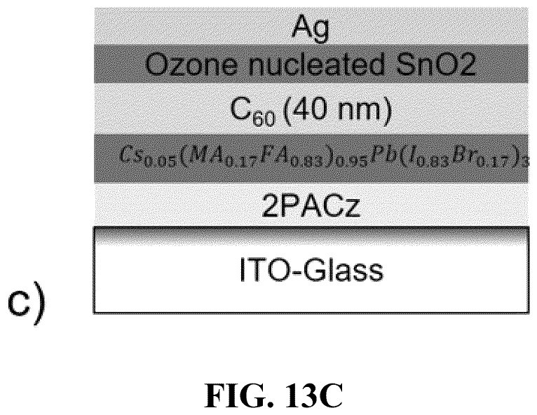

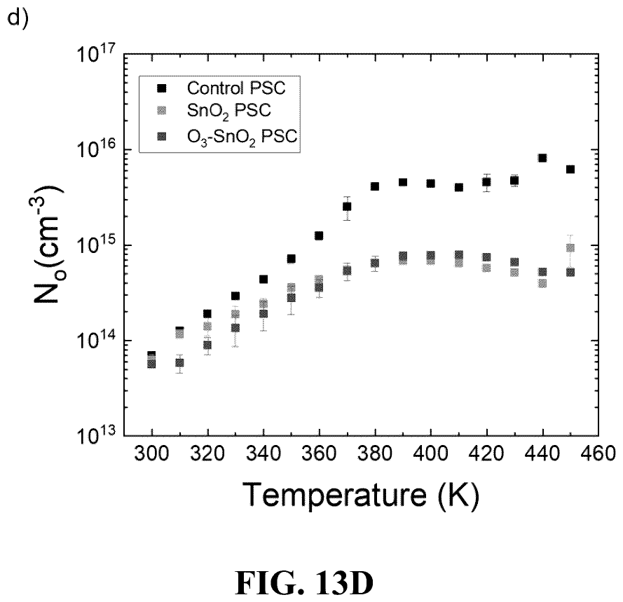

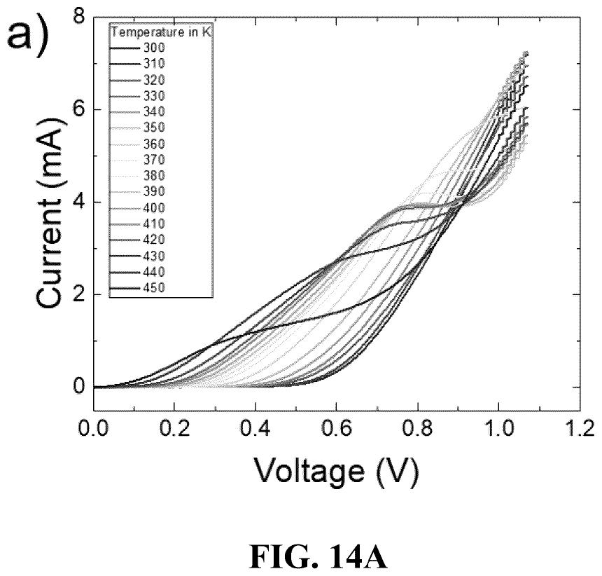

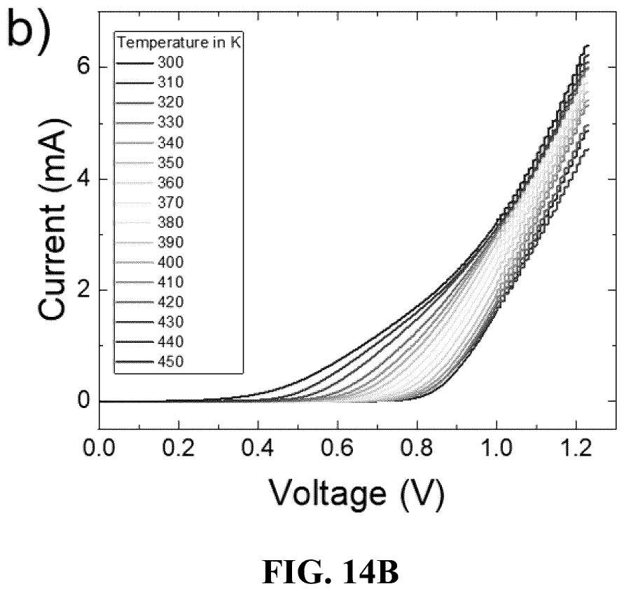

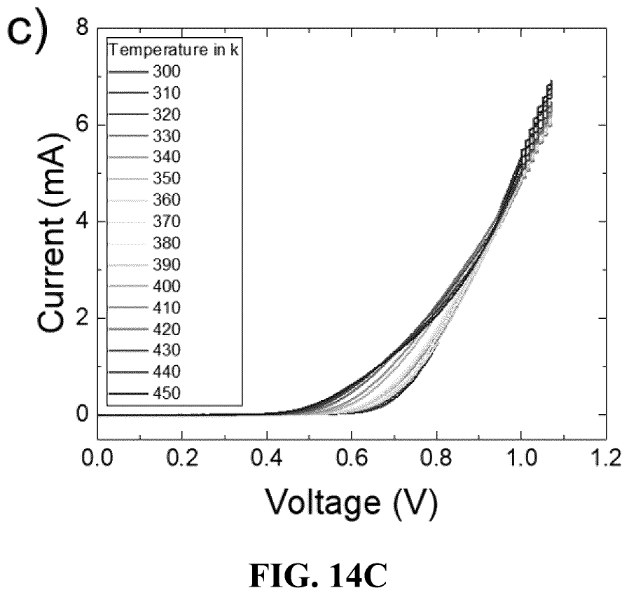

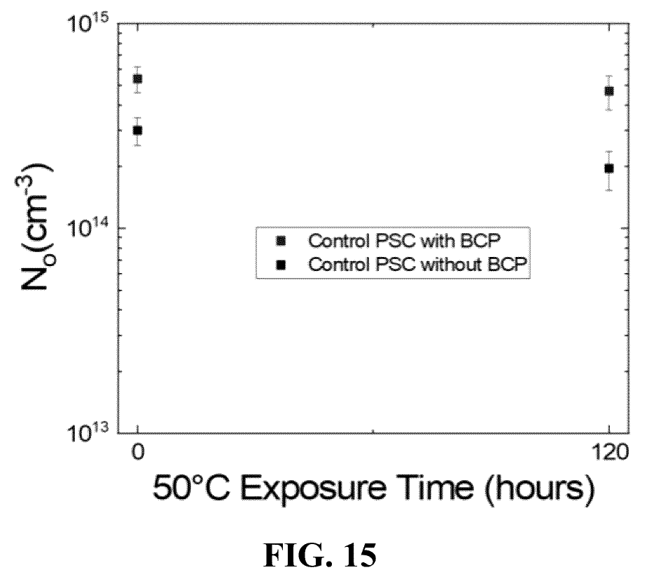

The point at which no electronic or ionic response was observed in the device was determined and this threshold temperature was assessed for the different architectures. We note that the apparent threshold temperatures can be either kinetic or thermodynamic effects associated with this temperature ramp experiment. The details of the kinetics of the migration are beyond the current scope of this work. Here, the HTL was either a self-assembled monolayer (SAM) (SAM-based PSC with the control architecture) or NiOx layer (control, SnO₂, and O₃—SnO₂ PSCs) (FIGS. 3A and 3B). A SAM-based PSC was selected as all state-of-the-art device architectures utilize SAM as the HTL and to demonstrate the versatility of the technique in measuring different device stack structures. From FIG. 3C, the SAM-based PSC and control PSC showed a threshold temperature of 370 K (˜100° C.), and the PSCs with barrier layers continued to operate with some response at a temperature of 450 K (˜180° C.), the upper limit which was tested for this study. FIG. 12A-12D shows device failure for the control PSC with a loss in dark IV response beyond 370 K and the SAM-based PSC showing a deteriorated dark IV response at 370K. In comparison, the SnO₂ PSC showed an acceptable dark IV response at 450 K while the O₃—SnO₂ PSC showed an onset of degradation at 440 K, but both the PSCs still had measurable Nₒ values at 450 K. Without wishing to be bound by theory, this is close to the threshold temperature for their ionic response based on the worsening of the IV curves. This effect was validated by testing a second set of samples with a similar top contact configuration in FIGS. 13A-13D and FIGS. 14A-14C, in which case the O₃—SnO₂ PSCs had an improved thermal stability response compared to both the control and SnO₂ PSCs. In this case, N₀ values for the control were measurable up to 450K, although the J-V response exhibited similar degradation at 370K and above. We note that a BCP layer was also included in this batch, and additional N₀ measurements for control devices that contain the BCP aged at 50° C. are included in FIG. 15, where the PSCs with BCP exhibited a trend in Nₒ that is very similar to control PSCs without BCP. This indicates that the introduction of barrier layers in the device stack increased the threshold operating temperature of the PSCs by at least 80° C., allowing an unencapsulated PSC in this work to function with an Ag electrode at a temperature comparable to the state-of-the-art achieved by a metal-free top contact structure using a combination of ITO with an ALD-based nanolaminate on top of the PSC for additional extrinsic stability shown elsewhere.(30)

Interestingly, there appears to be an empirically observed upper threshold of Nₒ for operation at ˜3.0*10¹⁶ cm⁻³ for multiple different combinations of electron and hole-transporting layers with Ag contacts, as indicated by the purple dashed line in FIG. 3C above which there is a high possibility of device failure based on the worsening or complete loss of dark IV response for most of the samples as shown in FIG. 12A-12D. All the PSCs showed an increase in Nₒ with temperature throughout the temperature range that was tested but the PSCs that had lower Nₒ initially (SnO₂ PSC and O₃—SnO₂ PSC) were operational at higher temperatures (370K to 450K) when compared to the PSCs that had higher Nₒ initially (control PSC and SAM-based PSC) which failed to show a response beyond 370K. Without wishing to be bound by theory, higher Nₒ values can correspond to accelerated degradation. One possible mechanism for this observation can be due to other failure modes unrelated to metal diffusion, such as reactions at the HTL/perovskite interface. This shows that having a higher Nₒ initially is consistent with more rapid deterioration of PSCs at higher temperatures and that having a lower initial Nₒ appears to be one of the factors that are associated with improved thermal stability of these p-i-n PSCs. As such, it can be possible to implement Nₒ as a screening tool or quality control for validating barrier layer efficacy in PSCs after fabrication.

Improved Bulk MHP Stability of PSCs with Barrier Layer

To study how the changes in ions correlate to microstructure changes in the films, GIWAXS was performed on control, SnO₂, and O₃—SnO₂ PSCs before and after the PSCs were subjected to the same thermal aging (50° C. for 120 h in N₂). Incident angle scans showcasing the X-ray diffraction plots in q-space at incidence angles 0.3° (representing the top surface) and 5° (representing the bulk) for all 3 device configurations before and after aging are shown in FIG. 4A-4F. Note that the unaged and aged sample measurements were not performed on the same sample. The peaks that indicate some presence of the degradation products were evident on the MHP surface for all the PSCs before and after aging was performed. All the unaged PSCs (FIG. 4A-4C) showcased a clear MHP (110) peak in the bulk.(31) However, after aging, the control PSC (FIG. 4D) exhibited a significant diminishing of the MHP (110) peak in the bulk. Note that a slightly higher amount of degradation was observed on the surface in the SnO₂ PSC (FIG. 4E) when compared to the O₃—SnO₂ PSC (FIG. 4F) after aging. Both SnO₂ PSC and O₃—SnO₂ PSC did not show a significant variation in the bulk 1D profile after aging i.e., they retained their MHP (110) peak along with no presence of degradation byproduct peaks. The integrated peak area ratios of MHP (110) and a degradation product (which can correspond to either 2H-FAPbI₃ or a non-perovskite phase) (Table 7) from the 1D integrated GIWAXS profiles show that this ratio reduced from unaged to aged samples in the decreasing order of control PSC, SnO₂ PSC, and O₃—SnO₂ PSC. This reduction indicates that the control PSC has low stability both in the top surface and the bulk, whereas SnO₂ PSCs and O₃—SnO₂ PSCs show an improvement in bulk stability after the introduction of the barrier layers in the device structure.

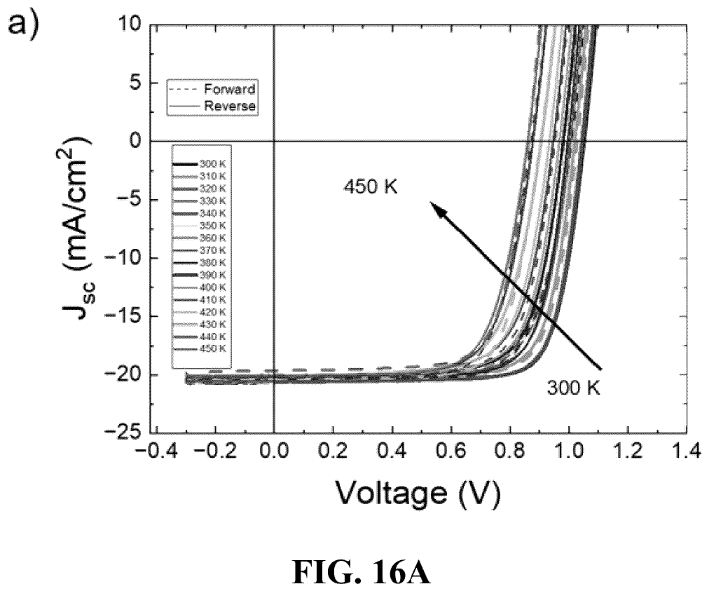

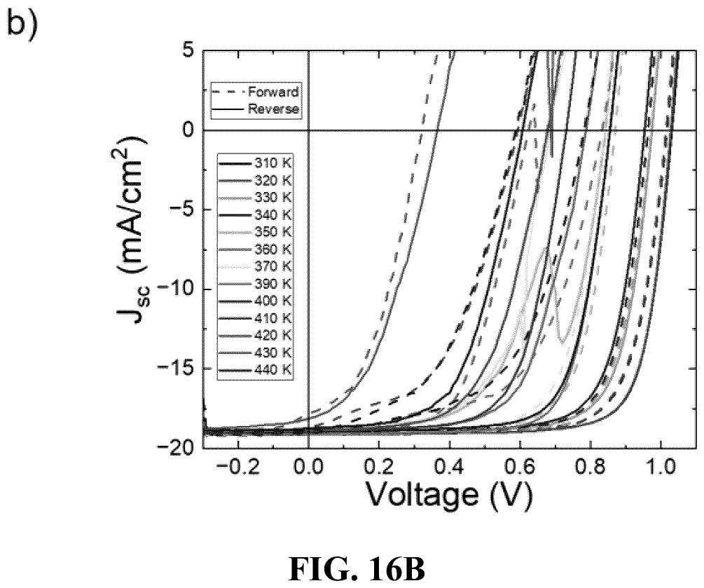

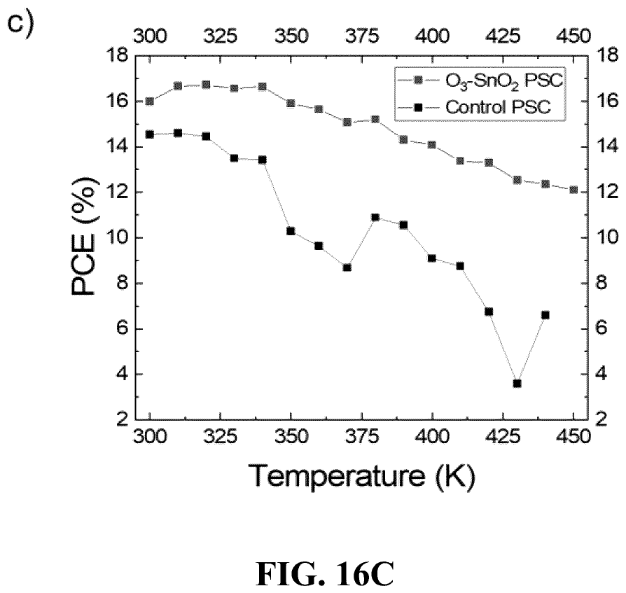

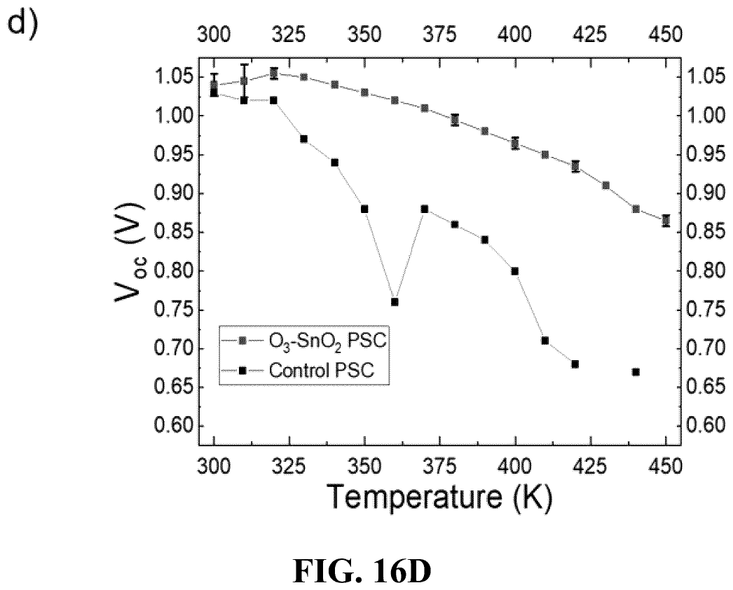

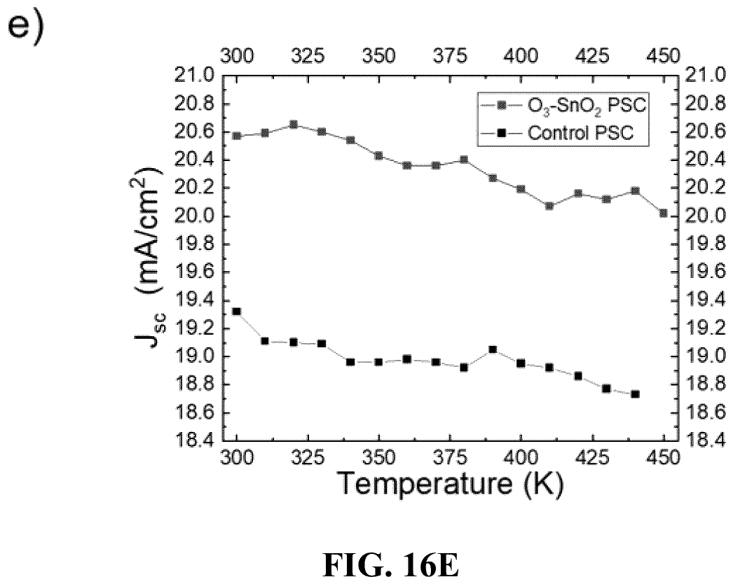

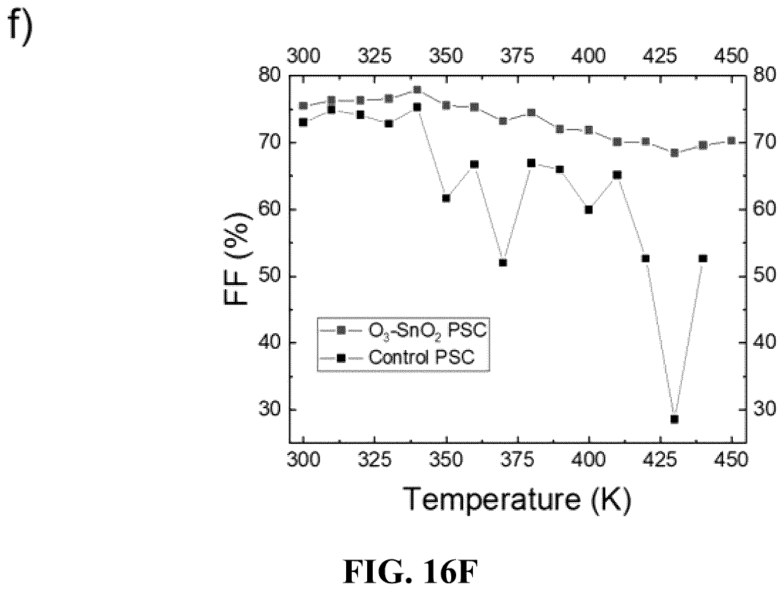

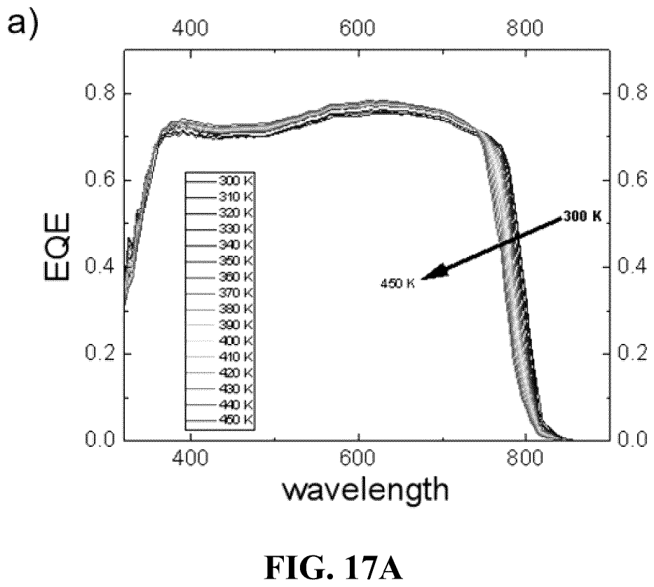

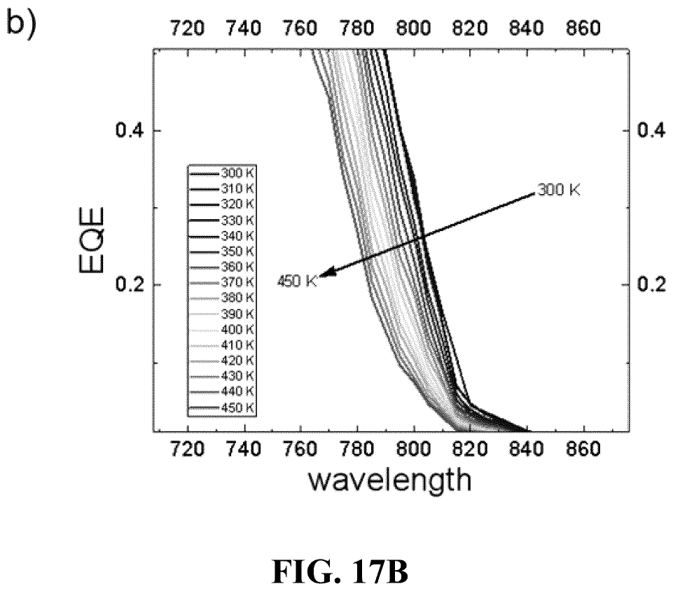

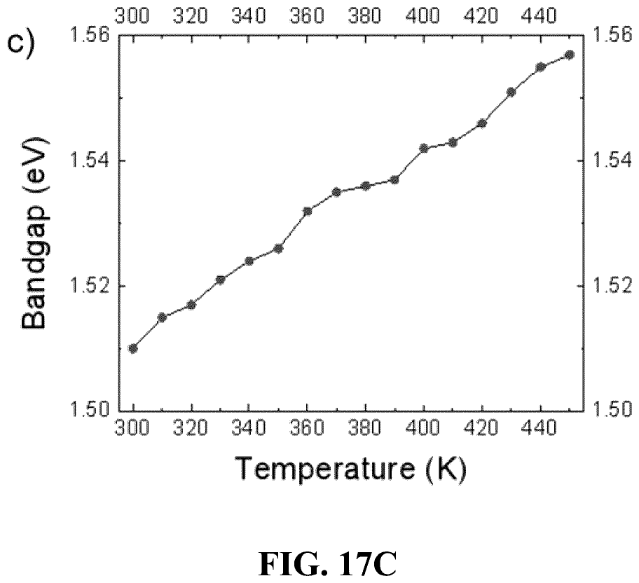

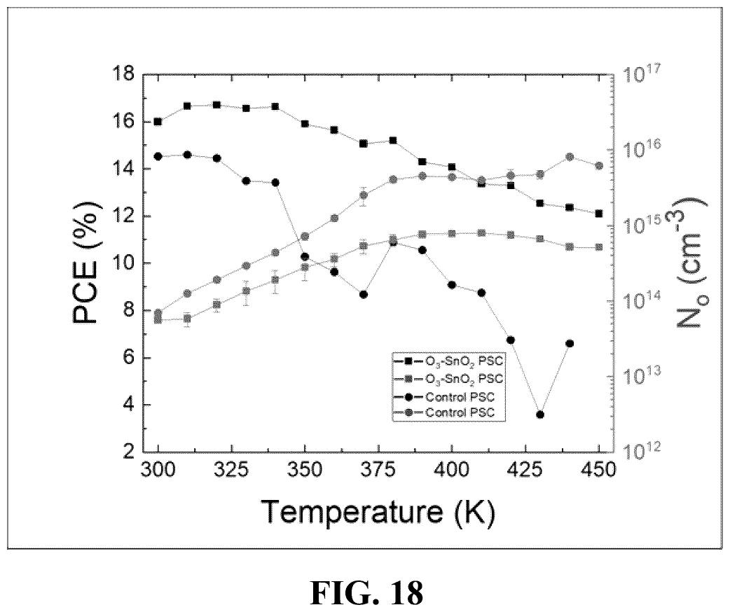

In addition to the dark I-V measurements, a full set of measurements were performed in the light and complemented by temperature-dependent EQE for the O₃—SnO₂ PSC (showing a minor increase in bandgap with temperature as in line with previous reporting for PSCs with similar compositions(32)) as shown in FIGS. 16A-16F and FIGS. 17A-17C. Control PSCs exhibited a rapid performance degradation with an increase in temperature, whereas O₃—SnO₂ PSCs exhibited much better thermal stability. There was a continuous drop in power conversion efficiency (PCE) from 14.5% to 6.6% for control PSC, whereas the PCE dropped from 16% to 12% for O₃—SnO₂ PSCs when the devices were exposed to heat from 300K to 450K. The factors contributing to the drop in PCE of control PSCs are a drop in V_{OC} and fill factor, both of which showed better stability for O₃—SnO₂ PSCs. Hence the improvement in Nₒ and the associated enhancement in the O₃—SnO₂ PSCs in comparison to control PSCs is complemented by better stability under extreme operational conditions (FIG. 18) and is on par with the best reported thermal stability of PSCs, which required the use of a metal-free top contact structure comprising ITO and an ALD nanolaminate(30) on top of the completed device. Our device structure shows that the reactions from a highly reactive metal (Ag) can be mitigated by preventing ion diffusion through the use of an ultra-thin, dense, and well-designed built-in barrier layer.

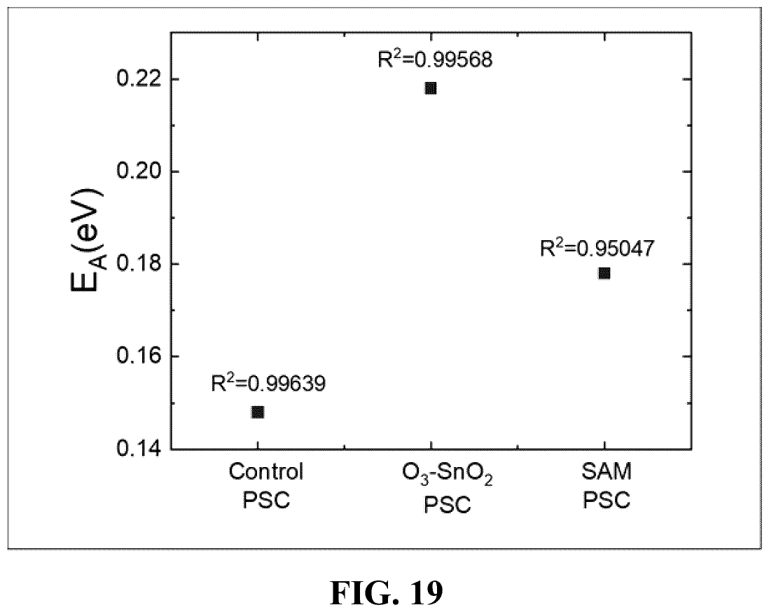

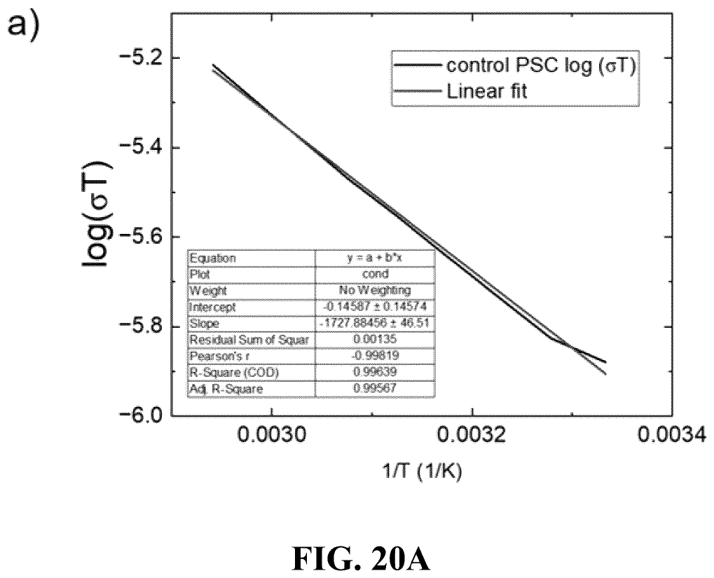

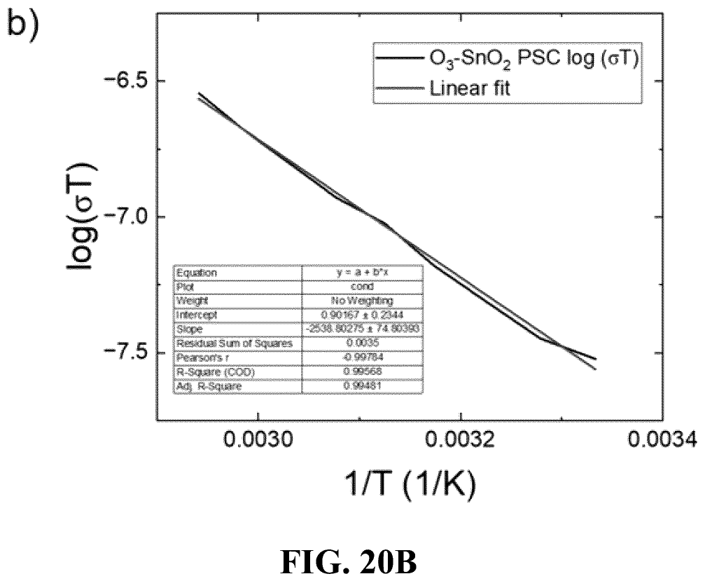

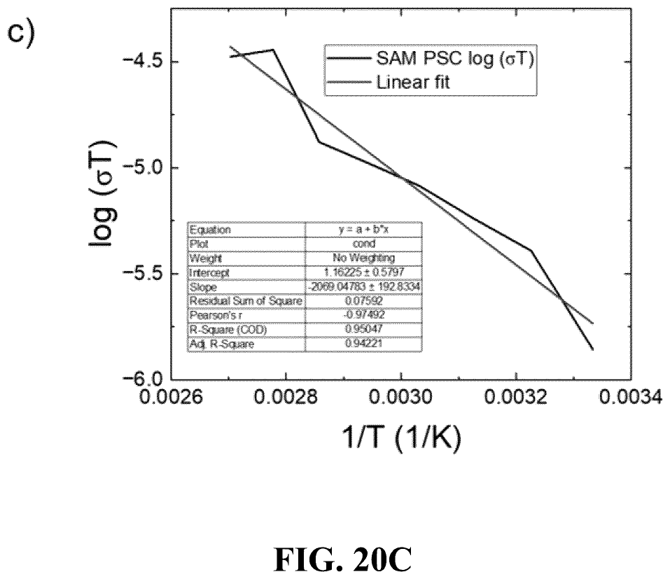

The activation energy (E_{A}) of the PSCs was also determined using in-situ ionic conductivity across a range of temperatures, a measurement that has been used in several other reports for ion-specific activation mechanisms.(33-35) As plotted in FIG. 19 and FIG. 20A-20C, the E_{A} of the control PSC was 0.346 eV, the E_{A} of the SAM-based PSC was 0.410 eV, and the EA of the O₃—SnO₂ PSC was 0.503 eV. This value is much higher than the E_{A} of triple halide PSCs with a similar architecture to the control PSC in this study and without any barrier layer (0.14 eV) from previous work.(22) As expected, these values support that the mobile ion activation is suppressed in the PSCs with a barrier layer when compared to the control and SAM-based PSCs. The implication of a higher E_{A} in the O₃—SnO₂ PSC demonstrates that well-designed barrier layers can reduce both the formation and evolution of mobile ions under operational conditions.

Described herein is the utilization the ion blocking feature/mechanism of a dense ALD O₃—SnO₂ layer to clearly show the diffusion of metal into the MHP under operation and the ability to detect this diffusion using Nₒ. A mild temperature of 50° C. was initially selected for the exposure tests to be able to observe only the temperature-dependent diffusion mechanisms on the PSCs without the influence of more rapid MHP degradation that can happen if the accelerated testing was done at higher temperatures or with light. Once an understanding regarding the diffusion of metal was achieved at 50° C., the PSCs were exposed to much higher temperatures up to 450K (177° C.) to observe the effects of degradation of MHP along with the diffusion of metal into the MHP. Additional experiments were performed under illumination during this high-temperature study showing the improved operational stability of O₃—SnO₂ devices compared to control devices (FIGS. 16A-16F and FIGS. 17A-17C) that directly correlate with the reduction in Nₒ. Without wishing to be bound by theory, we can use in-situ PL mapping characterization of the PSCs to monitor compositional changes in the MHP caused by the metal diffusion under operation during thermal aging.

### Non-Limiting Conclusion

In this work, we quantified mobile ionic species directly or indirectly resulting from chemical reactions. We demonstrated that our Nₒ measurement is sensitive to Ag ions diffusing into the MHP lattice of PSCs through the changes in Nₒ based on top electrode chemistry and from thermal aging. We validated that O₃—SnO₂ is an improved barrier layer in preventing the diffusion of Ag ions along with retaining the bulk stability of the MHP while improving PSC thermal stability compared to devices without a barrier layer. This allowed us to correlate this Nₒ metric to current-voltage (IV) behavior and ion redistribution as measured by Rutherford Backscattering Spectrometry. It is important to note that at high enough temperatures such as 450K, MHPs will degrade even with barrier layers due to structural degradation, an effect which was observed in the appearance of an upper threshold for Nₒ across device types. While many factors contribute to the real lifetime of fielded PV modules, the effectiveness, and reproducibility of barrier layers to prevent ion migration and chemical degradation are among the most critical to tackle for the stability of PSCs. Overall, our results demonstrate that Nₒ-temperature measurements are a rapid and effective method to characterize barrier layers at perovskite/electrode interfaces and predict the chemical robustness of the full devices.

To this end, there is a need for a deeper understanding of the correlation between power conversion efficiency, ion migration, and stability of PSCs. As such, we believe that the use of Nₒ measurements coupled with accelerated thermal and/or light aging can serve as a highly useful tool in quantifying the extent to which multiple sources of ions (whether from the top electrode or from the MHP itself) move throughout the PSC to provide a deeper understanding of ion-based degradation mechanisms.

### Methods

The preparation of glass substrates before doing any of the processing on top of the substrate was performed in a step-by-step procedure as follows: Indium tin oxide coated glass (ITO-glass) substrates (Xin Yan Technologies) were initially cleaned in an ultrasonic cleaner by submerging them in an industry grade soap solution of Extran (Millipore Sigma) diluted in water in the ratio of 1:10 for 10 min. Then, the ITO-glass slides were rinsed under a flow of de-ionized water with a brush to remove the residual soap on top of the substrates. This was followed by ultrasonic cleaning by submerging them in isopropyl alcohol (IPA) (Thermo Scientific) and acetone (Alfa Aesar—99.5%+) separately for 10 min. Finally, they were subjected to a UV ozone treatment for another 15 min.

### Nickel-oxide (NiOₓ)

A NiOx sol-gel solution for depositing the hole transport layer (HTL) was prepared by mixing 1M NiNO₃·(H₂O)₆ (Sigma Aldrich—99.999% trace metals basis) in 94% ethylene glycol (EG) (Thermo scientific—anhydrous 99.8%) and 6% ethylenediamine (EDA) (Thermo scientific—99%); the vial was then placed in a vortex mixer, and the solution was mixed until it turned a dark blue color.

### Self-Assembled Monolayer

0.5 mg ml-1 MeO-2PACz self-assembled monolayer solution dissolved in ethanol was spin-coated on substrates at 3,000 rpm for 30 s in a nitrogen glovebox, followed by annealing at 100° C. for 10 min.

Cesium Formamidinium Lead Iodide (Cs_{0.2}FA_{0.8}PbI₃)

The MHP precursor solution for Cs_{0.2}FA_{0.8}PbI₃ films was prepared by mixing 0.2 mol Cesium Iodide (CsI) (Sigma-Aldrich—99.999% trace metals basis), 0.8 mol Formamidinium Iodide (FAI) (Greatcell Solar Materials), and 1 mol Lead Iodide (PbI₂) (TCI America—99.99% trace metals basis). A 1M concentration solution was made by mixing 0.0519 gm of CsI, 0.1375 gm of FAI, and 0.461 gm of PbI₂ in a solvent of 4:1 Dimethylformamide (DMF) (Sigma-Aldrich—Anhydrous 99.8%) and Dimethyl Sulfoxide (DMSO) (Sigma-Aldrich—Anhydrous ≥99.9%) with 800 μL of DMF and 200 μL of DMSO. A vortex mixer was used to mix the solution until the powders were uniformly dissolved and a yellow solution was formed.

### Perovskite Solar Cells (PSCs)

After finishing the substrate preparation process and making the required inks, PSCs were fabricated in a step-by-step process. As the PSCs were in a p-i-n configuration, the HTL (NiOx/SAM) was first deposited on the cleaned ITO-glass by spin coating. 50 μL of NiOx solution was deposited at a speed of 5000 rpm and an acceleration of 2500 rpm/s for 30 s in a fume hood and then annealed at 315° C. for 1 h. The SAM layer was deposited at a speed of 3000 rpm for 30 s followed by annealing at 100° C. for 10 min. After the HTL was formed, the MHP absorber layer of Cs_{0.2}FA_{0.8}PbI₃ was deposited using a spin coating process with anti-solvent quenching. This was done by depositing 100 μL of MHP precursor on the glass and spinning at a speed of 1000 rpm and acceleration of 500 rpm/s for 10 s, and then the speed was stepped up to 5000 rpm and acceleration of 1500 rpm/s for 10 s. In the last 3-5 s of the second step, 100 μL of chlorobenzene (anti-solvent) (Sigma-Aldrich—Anhydrous 99.8%) was deposited quickly. Then, the samples were annealed at 150° C. for 10 minutes. The ETL was deposited by evaporating 45 nm of C₆₀ on top of the samples in an Angstrom evaporator with a shadow mask, and the top electrode was made by evaporating either 100 nm of Ag or Au on top of the device stack using a different mask. The carbon (C) top electrode was formed on top of the PSC by depositing it from the solvent-based C paste (PELCO conductive carbon glue—Ted Pella). Three different electrodes (evaporated Ag or Au and a solvent-based C) were deposited on top of the same PSC substrate to observe the variation in Nₒ with respect to barrier layers and the top electrode. ALD SnO₂ and O₃—SnO₂ for the barrier layers were deposited in a Beneq TFS200 ALD reactor by 125 cycles of tetrakisdimethylamino tin(IV) and water at 90. A 15-second ozone and water treatment was applied to the O₃—SnO₂ samples in-situ part way through the 125 cycles SnO₂ deposition following the sequence: 40 cycles SnO₂/15-second ozone and water/85 cycle SnO₂. (20)

### Characterization

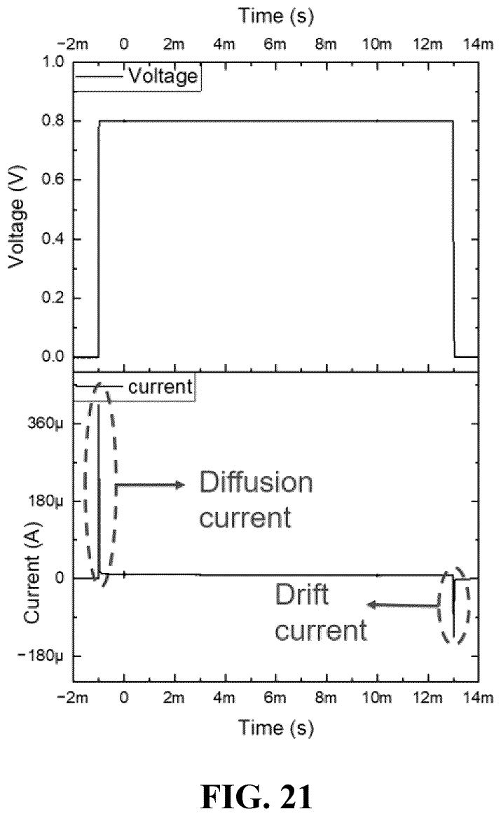

All the ionic and electronic measurements were performed with PAIOS, an all-in-one measurement equipment for photovoltaic devices and LEDs (FLUXiM AG). A hot plate was used to age the PSCs (as fabricated without encapsulation) at 50° C. in an N₂ glovebox for 120 h with ex-situ measurements on PAIOS. Nₒ was measured and calculated using the transient dark current method (FIG. 21) as described in our previous work(22) in which a voltage bias of 800 mV is applied to the PSC in a forward-bias configuration in the form of a pulse with the following characteristics: 1 ms settling time, 10 ms pulse time, and 1 ms follow-up time. The entire measurement lasts around 13 ms with the measurement cut-off around 1 ms after the bias is taken away, during which the mobile ions in the MHP drift. The measured drift current can be time-integrated and divided by the elementary charge, area, and thickness of the MHP layer respectively to determine the Nₒ.(22) For the quantification of mobile ion concentration (Nₒ) using the transient dark current methodology, the voltage pulse is applied in forward bias for only a short time of 10 ms. This timescale was chosen to be able to only measure the intrinsic concentration of ions in the perovskite that are ready to move under a small voltage perturbation. Using such a short timescale for the measurement might result in values of Nₒ that are lower than what has been reported in the literature, but we believe that the values obtained represent the actual ionic concentration present in the device at the surface level or at the interfaces. The consistency of the measured Nₒ values has been shown in our previous works.(22,28,35)

In-situ ionic measurements were performed with the temperature control stage and module (LTS-420E) from Linkam in integration with PAIOS in increments of 10 K from room temperature (300 K) up to 450 K. E_{A} was measured following the same methodology used in our previous work.(35) The ramp rate used was 10K/min and the tolerance was 0.5K with a settling time of 20 s. The reported E_{A} values are based on measurements of a single sample. However, the samples were measured during both ramp up and ramp down of the temperature. The reduction of temperature happened naturally and hence the samples would have significant dwell at each temperature and the calculations include averages of the measurement in both directions.

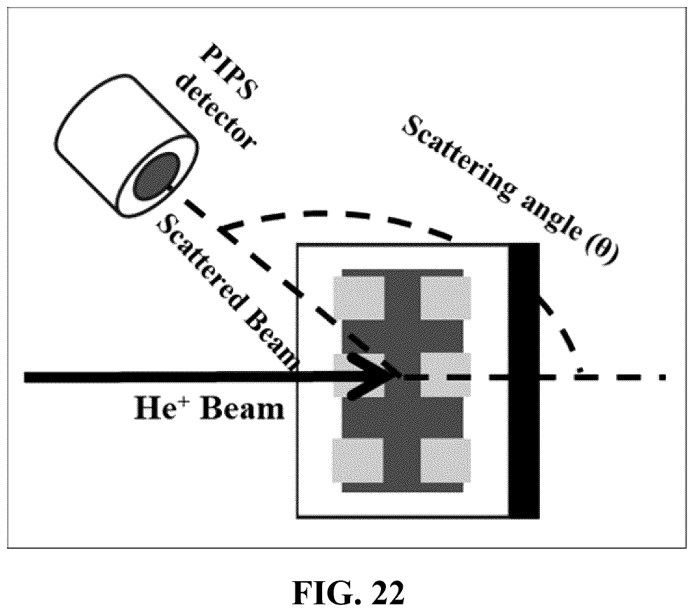

The RBS experiment was conducted in the Ion beam laboratory (IBL) at the University of North Texas (UNT) using the NEC 9SH 3MV Pelletron accelerator.(36,37) All the experiments were performed in the ion microprobe beamline using a 2 MeV He⁺ beam under a vacuum of 2×10⁻⁷ Torr. The RBS spectra were collected using a Passivated Implanted Planar Silicon (PIPS) charged particle detector from Mirion Technologies (Canberra), model No. PD25-11-300 AM, having a solid angle of 34 milli-steradian, and the operating voltage for the detector was 40 V situated at the backscattered angle of 145° (FIG. 22). The detector arrangement in the microprobe chamber is such that the incident beam, backscattering detector, and target normal lie in the same horizontal plane.

The RBS data fitting was done using the SIMNRA software package.(38) Based on the thickness values of each layer in the PSC stack, a simulated sample was generated. The concentrations of each layer were adjusted until a suitable match was achieved. Layer thickness is accepted by SIMNRA in the form of the layer's areal density (atoms cm⁻²). The SRIM/TRIM software program was utilized to convert the thickness into areal density(39) and detailed information on the process is provided elsewhere.(24) The layer information extracted from the SIMNRA was fed into the MultiSIMNRA(40) software program, to further extract the contribution from the individual layers and their elemental species.

To identify the different crystalline phases in the perovskite films and devices, at different subsurface depths, synchrotron-based grazing incidence wide-angle X-ray scattering (GIWAXS) data were collected at NCD-SWEET beamline at the ALBA synchrotron (Cerdanyola del Valles, Spain): a monochromatic (λ=0.95741 Å) X-ray beam of 150×30 μm² [H×V] was defined using a Si (111) channel cut monochromator and collimated using Be Compound Refractive Lenses (CRLs). The scattered signal was recorded using a Rayonix LX255-HS area detector placed at 251.2 mm from the sample position. Detector tilts and sample-to-detector distance were calculated using Cr₂O₃ as a calibrant, which was employed to calibrate the reciprocal space wavevector, q. GIWAXS frames were recorded at incident angles (αᵢ) between 0° and 5° in a scanning fashion, shifting from the surface-sensitive evanescent regime of scattering and transitioning to a deep penetrative measurement of the film layers at relatively high angles.(41) Throughout the data acquisition process, a continuous flow of N₂ gas was maintained over the sample. Collected 2D images were azimuthally integrated to general 1D profiles using PyFAI(42) and processed using a custom Python routine.

### REFERENCES

Li Z, Li B, Wu X, Sheppard S A, Zhang S, Gao D, et al. Organometallic-functionalized interfaces for highly efficient inverted perovskite solar cells. Science (1979) [Internet]. 2022 Apr. 22; 376(6591):416-20. Available from: https://doi.org/10.1126/science.abm8566
Yoo J J, Seo G, Chua M R, Park T G, Lu Y, Rotermund F, et al. Efficient perovskite solar cells via improved carrier management. Nature [Internet]. 2021; 590(7847):587-93. Available from: https://doi.org/10.1038/s41586-021-03285-w
NREL Best Research-Cell Efficiency Chart [Internet]. [cited 2024 Aug 15]. Available from: https://www.nrel.gov/pv/cell-efficiency.html
Green M A, Ho-Baillie A, Snaith H J. The emergence of perovskite solar cells. Nat Photonics [Internet]. 2014; 8(7):506-14. Available from: https://doi.org/10.1038/nphoton.2014.134
Ashif Mohammad, Farhana Mahjabeen. Promises and Challenges of Perovskite Solar Cells: A Comprehensive Review. BULLET: Jurnal Multidisiplin Ilmu [Internet]. 2023 Oct. 20; 2(5):1147-57. Available from: https://journal.mediapublikasi.id/index.php/bullet/article/view/3685
Čulik P, Brooks K, Momblona C, Adams M, Kinge S, Maréchal F, et al. Design and Cost Analysis of 100 MW Perovskite Solar Panel Manufacturing Process in Different Locations. ACS Energy Lett [Internet]. 2022 Sep. 9; 7(9):3039-44. Available from: https://doi.org/10.1021/acsenergylett.2c01728
Ahangharnejhad R H, Becker W, Jones J, Anctil A, Song Z, Phillips A, et al. Environmental Impact per Energy Yield for Bifacial Perovskite Solar Cells Outperforms Crystalline Silicon Solar Cells. Cell Rep Phys Sci [Internet]. 2021; 2(2):100344. Available from: https://www.sciencedirect.com/science/article/pii/S2666386421000291
Sakhatskyi K, John R A, Guerrero A, Tsarev S, Sabisch S, Das T, et al. Assessing the Drawbacks and Benefits of Ion Migration in Lead Halide Perovskites. ACS Energy Lett [Internet]. 2022 Oct. 14; 7(10):3401-14. Available from: https://doi.org/10.1021/acsenergylett.2c01663
Liu J, Hu M, Dai Z, Que W, Padture N P, Zhou Y. Correlations between Electrochemical Ion Migration and Anomalous Device Behaviors in Perovskite Solar Cells. ACS Energy Lett [Internet]. 2021 Mar. 12; 6(3):1003-14. Available from: https://doi.org/10.1021/acsenergylett.0c02662
Grancini G, Roldan-Carmona C, Zimmermann I, Mosconi E, Lee X, Martineau D, et al. One-Year stable perovskite solar cells by 2D/3D interface engineering. Nat Commun [Internet]. 2017; 8(1):15684. Available from: https://doi.org/10.1038/ncomms15684
Perovskite PV Accelerator for Commercializing Technologies. [cited 2024 Aug 15]; Available from: https://pvpact.sandia.gov/
Bi E, Song Z, Li C, Wu Z, Yan Y. Mitigating ion migration in perovskite solar cells. Trends Chem [Internet]. 2021 Jul. 1; 3(7):575-88. Available from: https://doi.org/10.1016/j.trechm.2021.04.004
Zai H, Ma Y, Chen Q, Zhou H. Ion migration in halide perovskite solar cells: Mechanism, characterization, impact and suppression. Journal of Energy Chemistry [Internet]. 2021; 63:528-49. Available from: https://www.sciencedirect.com/science/article/pii/S2095495621004290
Zhao Y, Zhou W, Han Z, Yu D, Zhao Q. Effects of ion migration and improvement strategies for the operational stability of perovskite solar cells. Physical Chemistry Chemical Physics [Internet]. 2021; 23(1):94-106. Available from: http://dx.doi.org/10.1039/DOCP04418K
Zhao L, Kerner R A, Xiao Z, Lin Y L, Lee K M, Schwartz J, et al. Redox Chemistry Dominates the Degradation and Decomposition of Metal Halide Perovskite Optoelectronic Devices. ACS Energy Lett [Internet]. 2016 Sep. 9; 1(3):595-602. Available from: https://doi.org/10.1021/acsenergylett.6b00320
Kerner R A, Zhao L, Harvey S P, Berry J J, Schwartz J, Rand B P. Low Threshold Voltages Electrochemically Drive Gold Migration in Halide Perovskite Devices. ACS Energy Lett [Internet]. 2020 Nov. 13; 5(11):3352-6. Available from: https://doi.org/10.1021/acsenergylett.0c01805
Kerner R A, Cohen A V, Xu Z, Kirmani A R, Park S Y, Harvey S P, et al. Electrochemical Doping of Halide Perovskites by Noble Metal Interstitial Cations. Advanced Materials [Internet]. 2023 Jul. 1; 35(29):2302206. Available from: https://doi.org/10.1002/adma.202302206
Shlenskaya N N, Belich N A, Grätzel M, Goodilin E A, Tarasov A B. Light-induced reactivity of gold and hybrid perovskite as a new possible degradation mechanism in perovskite solar cells. J Mater Chem A Mater [Internet]. 2018; 6(4):1780-6. Available from: http://dx.doi.org/10.1039/C7TA10217H
Zhou J, Liu Z, Yu P, Tong G, Chen R, Ono L K, et al. Modulation of perovskite degradation with multiple-barrier for light-heat stable perovskite solar cells. Nat Commun [Internet]. 2023; 14(1):6120. Available from: https://doi.org/10.1038/s41467-023-41856-9
Johnson S A, White K P, Tong J, You S, Magomedov A, Larson B W, et al. Improving the barrier properties of tin oxide in metal halide perovskite solar cells using ozone to enhance nucleation. Joule [Internet]. 2023 Dec. 20; 7(12):2873-93. Available from: https://doi.org/10.1016/j.joule.2023.10.009
Li M, Johnson S, Gil-Escrig L, Sohmer M, Figueroa Morales C A, Kim H, et al. Strategies to improve the mechanical robustness of metal halide perovskite solar cells. Energy Advances [Internet]. 2024; 3(1):273-80. Available from: http://dx.doi.org/10.1039/D3YA00377A
Penukula S, Estrada Torrejon R, Rolston No Quantifying and Reducing Ion Migration in Metal Halide Perovskites through Control of Mobile Ions. Molecules [Internet]. 2023; 28(13). Available from: https://www.mdpi.com/1420-3049/28/13/5026
Lang F, Juma A, Somsongkul V, Dittrich T, Arunchaiya M. Rutherford Backscattering Spectroscopy of Mass Transport by Transformation of PbI2 into CH3NH3PbI3 within np-TiO2. Hybrid Materials. 2014 Jan. 22; 1(1).
Parashar M, Sharma M, Saini D K, Byers T A, Luther J M, Sellers I R, et al. Probing elemental diffusion and radiation tolerance of perovskite solar cells via non-destructive Rutherford backscattering spectrometry. APL Energy [Internet]. 2024 Mar. 7; 2(1):016109. Available from: https://doi.org/10.1063/5.0193601
Park H H, Fermin D J. Recent Developments in Atomic Layer Deposition of Functional Overlayers in Perovskite Solar Cells. Nanomaterials [Internet]. 2023; 13(24). Available from: https://www.mdpi.com/2079-4991/13/24/3112
Bi E, Chen H, Xie F, Wu Y, Chen W, Su Y, et al. Diffusion engineering of ions and charge carriers for stable efficient perovskite solar cells. Nat Commun [Internet]. 2017; 8(1):15330. Available from: https://doi.org/10.1038/ncommsl5330
Li N, Shi Z, Fei C, Jiao H, Li M, Gu H, et al. Barrier reinforcement for enhanced perovskite solar cell stability under reverse bias. Nat Energy [Internet]. 2024; Available from: https://doi.org/10.1038/s41560-024-01579-7
Penukula S, Tippin F, Li M, Khawaja K A, Yan F, Rolston N. Use of carbon electrodes to reduce mobile ion concentration and improve reliability of metal halide perovskite photovoltaics. Energy Materials [Internet]. 2024; 4(5). Available from: https://www.oaepublish.com/articles/energymater.2024.26
Zhong Y, Yang J, Wang X, Liu Y, Cai Q, Tan L, et al. Inhibition of Ion Migration for Highly Efficient and Stable Perovskite Solar Cells. Advanced Materials [Internet]. 2023 Dec. 1; 35(52):2302552. Available from: https://doi.org/10.1002/adma.202302552
Afshari H, Sourabh S, Chacon S A, Whiteside V R, Penner R C, Rout B, et al. FACsPb Triple Halide Perovskite Solar Cells with Thermal Operation over 200° C. ACS Energy Lett [Internet]. 2023 May 12; 8(5):2408-13. Available from: https://doi.org/10.1021/acsenergylett.3c00551
Yang Y, Yang L, Feng S. Interfacial engineering and film-forming mechanism of perovskite films revealed by synchrotron-based GIXRD at SSRF for high-performance solar cells. Mater Today Adv [Internet]. 2020; 6:100068. Available from: https://www.sciencedirect.com/science/article/pii/S2590049820300151
Moot T, Patel J B, McAndrews G, Wolf E J, Morales D, Gould I E, et al. Temperature Coefficients of Perovskite Photovoltaics for Energy Yield Calculations. ACS Energy Lett [Internet]. 2021 May 14; 6(5):2038-47. Available from: https://doi.org/10.1021/acsenergylett.1c00748
López-Gonzilez M C, del Pozo G, Arredondo B, Delgado S, Martin-Martin D, Garcia-Pardo M, et al. Temperature behaviour of mixed-cation mixed-halide perovskite solar cells. Analysis of recombination mechanisms and ion migration. Org Electron [Internet]. 2023; 120:106843. Available from: https://www.sciencedirect.com/science/article/pii/S156611992300099X
Xing J, Wang Q, Dong Q, Yuan Y, Fang Y, Huang J. Ultrafast ion migration in hybrid perovskite polycrystalline thin films under light and suppression in single crystals. Physical Chemistry Chemical Physics [Internet]. 2016; 18(44):30484-90. Available from: http://dx.doi.org/10.1039/C6CP06496E
Sun J, Penukula S, Li M, Hosseinzade M R, Tang Y, Dou L, et al. Mechanical and Ionic Characterization for Organic Semiconductor-Incorporated Perovskites for Stable 2D/3D Heterostructure Perovskite Solar Cells. Small [Internet]. 2024 Oct. 7; n/a(n/a):2406928. Available from: https://doi.org/10.1002/smll.202406928
Rout B, Dhoubhadel M S, Poudel P R, Kummari V C, Pandey B, Deoli N T, et al. An overview of the facilities, activities, and developments at the University of North Texas Ion Beam Modification and Analysis Laboratory (IBMAL). AIP Conf Proc [Internet]. 2013 Jul. 3; 1544(1):11-8. Available from: https://doi.org/10.1063/1.4813454
Sharma M, Parashar M, Saini D K, Byers T A, Bowen C, Khanal M N, et al. In-Situ Characterization Tools for Evaluating Radiation Tolerance and Elemental Migration in Perovskites. In: 2024 IEEE 52nd Photovoltaic Specialist Conference (PVSC). 2024. p. 496-8.
Matej Mayer. SIMNRA User's Guide. 1997 Apr [cited 2024 Jul 22]; Available from: https://mam.home.ipp.mpg.de/Report %20IPP %209-113.pdf
Ziegler J F, Ziegler M D, Biersack J P. SRIM—The stopping and range of ions in matter (2010). Nucl Instrum Methods Phys Res B [Internet]. 2010; 268(11):1818-23. Available from: https://www.sciencedirect.com/science/article/pii/S0168583X10001862
Silva T F, Rodrigues C L, Mayer M, Moro M V, Trindade G F, Aguirre F R, et al. MultiSIMN4RA: A computational tool for self-consistent ion beam analysis using SIMNRA. Nucl Instrum Methods Phys Res B [Internet]. 2016; 371:86-9. Available from: https://www.sciencedirect.com/science/article/pii/S0168583X15010459
Steele J A, Solano E, Hardy D, Dayton D, Ladd D, White K, et al. How to GIWAXS: Grazing Incidence Wide Angle X-Ray Scattering Applied to Metal Halide Perovskite Thin Films. Adv Energy Mater [Internet]. 2023 Jul. 1; 13(27):2300760. Available from: https://doi.org/10.1002/aenm.202300760
Ashiotis G, Deschildre A, Nawaz Z, Wright J P, Karkoulis D, Picca F E, et al. The fast azimuthal integration Python library: pyFAI. J Appl Crystallogr [Internet]. 2015 Apr; 48(2):510-9. Available from: doi.org/10.1107/S1600576715004306

TABLE 1
Atomic concentrations of unaged control PSC as determined using RBS

| Layer-1 | | | | | |
|---|---|---|---|---|---|
| Ag | Layer-2 | Layer-3 | Layer-4 | Layer-5 | Layer-6 |
| electrode | BCP | C₆₀ | Perovskite | 2-PACZ | ITO |
| (×10¹⁵ | (×10¹⁵ | (×10¹⁵ | (×10¹⁵ | (×10¹⁵ | (×10¹⁵ |
| atoms/cm²) | atoms/cm²) | atoms/cm²) | atoms/cm²) | atoms/cm²) | atoms/cm²) |
| 513.75 | 159.09 | 255.73 | 2646.84 | 14.39 | 989.52 |
| O | H | C | H | H | O |
| 15.49 | 66.33 | 248.69 | 550.97 | 2.18 | 703.17 |
| Ag | C | Ag | C | C | Br |
| 495.72 | 85.85 | 7.04 | 403.38 | 1.73 | 30.08 |
| I | N | | N | N | Ag |
| 2.54 | 6.91 | | 451.96 | 0.22 | 5.15 |
| | | | 0 | P | In |
| | | | 251.08 | 0.20 | 105.71 |
| | | | Br | I | Sn |
| | | | 44.63 | 10.07 | 54.93 |
| | | | Ag | | I |
| | | | 10.05 | | 90.46 |
| | | | I | | |
| | | | 650.96 | | |
| | | | Cs | | |
| | | | 72.93 | | |
| | | | Pb | | |
| | | | 210.88 | | |

TABLE 2
Atomic concentrations of control PSC after aging at
50° C. for 120 h as determined using RBS

| Layer-1 | | | | | |
|---|---|---|---|---|---|
| Ag | Layer-2 | Layer-3 | Layer-4 | Layer-5 | Layer-6 |
| electrode | BCP | C₆₀ | Perovskite | 2-PACZ | ITO |
| (×10¹⁵ | (×10¹⁵ | (×10¹⁵ | (×10¹⁵ | (×10¹⁵ | (×10¹⁵ |
| atoms/cm²) | atoms/cm²) | atoms/cm²) | atoms/cm²) | atoms/cm²) | atoms/cm²) |
| 538.53 | 63.36 | 261.55 | 2729.91 | 4.49 | 957.25 |
| O | H | C | H | H | O |
| 61.32 | 20.96 | 251.51 | 652.33 | 2.22 | 653.59 |
| Ag | C | Ag | C | C | Br |
| 472.11 | 27.08 | 10.04 | 353.75 | 1.75 | 30.29 |
| I | N | | N | N | Ag |
| 5.10 | 2.26 | | 451.85 | 0.25 | 9.11 |
| | Br | | O | P | In |
| | 4.02 | | 251.67 | 0.28 | 105.53 |
| | I | | Br | I | Sn |
| | 9.04 | | 30.28 | | 68.28 |
| | | | Ag | | I |
| | | | 75.21 | | 90.45 |
| | | | I | | |
| | | | 633.81 | | |
| | | | Cs | | |
| | | | 69.65 | | |
| | | | Pb | | |
| | | | 211.37 | | |

TABLE 3
Atomic concentrations of unaged SnO₂ PSC as determined using RBS

| Layer-1 | | | | | |
|---|---|---|---|---|---|
| Ag | Layer-2 | Layer-3 | Layer-4 | Layer-5 | Layer-6 |
| electrode | BCP | C₆₀ | Perovskite | 2-PACZ | ITO |
| (×10¹⁵ | (×10¹⁵ | (×10¹⁵ | (×10¹⁵ | (×10¹⁵ | (×10¹⁵ |
| atoms/cm²) | atoms/cm²) | atoms/cm²) | atoms/cm²) | atoms/cm²) | atoms/cm²) |
| 531.49 | 112.32 | 258.44 | 2751.43 | 13.42 | 913.21 |
| O | H | C | H | H | O |
| 58.66 | 87.20 | 249.35 | 655.67 | 2.21 | 599.10 |
| Ag | C | Ag | C | C | Br |
| 472.83 | 25.13 | 9.09 | 355.31 | 1.69 | 38.05 |
| | | | N | N | Ag |
| | | | 451.00 | 0.23 | 0.00 |
| | | | O | P | In |
| | | | 259.59 | 0.22 | 130.25 |
| | | | Br | I | Sn |
| | | | 63.30 | 9.08 | 70.71 |
| | | | Ag | | I |
| | | | 14.54 | | 75.10 |
| | | | I | | |
| | | | 677.84 | | |
| | | | Cs | | |
| | | | 42.55 | | |
| | | | Pb | | |
| | | | 231.64 | | |

TABLE 4
Atomic concentrations of SnO₂ PSC after aging at
50° C. for 120 h as determined using RBS

| Layer-1 | | | | | |
|---|---|---|---|---|---|
| Ag | Layer-2 | Layer-3 | Layer-4 | Layer-5 | Layer-6 |
| electrode | BCP | C₆₀ | Perovskite | 2-PACZ | ITO |
| (×10¹⁵ | (×10¹⁵ | (×10¹⁵ | (×10¹⁵ | (×10¹⁵ | (×10¹⁵ |
| atoms/cm²) | atoms/cm²) | atoms/cm²) | atoms/cm²) | atoms/cm²) | atoms/cm²) |
| 559.65 | 123.30 | 230.13 | 2858.95 | 9.34 | 920.05 |
| O | H | C | H | H | O |
| 120.07 | 86.07 | 220.10 | 752.48 | 2.08 | 600.26 |
| Ag | C | Ag | C | C | Br |
| 439.56 | 12.08 | 10.04 | 351.06 | 1.58 | 37.71 |
| | Sn | | N | N | Ag |
| | 25.14 | | 347.34 | 0.46 | 0.00 |
| | | | O | P | In |
| | | | 348.87 | 0.19 | 131.35 |
| | | | Br | I | Sn |
| | | | 49.08 | 5.04 | 70.32 |
| | | | Ag | | I |
| | | | 60.12 | | 75.39 |
| | | | Sn | | Pb |
| | | | 10.01 | | 5.01 |
| | | | I | | |
| | | | 653.52 | | |
| | | | Cs | | |
| | | | 42.06 | | |
| | | | Pb | | |
| | | | 244.42 | | |

TABLE 5
Atomic concentrations of unaged
O₃—SnO₂ PSC as determined using RBS

| Layer-1 | | | | | |
|---|---|---|---|---|---|
| Ag | Layer-2 | Layer-3 | Layer-4 | Layer-5 | Layer-6 |
| electrode | BCP | C₆₀ | Perovskite | 2-PACZ | ITO |
| (×10¹⁵ | (×10¹⁵ | (×10¹⁵ | (×10¹⁵ | (×10¹⁵ | (×10¹⁵ |
| atoms/cm²) | atoms/cm²) | atoms/cm²) | atoms/cm²) | atoms/cm²) | atoms/cm²) |
| 577.15 | 165.25 | 243.00 | 2822.00 | 16.89 | 958.00 |
| O | H | C | H | H | O |
| 70.00 | 132.25 | 235.00 | 790.00 | 2.14 | 677.00 |
| Ag | C | Ag | C | C | Br |
| 507.15 | 5.00 | 8.00 | 400.00 | 1.68 | 30.00 |
| | Sn | | N | N | In |
| | 28.00 | | 430.00 | 0.17 | 104.98 |
| | | | 0 | P | Sn |
| | | | 250.00 | 0.15 | 61.02 |
| | | | Br | I | I |
| | | | 40.00 | 12.75 | 85.00 |
| | | | Ag | | |
| | | | 12.00 | | |
| | | | I | | |
| | | | 625.00 | | |
| | | | Cs | | |
| | | | 45.00 | | |
| | | | Pb | | |
| | | | 230.00 | | |

TABLE 6
Atomic concentrations of O₃—SnO₂ PSC after
aging at 50° C. for 120 h as determined using RBS

| Layer-1 | | | | | |
|---|---|---|---|---|---|
| Ag | Layer-2 | Layer-3 | Layer-4 | Layer-5 | Layer-6 |
| electrode | BCP | C₆₀ | Perovskite | 2-PACZ | ITO |
| (×10¹⁵ | (×10¹⁵ | (×10¹⁵ | (×10¹⁵ | (×10¹⁵ | (×10¹⁵ |
| atoms/cm²) | atoms/cm²) | atoms/cm²) | atoms/cm²) | atoms/cm²) | atoms/cm²) |
| 529.03 | 148.04 | 260.34 | 2659.50 | 4.36 | 1081.31 |
| O | H | C | H | H | O |
| 31.87 | 110.60 | 248.27 | 553.02 | 2.19 | 780.25 |
| Ag | C | Ag | C | C | Br |
| 497.16 | 10.05 | 12.07 | 402.19 | 1.74 | 15.08 |
| | Sn | | N | N | In |
| | 27.38 | | 452.47 | 0.22 | 95.51 |
| | | | O | P | Sn |
| | | | 251.37 | 0.20 | 61.36 |
| | | | Br | | I |
| | | | 45.25 | | 126.01 |
| | | | Ag | | Ag |
| | | | 30.16 | | 3.11 |
| | | | I | | |
| | | | 628.43 | | |
| | | | Cs | | |
| | | | 65.36 | | |
| | | | Pb | | |
| | | | 231.26 | | |

TABLE 7
Integrated peak area ratio between PVSK
(110) and degradation product for unaged
PSCs vs PSCs subjected to 50° C. for 120 h.

| Device | Unaged | Aged |
|---|---|---|
| Control PSC 0.3º (top surface) | 1.846 | 0.233 |
| Control PSC 5° (Bulk) | Inf | 0.214 |
| SnO₂ PSC 0.3º (top surface) | 3.228 | 1.877 |
| SnO₂ PSC 5° (Bulk) | Inf | Inf |
| O₃—SnO₂ PSC 0.3º (top surface) | 6.53 | 5.37 |
| O₃—SnO₂ PSC 5° (Bulk) | Inf | Inf |

### Supplementary Note 1

For RBS analysis using SIMNRA and MultiSIMNRA programs, the layer's structure or thickness can be expressed as aerial density (atoms/cm²). Then to begin with, the known thicknesses of the individual layers are entered to simulate the spectrum. The simulated spectrum is then compared with the experimental spectrum and then changes in the layer and elemental composition are made accordingly to best fit the simulated curve to the experimental curve. Once the best fit is achieved, the information for the individual layers is extracted. To determine the goodness of the fit and uncertainty of the fitted curve, Reduced chi-square

$$( {χ}_{r}^{2} )$$

value was obtained from the SIMNRA program. Reduced chi-square

$$( {χ}_{r}^{2} )$$

is defined as the

$${χ}_{r}^{2} = \frac{{χ}^{2}}{N} .$$

Where χ² represents the quadratic deviation between experimental and simulated data for the desired regions and N is the number of channels. The channels are calibrated to the backscattered helium ion energy. The

$${χ}_{r}^{2}$$

value between 2 and 5 suggests a satisfactory agreement between the experimental data and the simulation.^{[1,2]} The

$${χ}_{r}^{2}$$

values are determined within the 1357-1820 keV energy range. The

$${χ}_{r}^{2}$$

values for sample ID 20 and 22 are 2.42 and 2.41 respectively, and for sample ID 1 and 3 are 2.04 and 2.58 respectively, also for sample ID 7,13 are 2.95 and 3.03 respectively.

Sensitivity analysis was performed on sample ID 22 by manually changing the concentration of Ag in layer 4 and then simulating the fits. This analysis has shown that any change in the Ag concentration from the best fit value (with

$${χ}_{r}^{2}$$

value of 2.41) is leading to a drastic increase in the

$${χ}_{r}^{2}$$

value and hence affecting the goodness of the fit.

### REFERENCES CITED HEREIN

Matej Mayer, 1997.
T. F. Silva, C. L. Rodrigues, M. Mayer, M. V Moro, G. F. Trindade, F. R. Aguirre, N. Added, M. A. Rizzutto, M. H. Tabacniks, Nucl Instrum Methods Phys Res B 2016, 371, 86.

### Example 2

### Steps to Measure Mobile Ion Concentration (Nₒ)

1) Determine the architecture of the solar cell, whether it is in an inverted p-i-n configuration or the regular n-i-p configuration. This is important as the architecture determines the direction in which the probes are to be connected to the sample. The measurement needs to be performed in forward bias under dark hence the probe connections are as follows
p-i-n configuration—connect the positive probe to the bottom electrode and connect the negative probe to the top electrode.
n-i-p configuration—connect the negative probe to the bottom electrode and connect the positive probe to the top electrode.

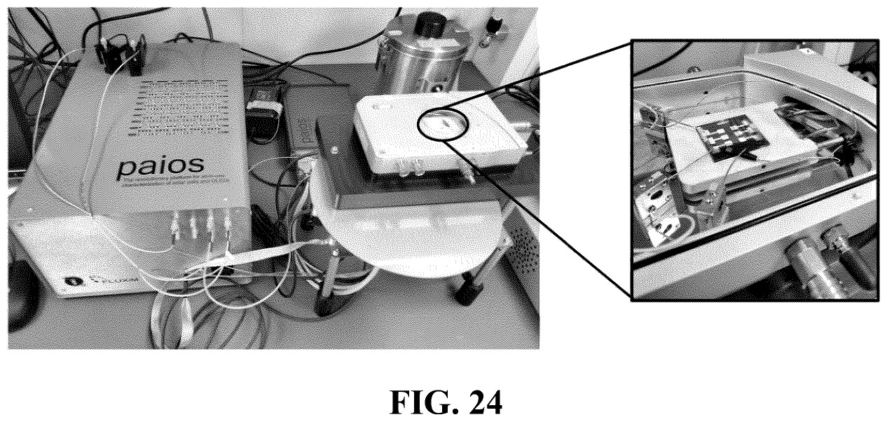

1) PAIOS (an all-in-one characterization equipment for the solar cells, batteries, and OLEDs) is used to make the measurements on the sample. The equipment is shown in FIG. 24.

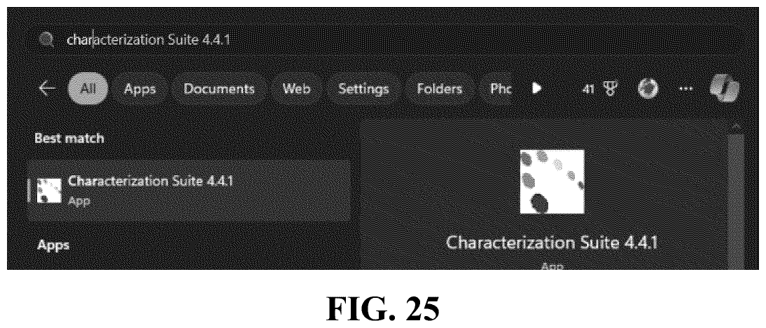

2) Follow the instructions to switch on the equipment (equipment-specific steps) and open characterization suite 4.4 (software used to connect with the PAIOS equipment) FIG. 25.

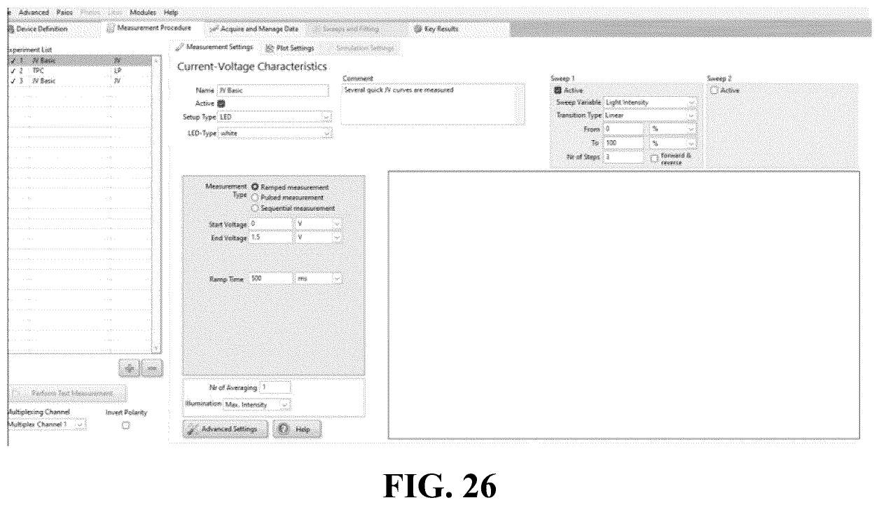

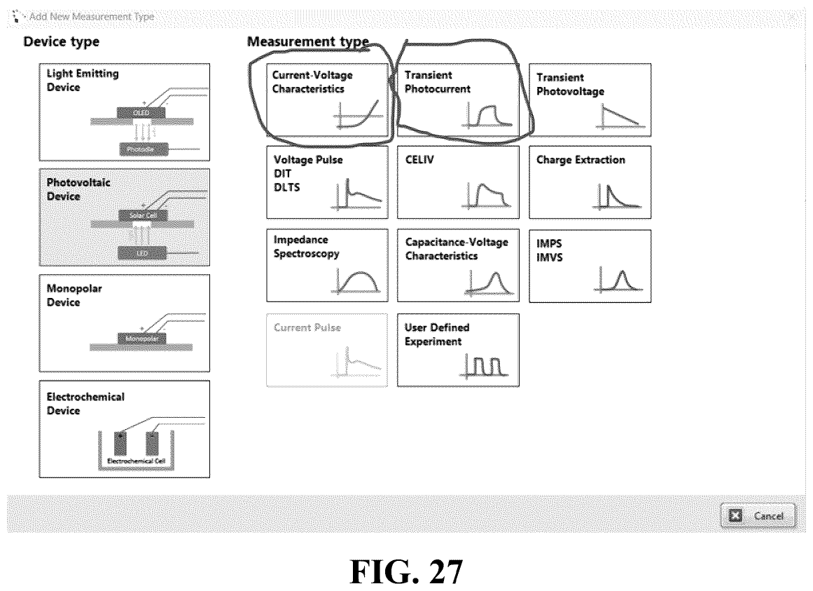

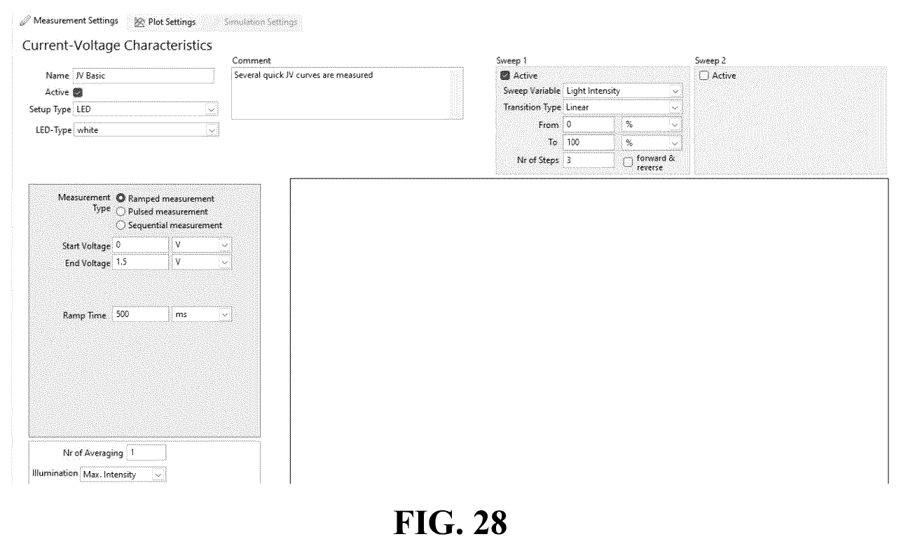

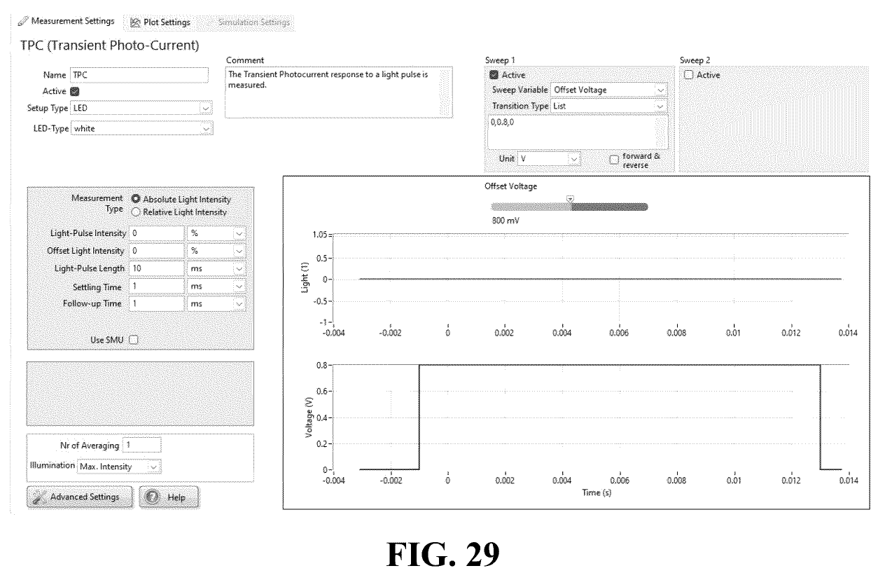

3) In the experiment list tab add three experiments (FIG. 26-FIG. 29)
i) JV measurement (voltage range 0-1.5V and sweep of light intensity at three values 0, 50%, 100%)—This measurement is used to determine if the electronic response of the measured sample/device is as expected or not.
ii) Transient photocurrent measurement—But since the measurement is to be performed in the dark change the light intensity to 0 (Hence the measurement is denoted as “Transient dark current”). Sweep offset voltage as a list and add the values as 0, 0.8, 0. Set the pulse length to be 10 ms with a follow-up and settling time of 1 ms each—This measurement is used to determine the transient dark current response of the sample which will be used to calculate the Nₒ.
iii) JV measurement—Same parameters as above—This is to determine if the measured sample/device is not showing any changes in its behaviour after performing the transient dark current measurement.

4) Perform the measurements on the sample.

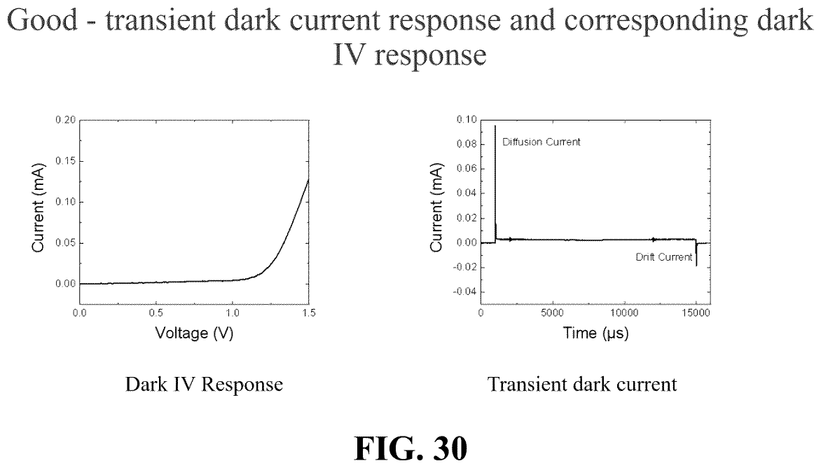

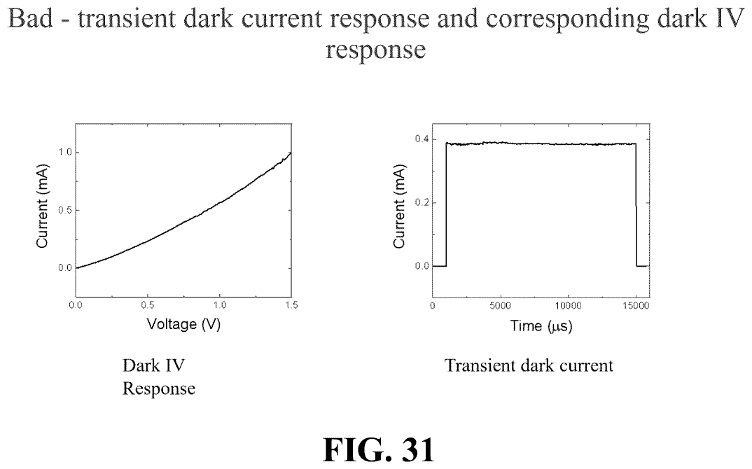

5) FIG. 30 shows good transient dark current response and corresponding dark IV response. FIG. 31 shows bad transient dark current response and corresponding dark IV response.

Once the sample is measured save the file and then extract text files for the plots of transient dark current response, and JV response if needed.

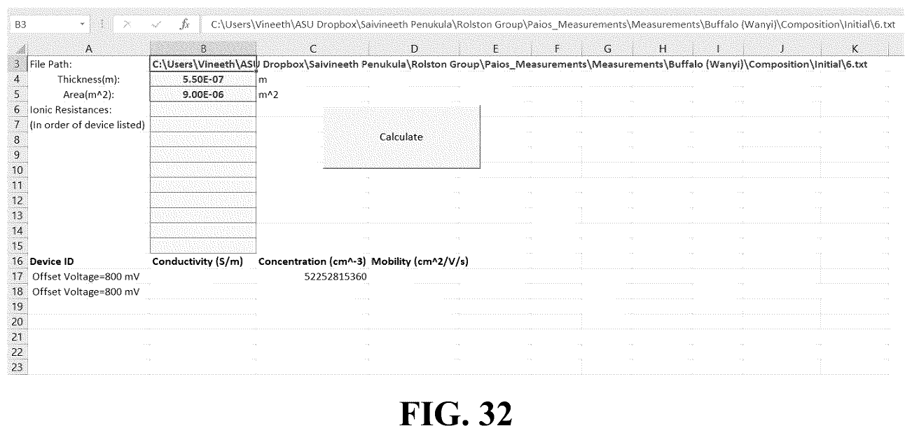

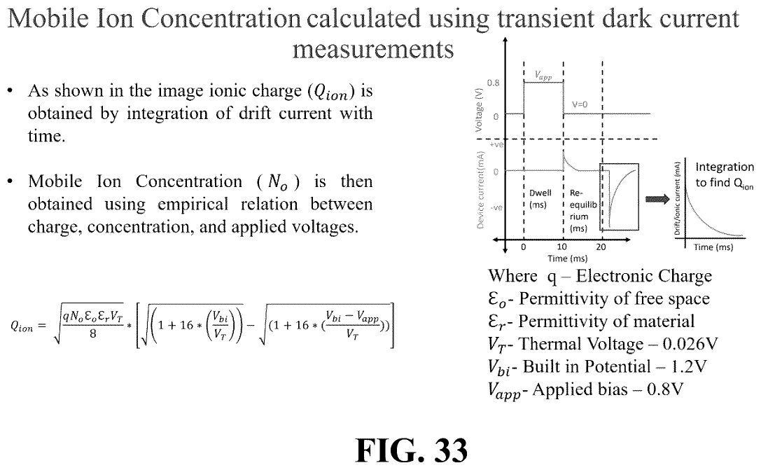

7) Calculation of Nₒ
Once the text file is extracted, copy the file path and paste it in the field in the excel sheet—Ion migration calculator (developed by one of the undergraduate students) as shown in FIG. 32 and hit calculate—give the value of Nₒ
For manual calculation—Open the extracted text file, isolate the negative current response in the transient current response, and replot the graph. Calculate the are under the graph (area under current vs time curve—gives charge) to get ionic charge. Once the ionic charge is calculated use the empirical formula to calculate Nₒ (FIG. 33).

8) Threshold Nₒ measurement—Attach the temperature-controlled stage to PAIOS and place the sample on the stage. Keep increasing the temperature from room temperature at 10K intervals and measure Nₒ and JV response at every interval. Failure of sample is indicated by bad electronic response (JV response) accompanied by bad transient dark current response.

In embodiments, the testing described above is applied to perovskite solar cells, memristors, mining ores, and battery materials.

### Example 3

### Steps to Calculate Ionic Mobility (μ)

The ionic mobility (μ) of the perovskite solar cells is determined using the relationship between ionic conductivity (σ) and mobile ion concentration (Nₒ). The equation to show the relationship is mentioned below

$$μ = \frac{σ}{q * {N}_{o}}$$

Where q—electronic charge, Nₒ—mobile ion concentration, σ—Ionic conductivity So as shown in the equation to calculate the ionic mobility of the perovskite solar cell, one needs to have an idea of the Nₒ and σ.

### Nₒ is Measured in the Exact Same Way as Mentioned in the Previous SOP.

### Calculation of Ionic Conductivity:

The ionic conductivity (σ) of PSCs is measured by performing electrochemical impedance spectroscopy (EIS).

In EIS, a small sinusoidal voltage of 0.05 V is applied to PSC, and the transient current is measured in the frequency range of 10 Hz to 10 MHz.

Based on the transient current measured and the sinusoidal voltage input applied a plot between real impedance vs imaginary impedance is generated (Nyquist plot).

An equivalent circuit that can model the behavior of the device is fit onto the Nyquist plot to obtain the resistance and capacitance components that affect the ionic characteristics of the device.

The σ of the PSCs is then calculated by using the measured ionic resistance, perovskite thickness, and the area of the electrode, as shown below

$$σ = \frac{t}{{R}_{i} * A}$$

Where σ—ionic conductivity, t—thickness of perovskite, Rᵢ—ionic resistance, and A—the area of the electrode.

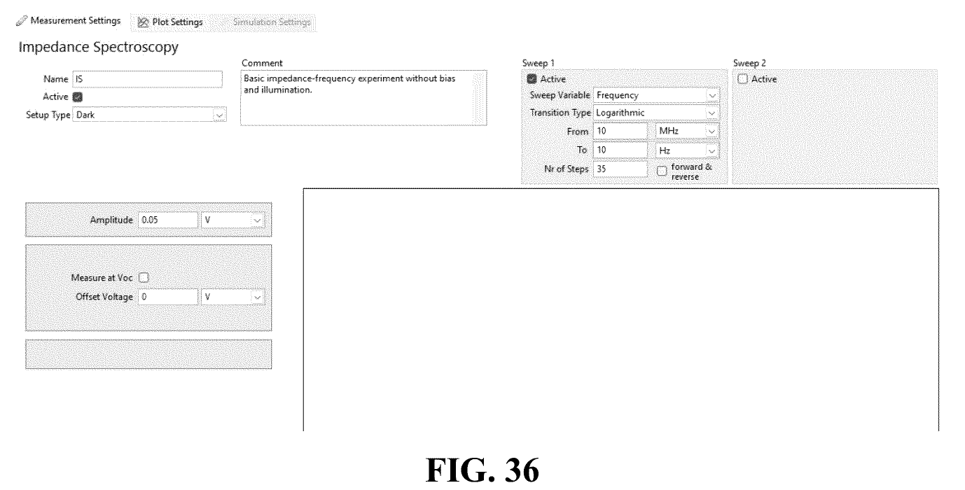

Recipe of the measurement shown in FIG. 36.

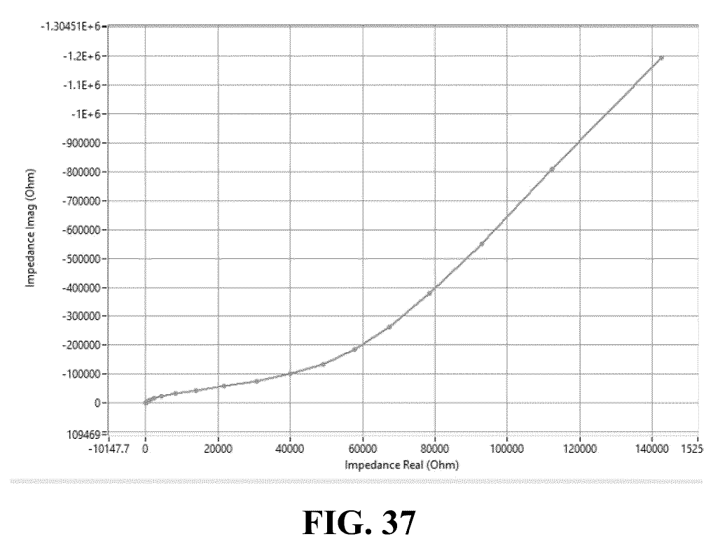

Sample Nyquist plot shown in FIG. 37.

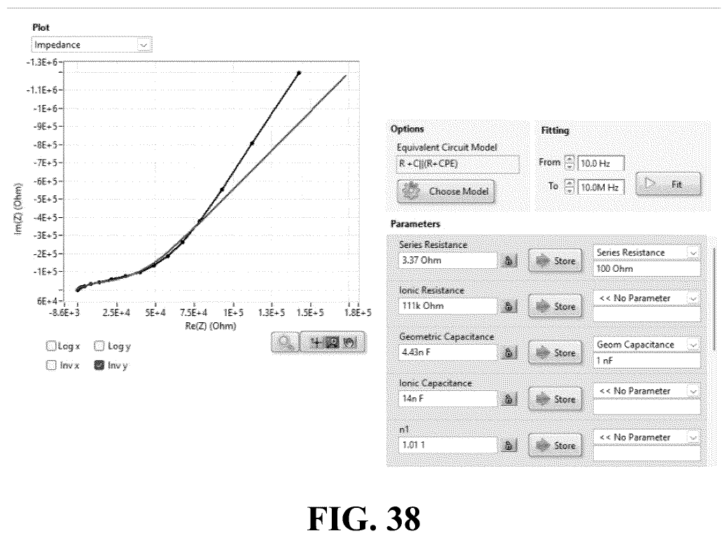

Sample Equivalent circuit fit shown in FIG. 38

Once the mobile ion concentration and ionic conductivity are determined ionic mobility is calculated using the above-mentioned formula.

### Example 4

Sample battery material measurements for mobile ion concentration

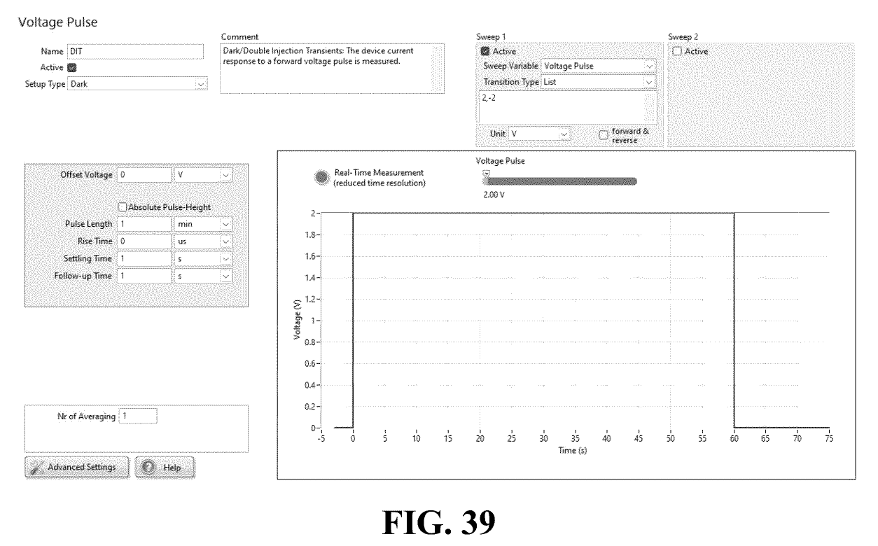

Recipe adapted from “Jordi Sastre et. al., Blocking lithium dendrite growth in solid-state batteries with an ultrathin amorphous Li—La—Zr—O solid electrolyte, Commun Mater 2, 76 (2021). https://doi.org/10.1038/s43246-021-00177-4” (FIG. 39).

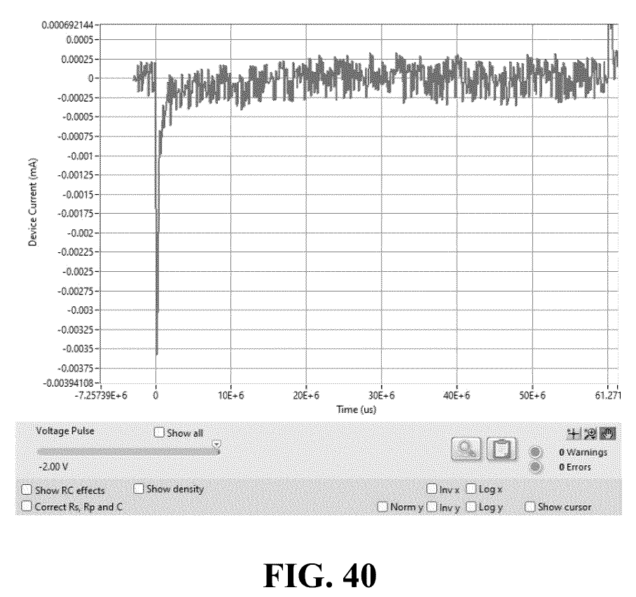

Transient current response that is used to calculate the mobile ion concentration shown in FIG. 40.

### Example 5

### Mechanical and Ionic Characterization for Organic Semiconductor—Incorporated Perovskites for Stable 2D/3D Heterostructure Perovskite Solar Cells

Hybrid metal halide perovskite (MHP) materials, while being promising for photovoltaic technology, also encounter challenges related to material stability. Combining two-dimensional (2D) MHPs with three-dimensional (3D) MHPs offers a viable solution, yet there is a gap in our understanding of the stability among various 2D materials. We report on the mechanical, ionic, and environmental stability of various 2D MHP ligands and demonstrate an improvement with the use of a quarter-thiophene based organic cation (4TmI) that forms an organic-semiconductor incorporated MHP structure. We show that the best balance of mechanical robustness, environmental stability, ion activation energy, and reduced mobile ion concentration under accelerated aging is achieved with the usage of 4TmI. Without wishing to be bound bt theory, addressing mechanical and ion-based degradation modes using this built-in barrier concept with a material system that also shows improvements in charge extraction and device performance, MHP solar devices can be designed for both reliability and efficiency.

### INTRODUCTION

Perovskite materials, especially hybrid metal halide perovskite (MHP), have garnered significant attention because of their enormous potential in the field of solar cells.^{[1,2]} However, the further development of perovskite materials has been plagued by their stability challenges.^{[3,4]} Because of the “soft” ionic nature of the lattice while being brittle and unable to plastically deform, three-dimensional (3D) MHP materials are highly susceptible to light, heat, moisture, oxygen, delamination,^{[5]} and electric field, etc.^{[6,7]} More importantly, because of the relatively weak binding energy between the cations and anions in the lattice, ion migration remains one of the primary degradation pathways^{[8-10]}.

Two-dimensional (2D) MHP materials intercalated with large organic cations have shown improved operational stability.^{[1,12]} Therefore, combining 2D and 3D MHP materials together in the form of heterostructures was introduced and this strategy has already contributed to several of the best performing and most stable perovskite solar cell (PSC) devices.^{[12-17]} BAI, OAI, and PEAI are conventional large organic cations that form Ruddlesden-Popper (RP) phase 2D MHP, and their properties have been widely investigated.^{[18]} These materials have also enabled improved bonding and deformability with improved mechanical robustness, an aspect that can contribute to stability improvements.^{[19]} Notably, our earlier studies have reported a unique series of quarter-thiophene based organic cations, i.e. 4TmI and halogen-4TmI, which form organic semiconductor-incorporated perovskite materials (OSiPs).^{[20-23]} Due to the well-aligned energy level with type-II alignment for charge extraction, these molecules have enabled PSCs with excellent efficiency and stability.

However, even though 2D MHPs are generally considered more stable than 3D MHPs, the variation of environmental and mechanical stability among different 2D MHP materials is still not well understood. Moreover, there has not been a quantitative understanding of the stability evolution of PSCs incorporating 2D MHPs. We showed that ion migration can be quantified in terms of mobile ion concentration (Nₒ), a quantity that can give a more complete understanding of the ionic character of MHPs.^{[24,25]} It can be useful to establish a comprehensive comparison of environmental and mechanical stability among the 2D RP-phase MHPs with small organic cations and large conjugated cations and further bridge this 2D material stability and device stability through quantitative characterization.

### Non-Limiting, Exemplary Results and Discussions

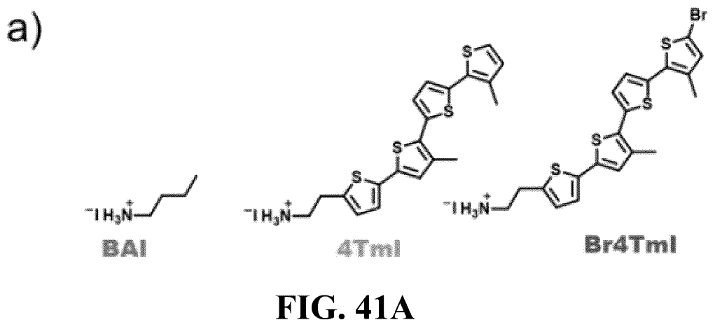

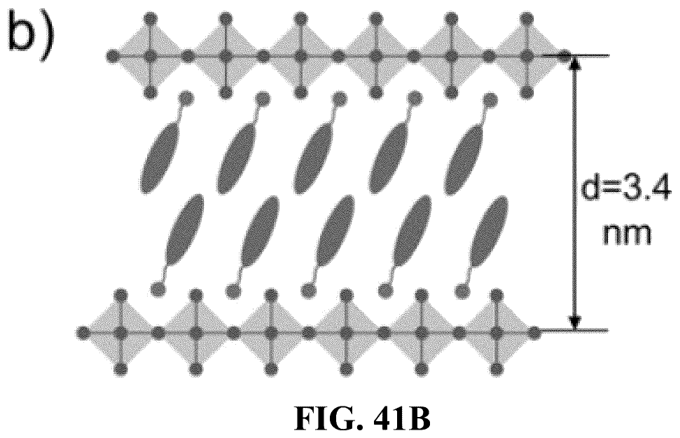

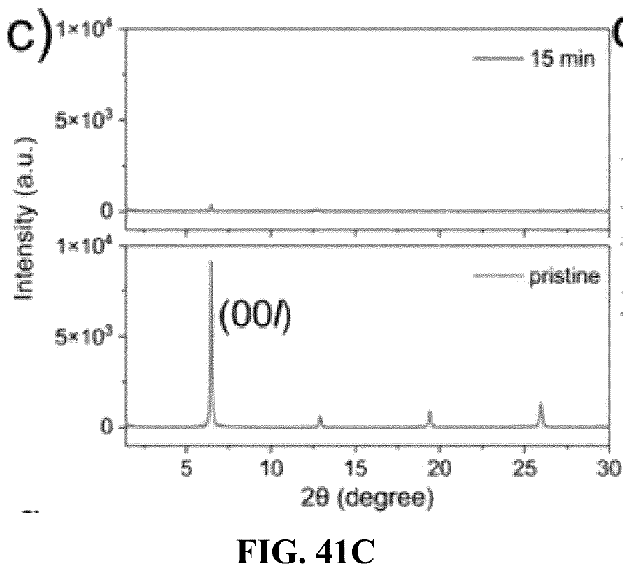

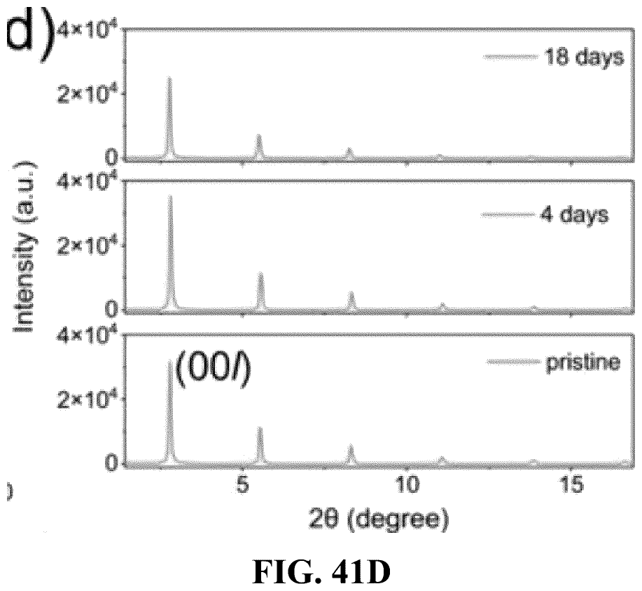

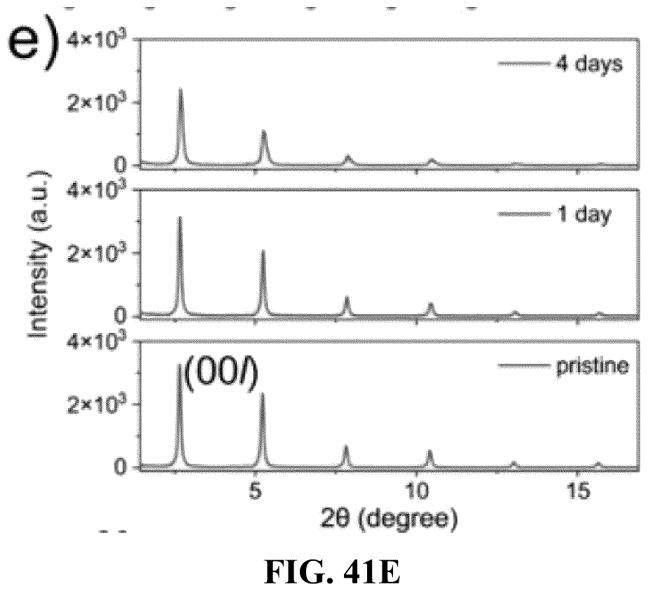

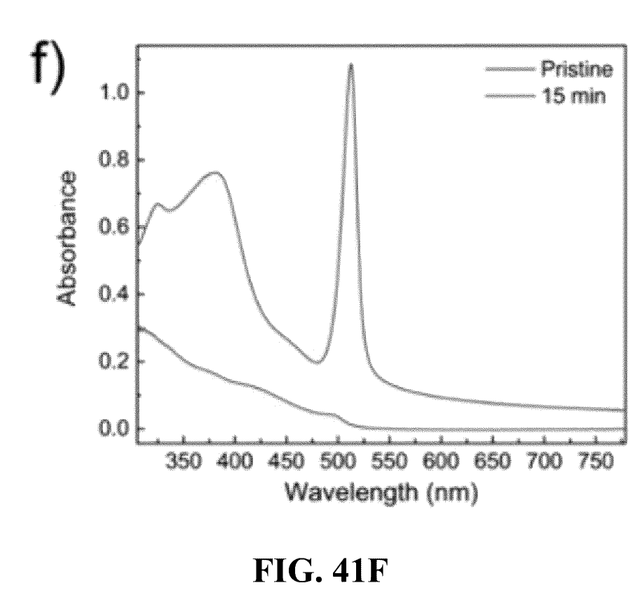

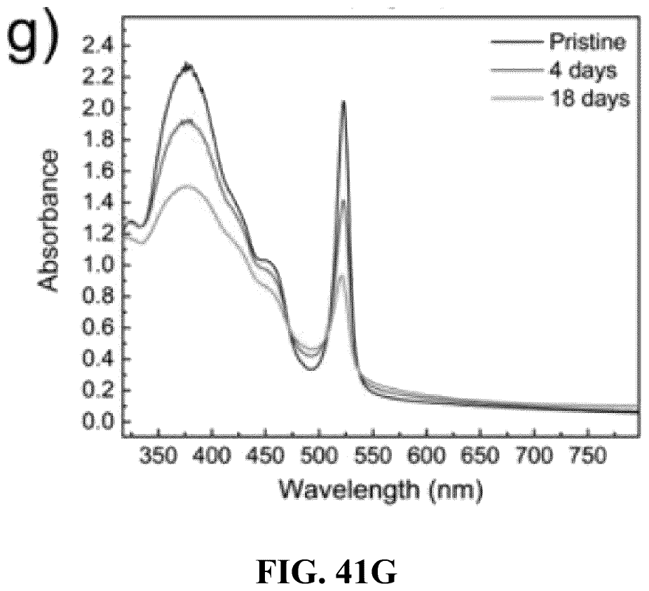

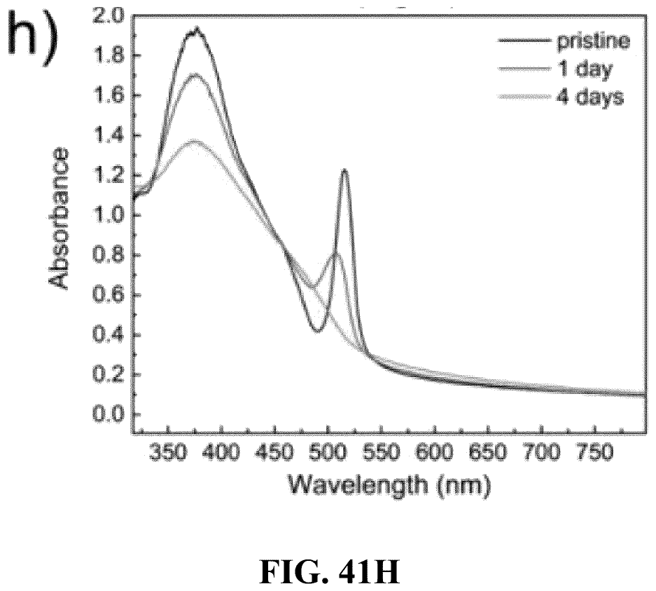

Here, we compared the stability of 2D RP-phase MHP materials in which widely-used aliphatic BAI, aromatic 4TmI, and Br4TmI (structures in FIG. 41A) are incorporated as organic cations, addressing aspects including photo, thermal, atmospheric, ionic, and mechanical stability. The stability of PSC devices based on the above MHPs are evaluated via improvements in ion migration through the quantification of mobile ion concentration and calculated activation energy of mobile ions along with thermal and light stability measurements. As a result, the best balance of mechanical robustness, environmental stability, ion activation energy, and reduced mobile ion concentration under accelerated aging is achieved with the usage of 4TmI.

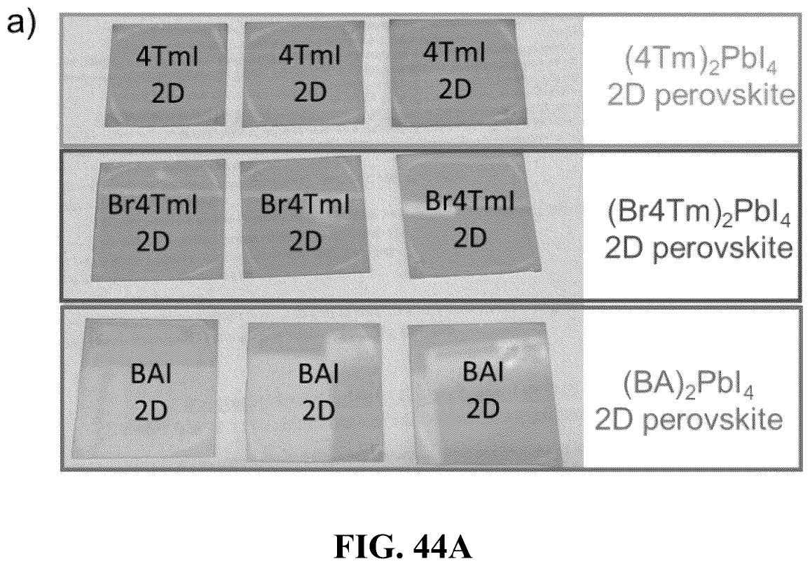

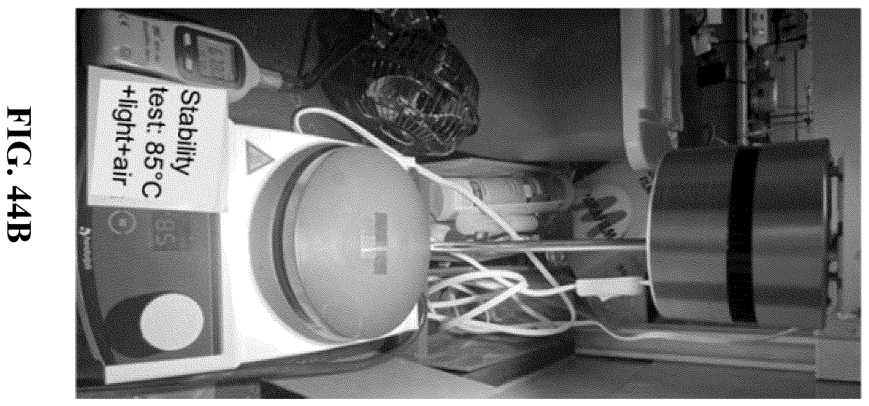

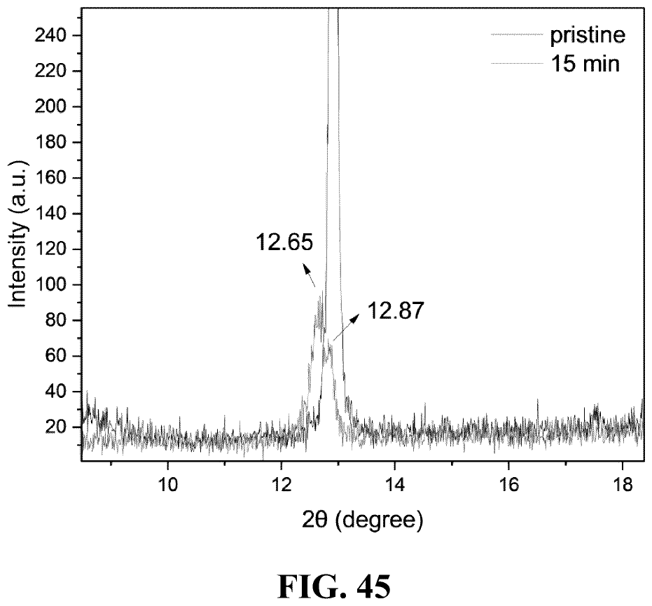

2D RP-phase MHP thin films were fabricated via spin-coating for initial, film-level environmental stability characterization. The XRD pattern reveals typical layered structures with calculated d-spacing as 1.4 nm, 3.2 nm, and 3.4 nm for (BA)₂PbI₄, (4Tm)₂PbI, and (Br4Tm)₂PbI₄, respectively (FIG. 41C-E). Note that the organic thiophene ligand layers between the PbI6 plane are organized together by van der Waal interactions and the distance between the PbI6 plane can be expanded as large as 3.4 nm (FIG. 41B), more than two-times higher compared to the 1.4 nm d-spacing of BAI 2D perovskites. The UV-vis spectra all reveal excitonic peaks at 513 nm, 523 nm, and 515 nm for (BA)₂PbI₄, (4Tm)₂PbI₄, and (Br4Tm)₂PbI₄, respectively (FIG. 41F-H). A rigorous triple-stress condition combining 85° C. heating, light, and ambient moisture was selected to probe environmental stability. XRD and UV-vis spectra were used to monitor the MHP film degradation under the triple-stress condition (FIG. 44A-44B). For (BA)₂PbI₄, accompanied by a rapid film color change from orange to yellow, the diminished XRD and UV-vis peaks clearly show that the whole film degraded within 15 minutes. The enlarged view also shows the emergence of a new peak at 12.65°, which is attributed to PbI2 (FIG. 45). However, for (4Tm)₂Pb, the stability was much better, as evidenced by XRD patterns that show similar crystallinity even after 18 days of exposure to the harsh triple-stress conditions. Only from the UV-vis spectra, we can observe a gradual decay of the excitonic peak at 523 nm. For (Br4Tm)₂PbI₄, the stability falls in between, revealed from initially a shift of the excitonic peak from 515 nm to 509 nm, and then a diminished peak after 4 days. Without wishing to be bound by theory, the brominated terminal thiophene in Br4TmI can speed up the photooxidation of iodide in the 2D perovskite lattice and cause degradation. (4Tm)₂PbI₄ and (Br4Tm)₂PbI₄, with a molecular formula of C₄₀H₃₈I₄N₂PbS₈ and C₄₀H₃₈Br₂I₄N₂PbS₈, respectively, have higher organic content and more bulky structure than conventional (BA)₂PbI₄ hybrids, which explains their superior stability performance as 2D RP-phase perovskite thin films. In summary, 2D MHP with 4TmI demonstrated the best environmental stability and thiophene-based 2D MHPs exhibited much better stability compared to conventional BA-based MHPs.

Mechanical stability of the 2D MHP with ligands BAI, 4TmI, and Br4TmI was quantified through fracture energy (G_{c}), which has been recognized as a key metric to quantify the reliability of multilayered devices.^{[26]} Studies have shown that traditional 3D perovskites, such as MAPbI3 and mixed-cation perovskites (e.g., MA/FA, Cs/FA and Cs/FA/MA), have low G_{c} (≤1.5 J/m2) values due to their fragile salt-like crystal structure.^{[27]} With such low G_{c} values, PSCs are susceptible to damage from various internal and external stressors, including in-service stresses caused by mismatches in the thermal expansion coefficients of different layers, as well as from device processing, manufacturing, and installation.^{[28]} These factors create a mechanical driving force for damage within the PSCs (G), ultimately leading to delamination when G>G_{c}. Any delamination will then create pathways for accelerated environmental degradation and loss of ohmic contact, resulting in decreased PCE and device failure.^{[19]}

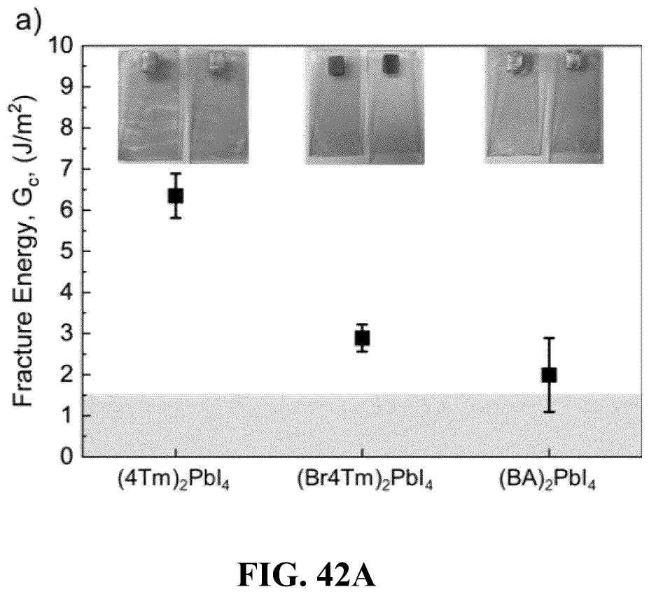

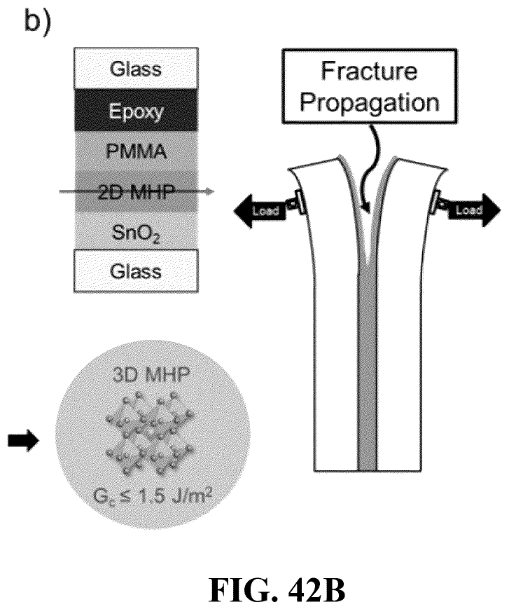

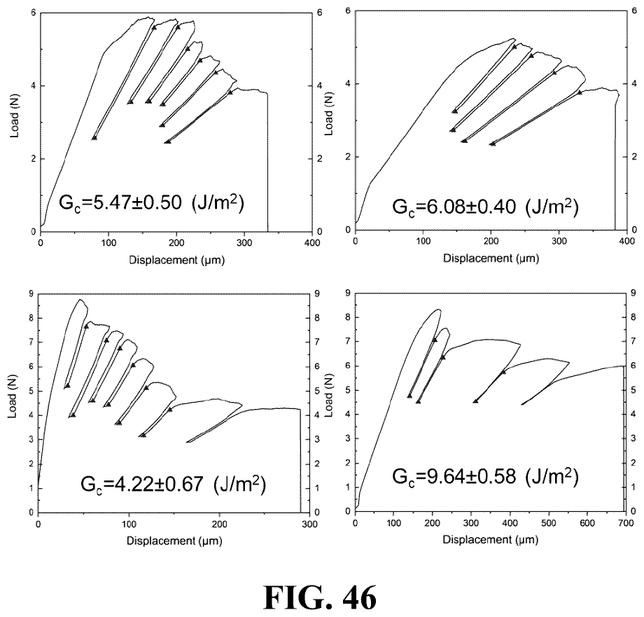

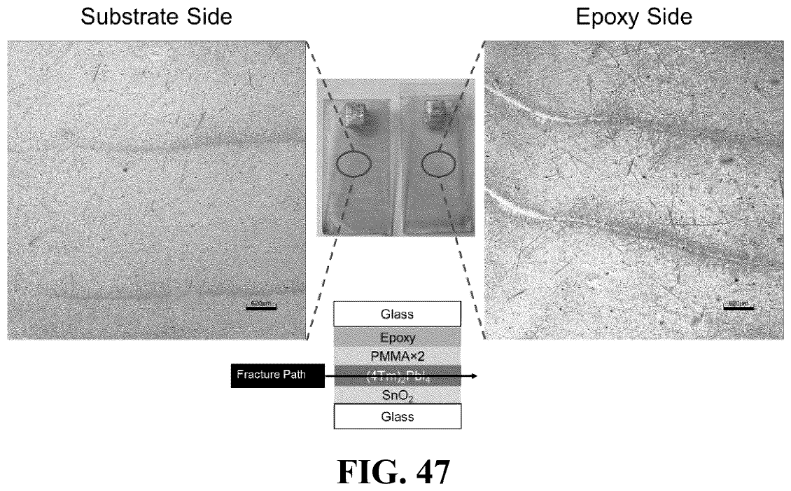

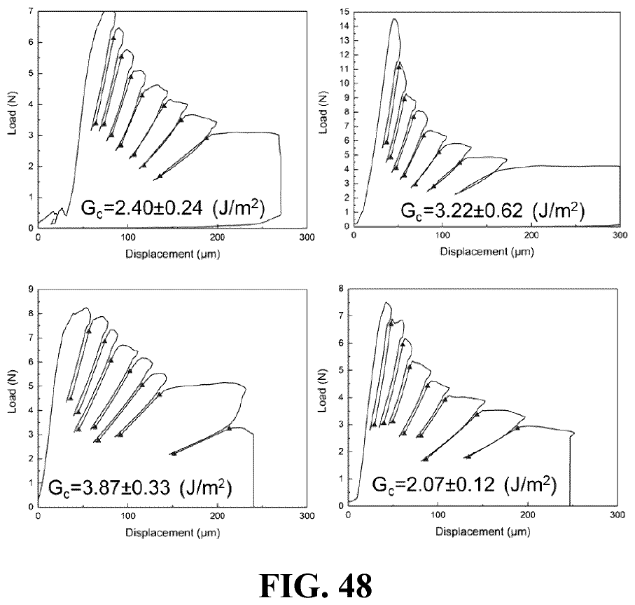

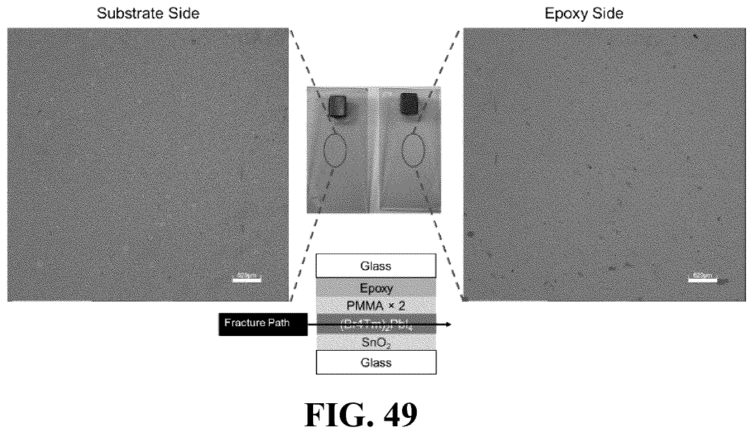

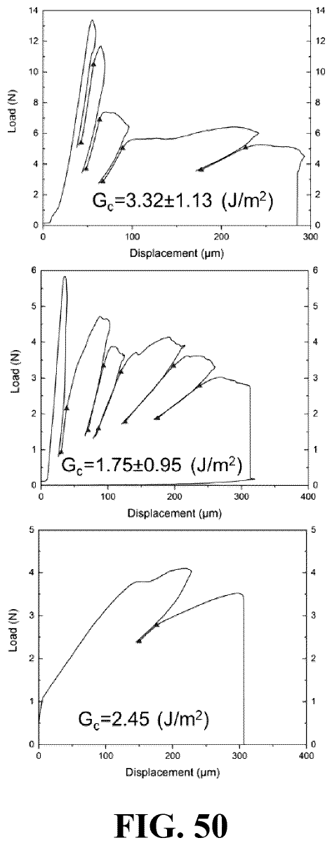

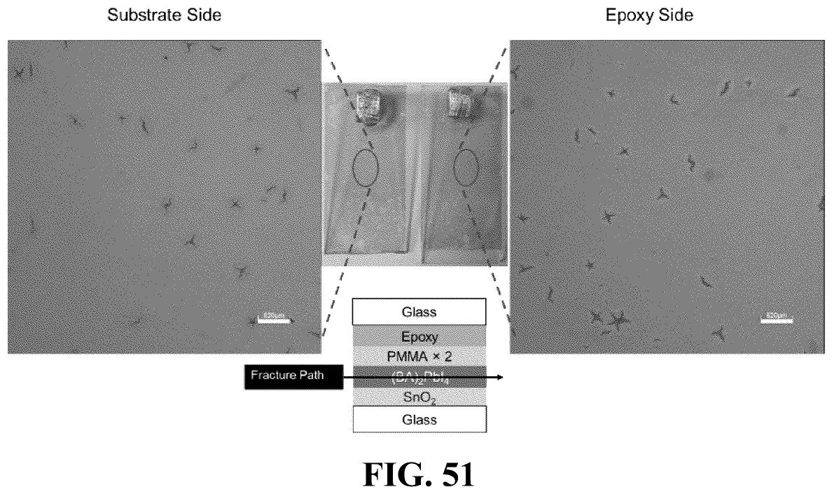

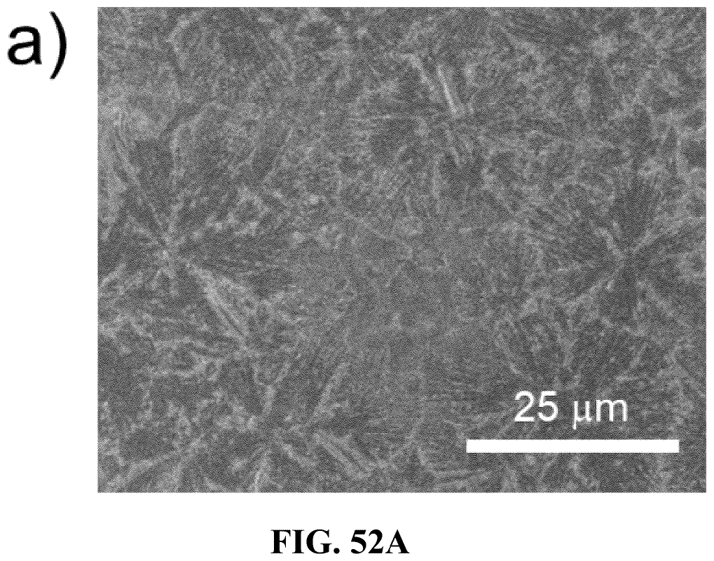

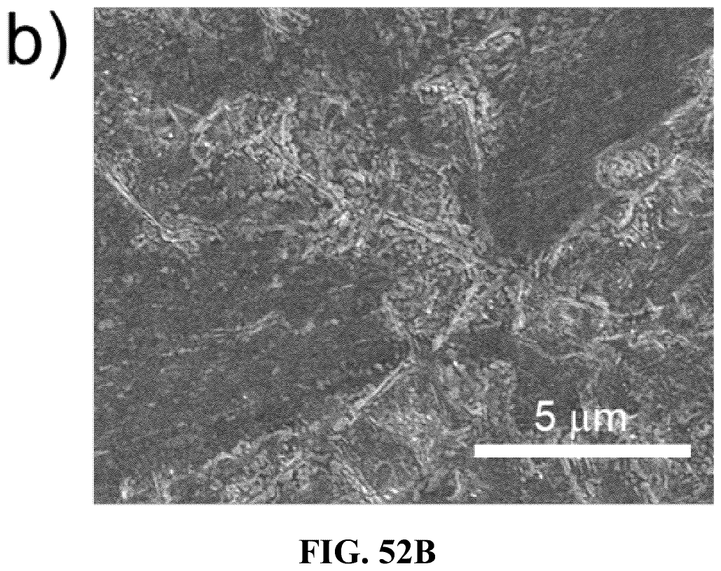

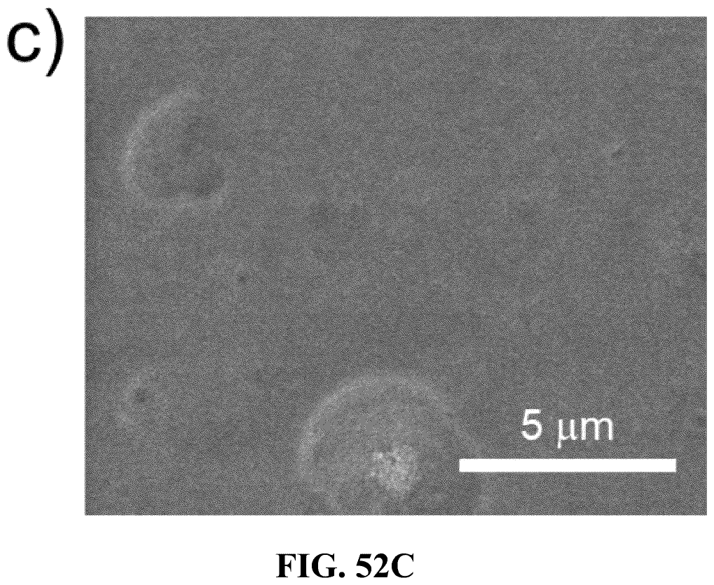

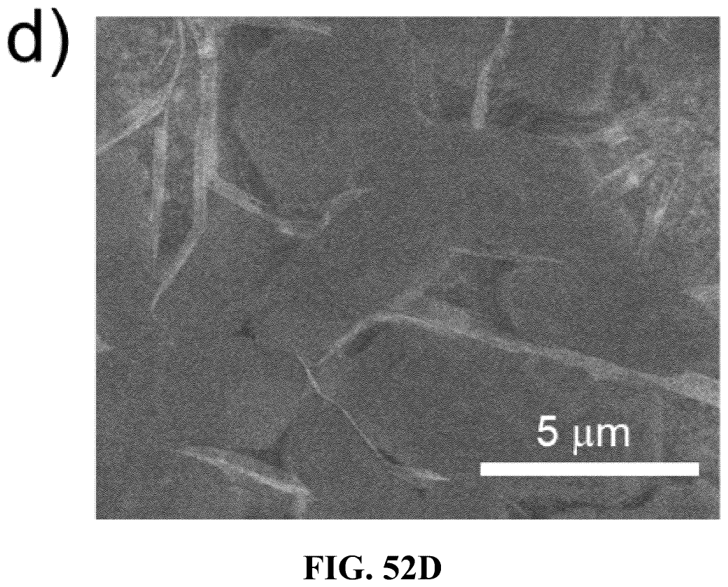

Therefore, investigating G_{c} is crucial for designing mechanically robust PSCs and achieving robust materials with a high G_{c} is essential for extending their operational lifetimes. However, little is known about the mechanical integrity of the emerging 2D perovskites. Our recent work suggested that pure RP-based perovskites with low n-values can exceed this low G_{c} threshold.^{[19]} Here, as shown in FIG. 42A-42B, we measured the G_{c} values of the 4TmI, Br4TmI, and BAI RP-phase 2D MHPs using a standard fracture configuration known as the double cantilever beam (DCB) test. To conduct the DCB test, we attached an epoxy-covered top piece of glass on to film substrates to create a sandwich-like structure (FIG. 42A) and protected the perovskite from epoxy by using a polymethyl methacrylate coating on top of the film, which was then subjected to uniaxial loading at controlled displacement rates to propagate a crack down the length of the sample. The G_{c} results and representative sample photographs after measurements are shown in FIG. 42B (raw fracture data and optical images after measurements are shown in FIGS. 46-51). Based on the optical images, perovskite material remained on both sides of the fractured DCB samples, indicating cohesive failure in the measured 2D MHP materials. This enables a direct comparison of G_{c} values to determine the mechanical robustness of the 2D MHP materials. The 4Tm-based 2D MHP has a G_{c} of 6.35±0.54 J/m², which is the highest of any unmodified MHP that has been measured to date, and it is significantly higher than the measured Br4Tm-based (G_{c}=2.9±0.32 J/m²) and BA-based (G_{c}=1.99±0.90 J/m²) 2D MHPs. Compared to (BA)₂PbI₄, the better cohesion of 2D (4Tm)₂PbI₄ and (Br4Tm)₂PbI₄ can be attributed to their large cations, likely allowing improved film morphology, plasticity, and capability to deform.^{[29]} Without wishing to be bound by theory, the reduced G_{c} of (Br4Tm)₂PbI₄ can originate from the smaller grain size and more grain boundaries induced by using Br4TmI as organic cations, which can weaken the layer interactions and initiate more defects to initiate fracture when subjected to tensile stress.^{[28,30]} We analyzed scanning electron microscope (SEM) images, as shown in FIG. 52A-52D. (BA)₂PbI₄ exhibits a rough, radiative needle-like surface structure, well aligned with its weakest fracture energy. (Br4Tm)₂PbI₄ reveals very small grain size, which makes it difficult to discern grain boundaries from SEM images alone. The presence of round-shape aggregates can be assigned to extra Br4TmI ligands, indicating a slightly lower propensity to form 2D MHPs. The extra Br4TmI can introduce defects and elevate the initial mobile ion concentration, as will be shown in the next section. Conversely, for (4Tm)₂PbI₄, SEM images reveal a relatively large grain size, approximately around 7 μm, which explained its ability to achieve the highest G_{c}. Overall, the same trend was observed in G_{c} as in the triple-stress environmental stability for the materials, where the 4TmI is the most robust followed by the Br4TmI and the BAI.

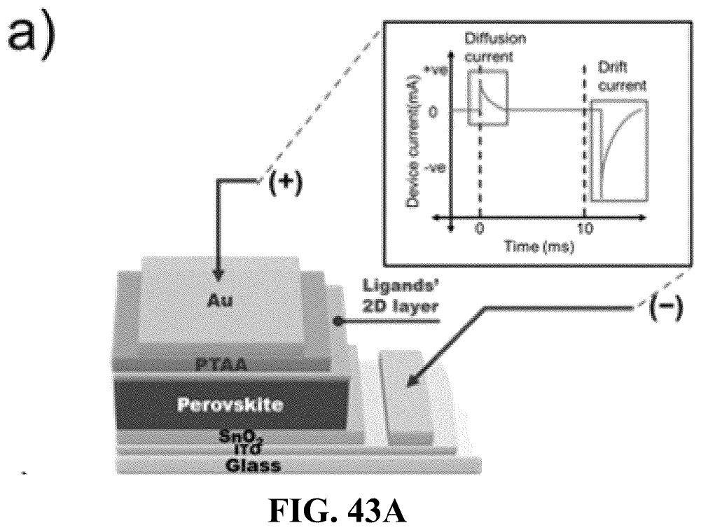

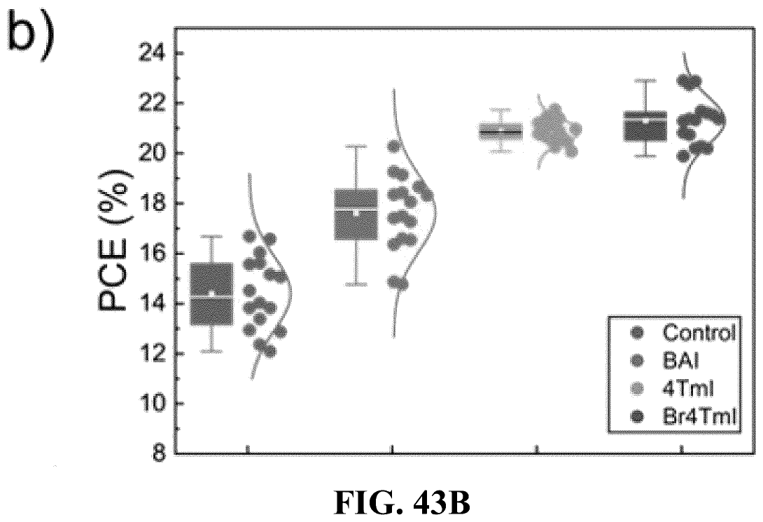

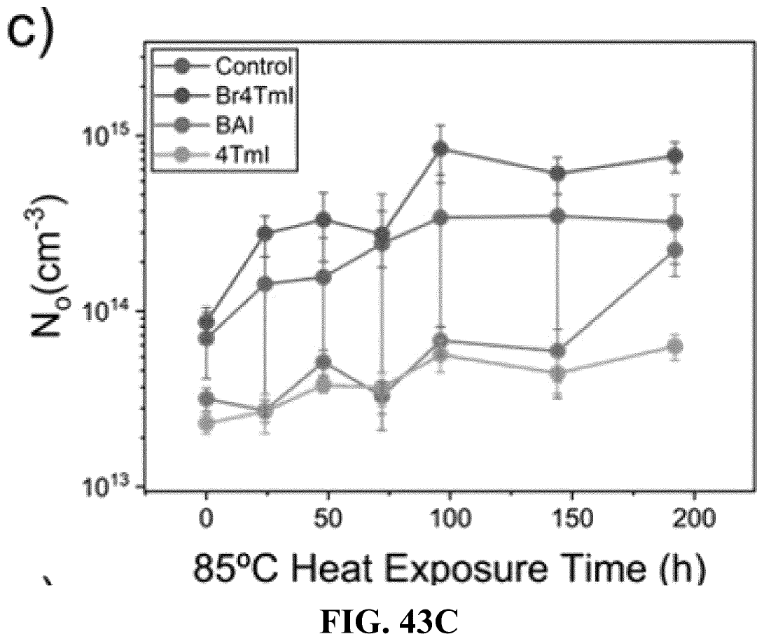

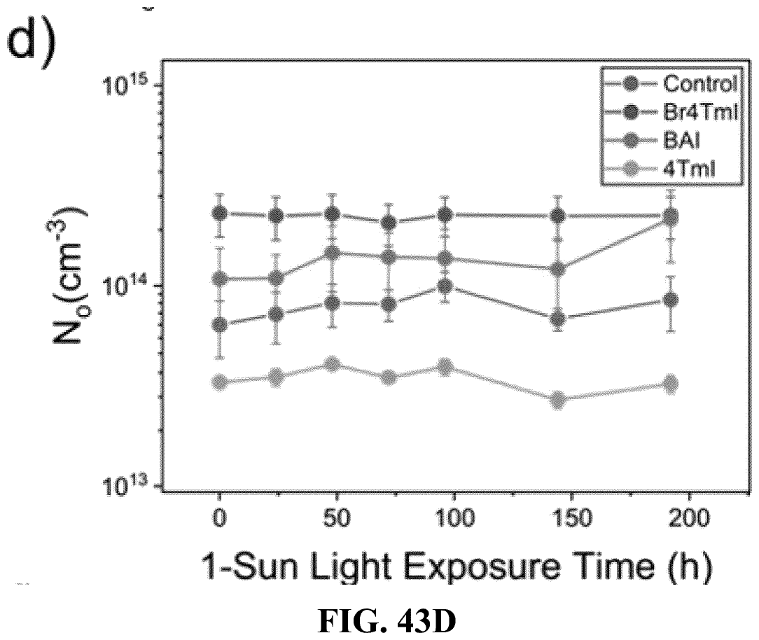

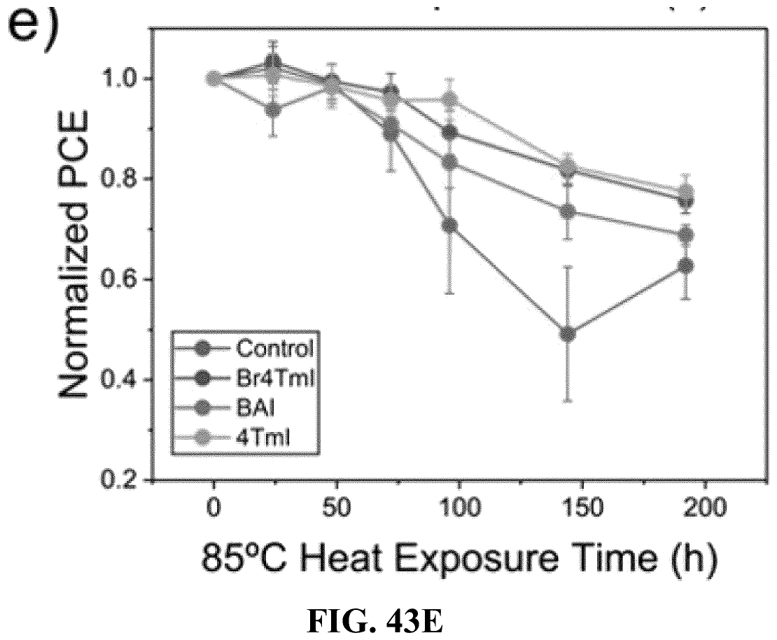

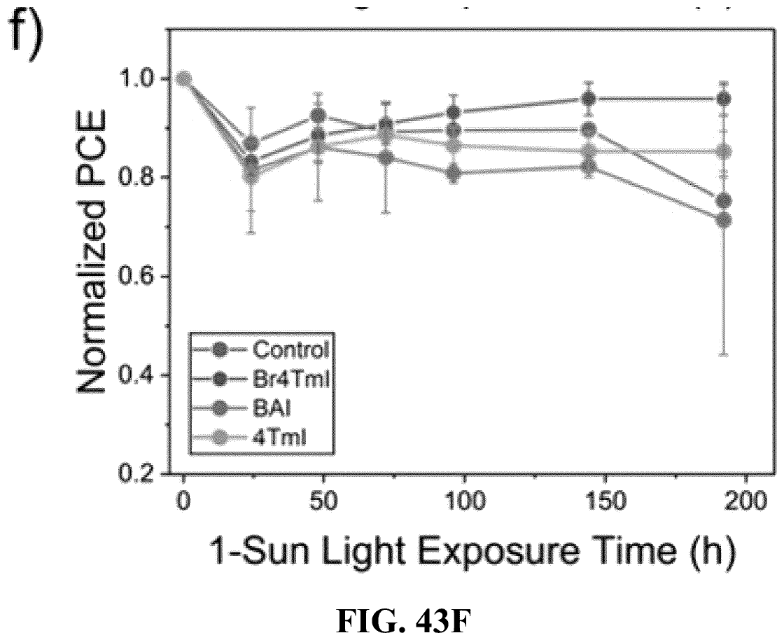

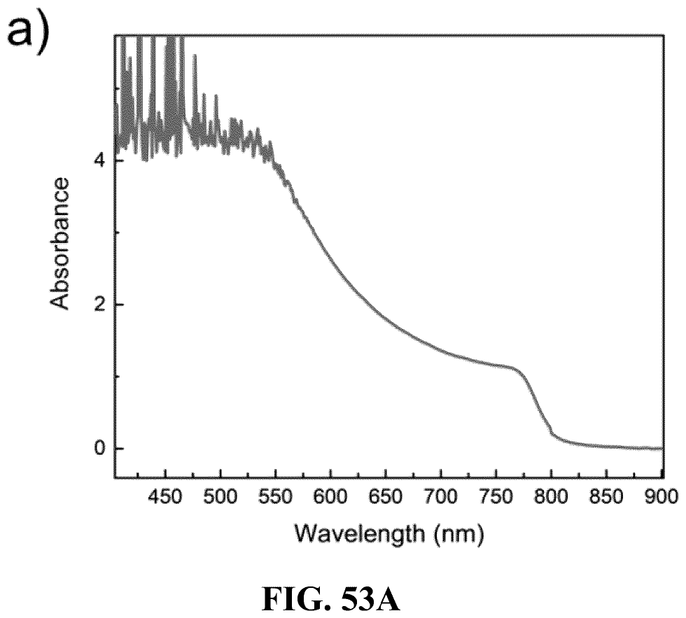

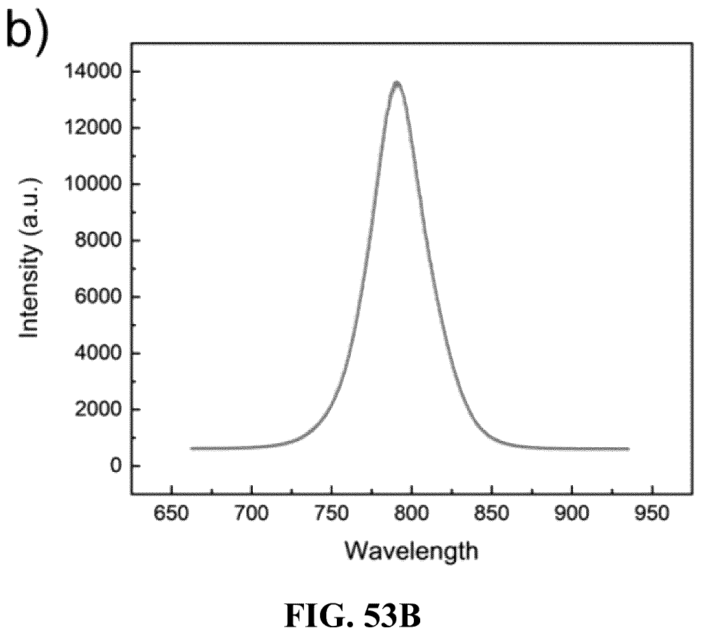

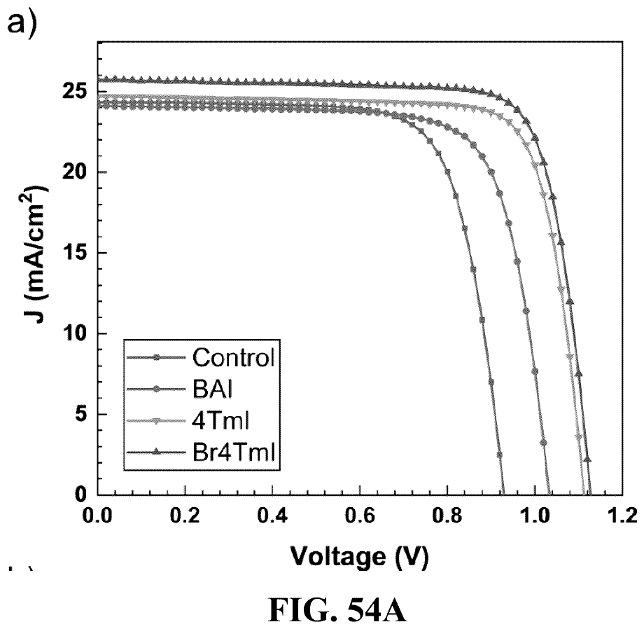

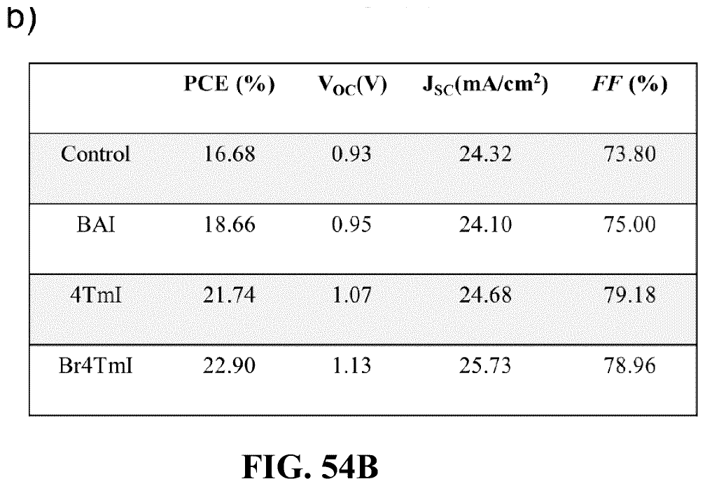

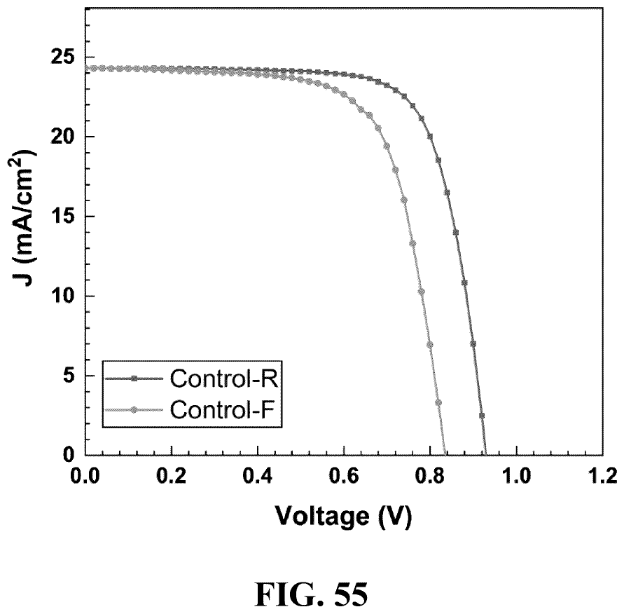

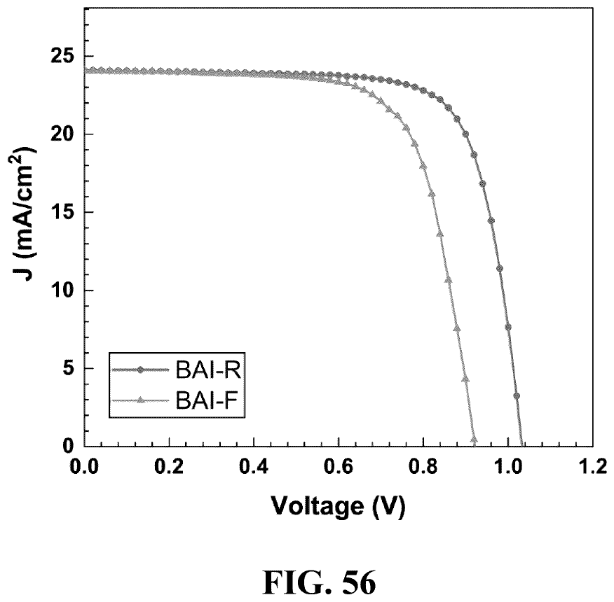

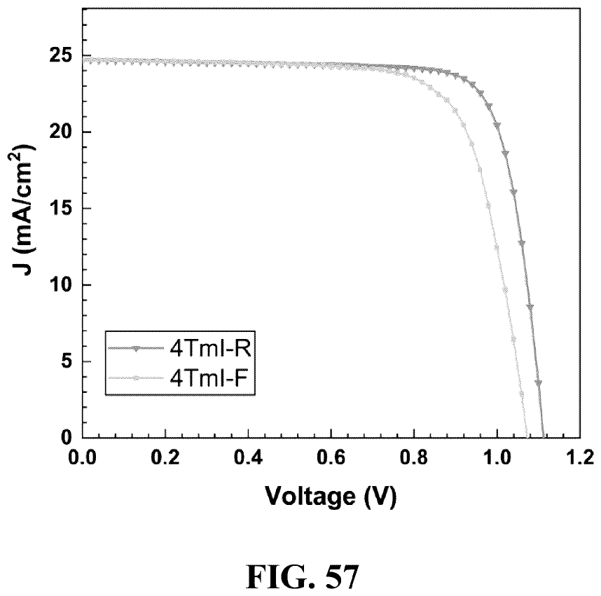

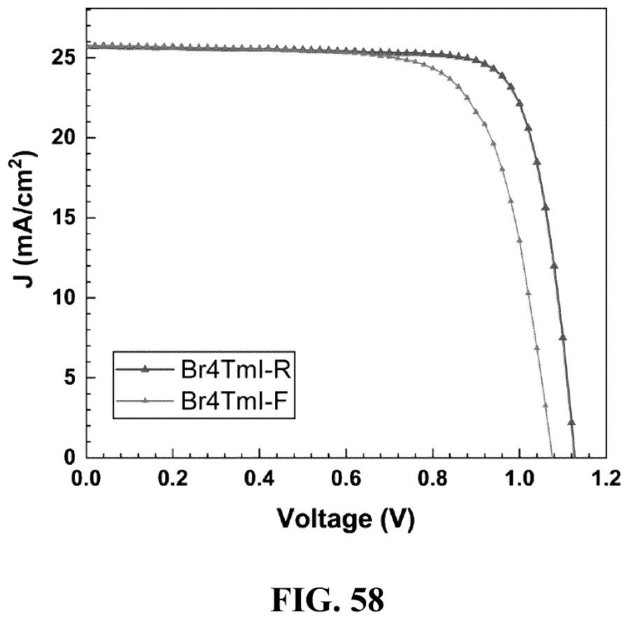

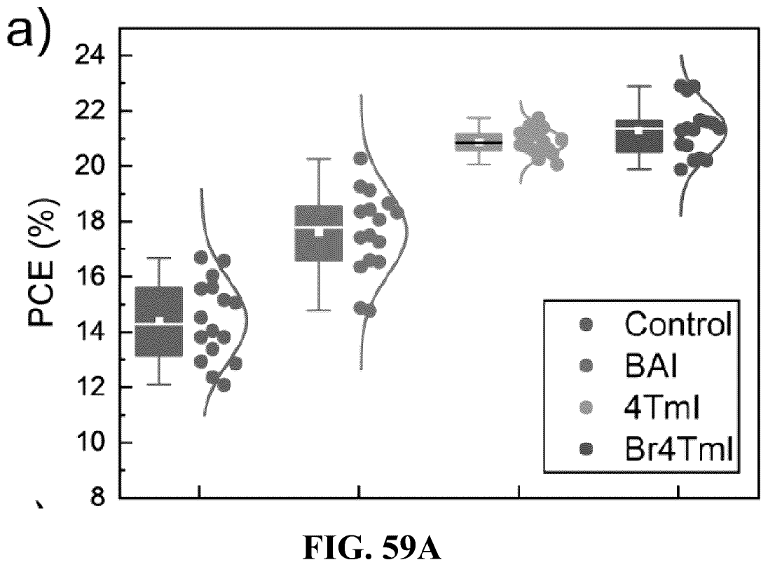

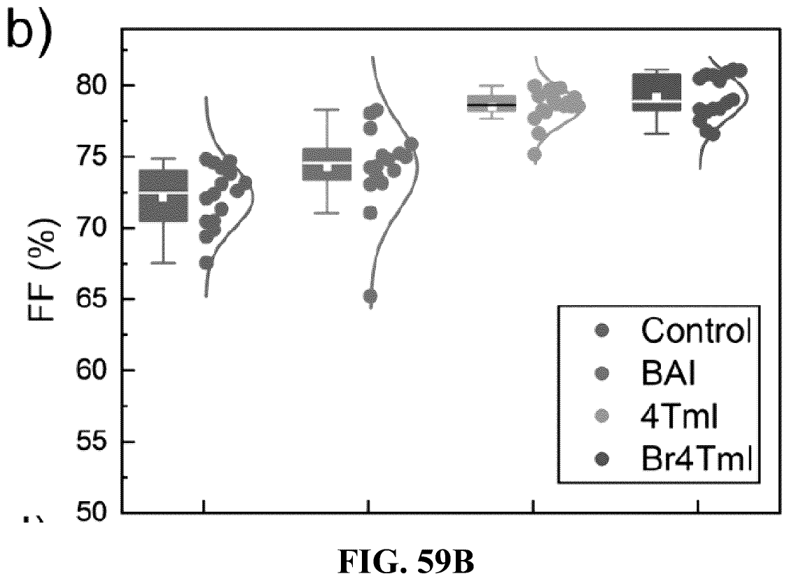

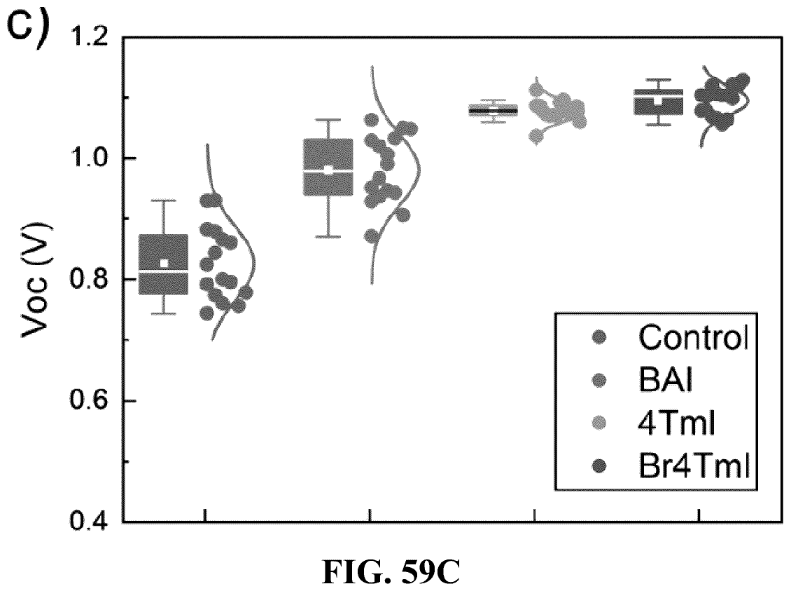

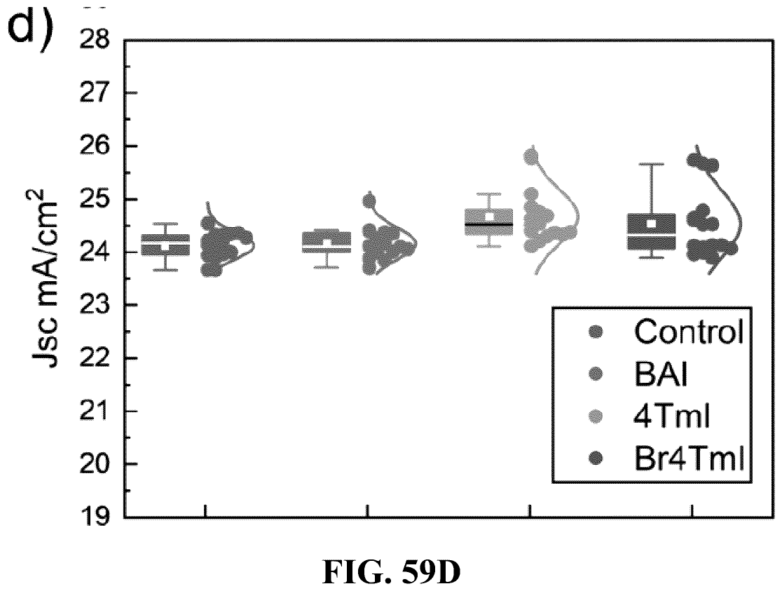

After investigating the stability performance of 2D MHP materials, n-i-p PSCs with 2D/3D heterostructures were fabricated to further probe the ionic properties, as well as tracking the evolution of ionic characteristics with accelerated heat (85° C.) and light (continuous 1 sun) exposure. A standard device structure, glass/ITO/SnO₂/MHP/2D layer/PTAA/Au, is shown in FIG. 43A. The absorption and photoluminescence spectra of FA0.9MA0.05Cs0.05PbI3 MHP absorber layer fabricated via two-step method are included in FIG. 53A-53B. The devices that do not have any 2D MHP interlayer are considered as controls. Compared with control devices with an average power conversion efficiency (PCE) of 14%, the addition of a 2D interlayer clearly enhanced the PCE of solar cells (FIG. 43B), mainly due to the enhanced fill factor and open circuit voltage (FIG. 54A-59D). Thiophene-based solar cell devices, 4TmI and Br4TmI, reveal an improved device PCE of over 21% compared to the 18% PCE of BAI-based solar cells. Especially, the highest efficiency for 4TmI and Br4TmI reached 21.74% and 22.90%, respectively. This is primary due to better energy alignment and enhanced charge transfer from the molecular engineered HOMO energy level from the conjugation.^{[23]}

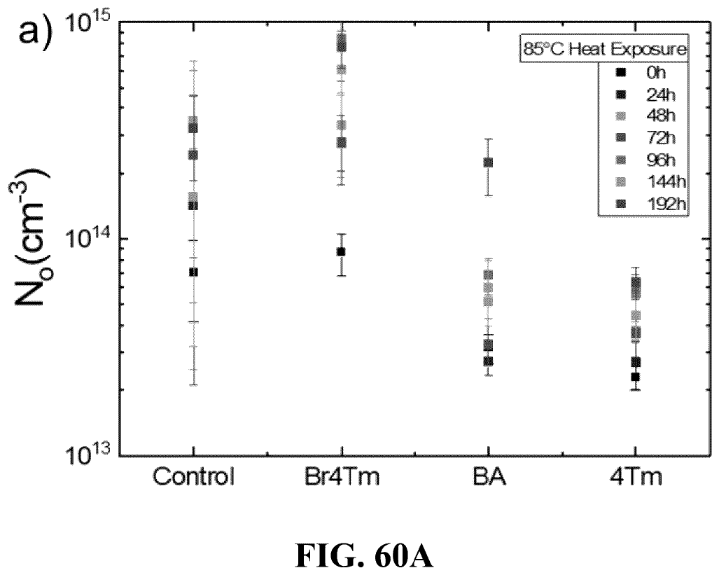

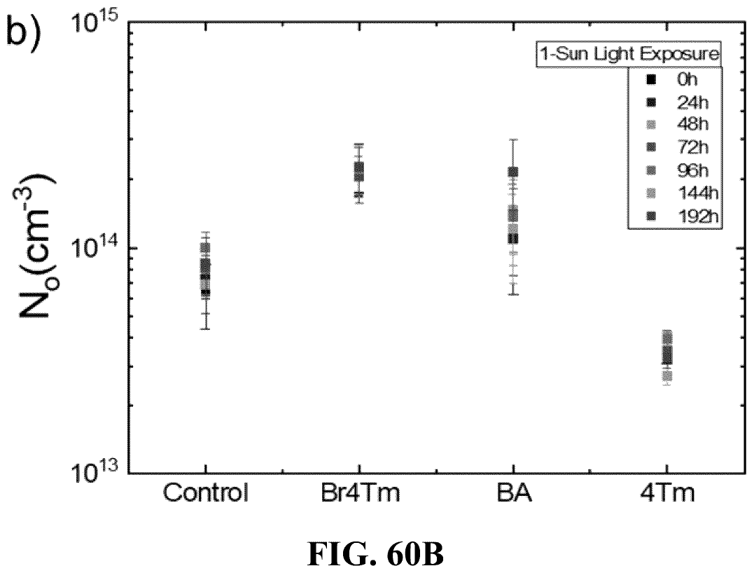

The PSCs without a 2D interlayer (control) and with a 2D interlayer (Br4TmI, BAI, 4TmI) were aged by subjecting them to 1-sun light intensity and 85° C. separately (both in N2 environments), and mobile ion concentration (Nₒ) measurements were performed on the PSCs periodically along with PCE measurements to observe the variation of Nₒ and PCE in the PSCs with aging. The characterization of Nₒ follows the procedure described in our previous work.^{[24,25]} In brief, as illustrated in FIG. 43A, after a constant bias is applied to the devices in the dark for 10 ms, a transient current response comprising first a diffusion response and subsequently a drift (ionic) current occurred at 0 V during the equilibration process. Drift current, representing the response of the ions in the form of current, was integrated over a millisecond scale to yield Nₒ, under the assumption and observation that electronic current was swept away from the initial bias. FIG. 43C depicts the evolution of Nₒ in PSCs with exposure to 85° C. for 192 h. The set of PSCs used for heat aging showed a progressively increasing Nₒ in the order of 4TmI, BAI, control, and Br4TmI before exposure. The higher initial Nₒ of Br4TmI-based PSCs could originate from the I— provided by extra Br4TmI present on the surface, as discussed previously in the SEM images. Control PSCs and PSCs with the Br4TmI interlayer showed a continuous increase of Nₒ throughout the aging period, while PSC with the BAI interlayer showed significant variation throughout the aging period, ultimately leading to an increase in Nₒ at 192 h, and PSCs with the 4TmI interlayer showed the smallest increase in Nₒ. The exposure to heat was highly influential on Nₒ evident from the increase in magnitude of Nₒ for all PSCs (also plotted in FIG. 60A). This is also validated in the film-level aging performed in FIGS. 41C-41H. FIG. 43D depicts the evolution of Nₒ in PSCs with exposure to light for 192 h. The set of PSCs used for light aging showed a progressively increasing Nₒ in the order of 4TmI, control, BAI, and Br4TmI before exposure. Minimal changes were observed in Nₒ for all PSCs throughout the 192 h, except for a small increase in Nₒ for PSCs with BAI 2D interlayer. Overall, the light exposure was not highly influential on Nₒ of PSCs over the period aging was performed (also plotted in FIG. 60B). FIG. 43E depicts the evolution of the normalized PCE of PSCs with exposure to 85° C. for 192 h. All the PSCs showed a reduction in PCE throughout the exposure period of 192 h with the PSCs with 4TmI interlayer showing the least reduction with a 23% drop in PCE and the control PSCs showing the largest reduction with a 37% drop in PCE. Hence, we conclude that PSC with 4TmI interlayer is the most stable among the PSCs when exposed to heat with the least variation in Nₒ and PCE. FIG. 43F depicts the evolution of the normalized PCE of PSCs with exposure to light for 192 h. All the PSCs showed an initial drop in PCE after 24 h with a less significant reduction in PCE over an exposure period of 192 h. The PSCs with Br4TmI interlayer showed the least reduction with a 4% drop in PCE followed by the PSCs with 4TmI interlayer with a 15% drop in PCE, and the PSCs with BAI interlayer showed the most reduction with a 29% drop in PCE. We conclude that PSCs with OSiP interlayers, i.e., Br4TmI- and 4TmI-2D interlayers, are the most stable among the PSCs when exposed to light with the least variation in Nₒ and PCE. Also, we proposed that BAI-2D interlayers, with smaller size and “soft” aliphatic chains, could easily penetrate into the lattice of MHP absorbers and have interface reconstruction, which could potentially lead to a fast decay of PCE. Since Nₒ measurement reflects changes to the MHP absorber layer itself, some of the less direct correlation between Nₒ and stability indicates the degradation mechanism could be driven by electrode and/or charge transport layer changes. It is also important to note that the changes in Nₒ of the PSCs are one of the many factors that influence the performance of the PSCs.

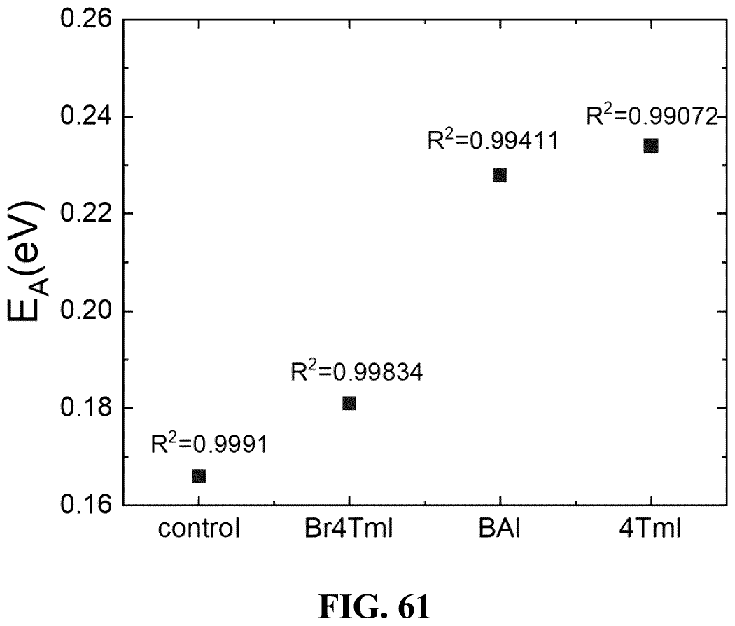

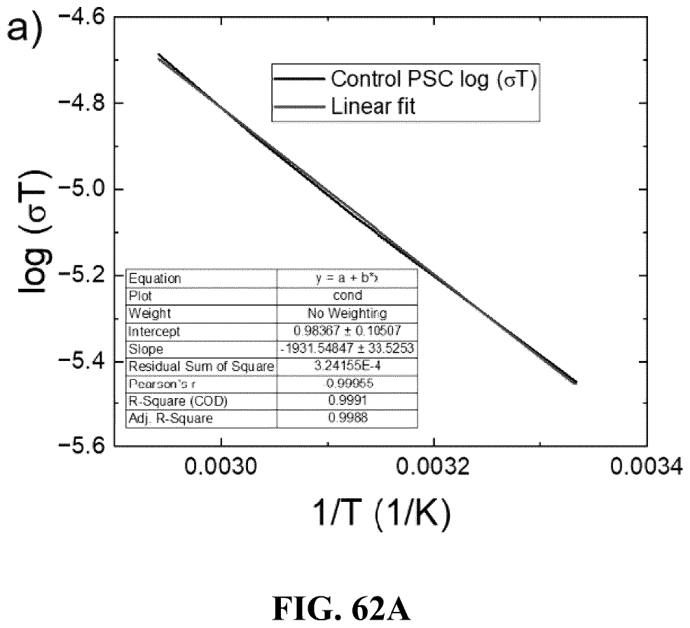

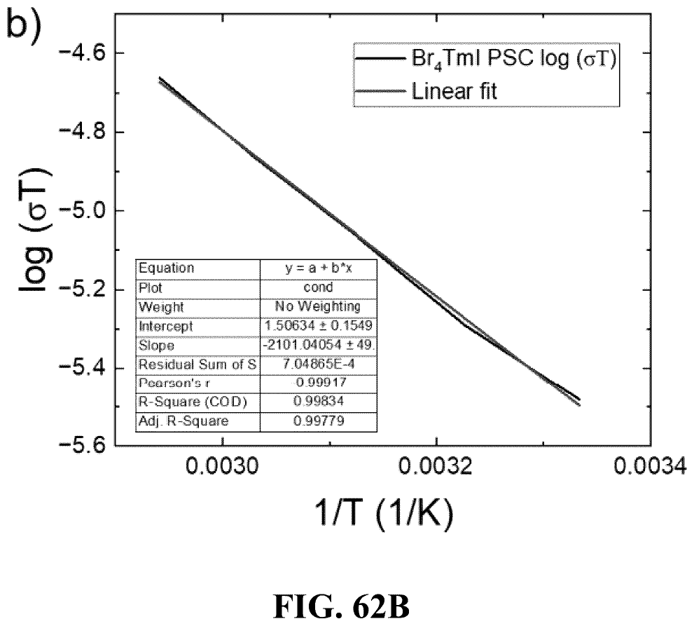

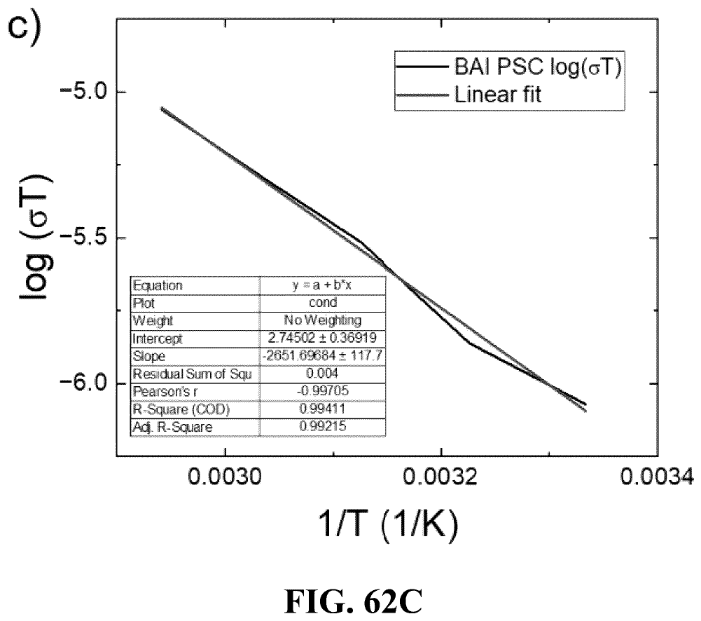

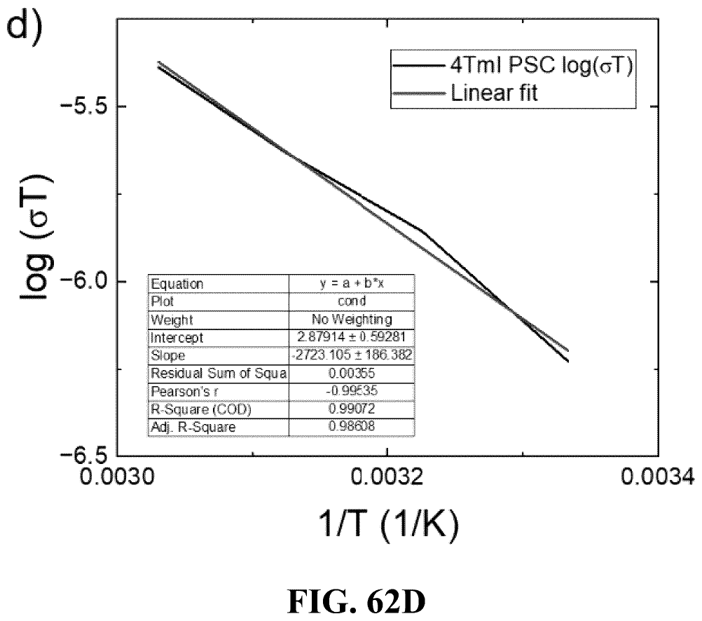

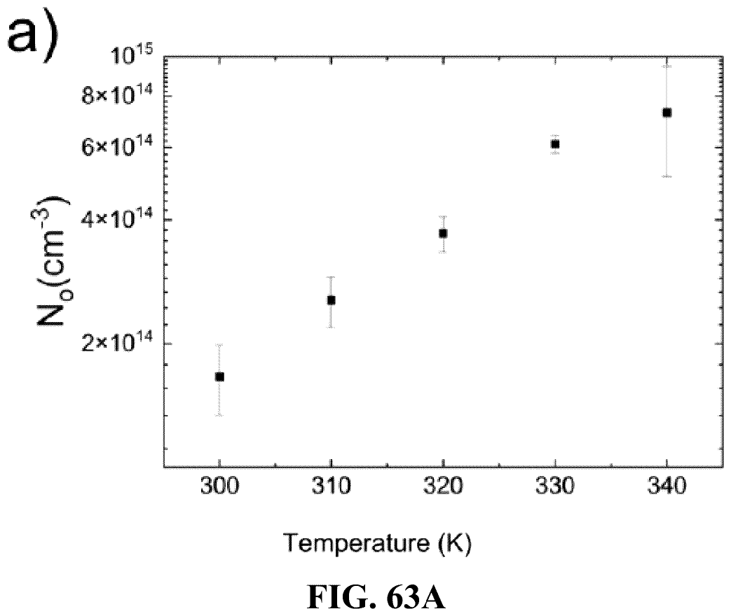

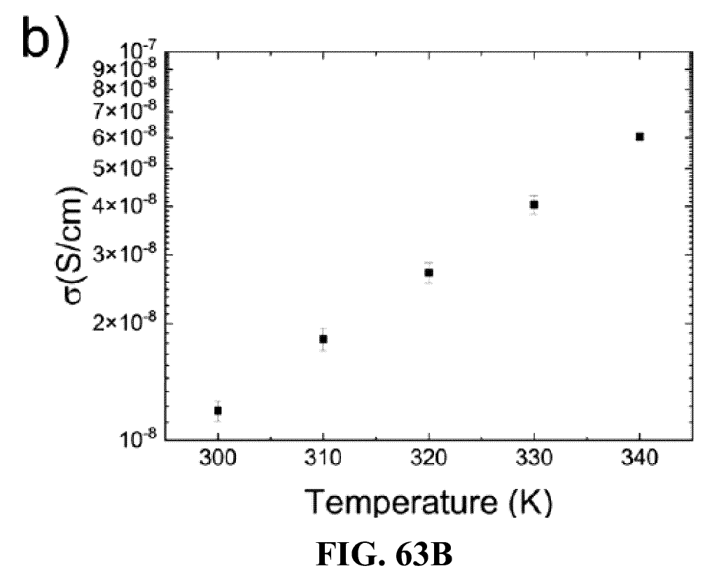

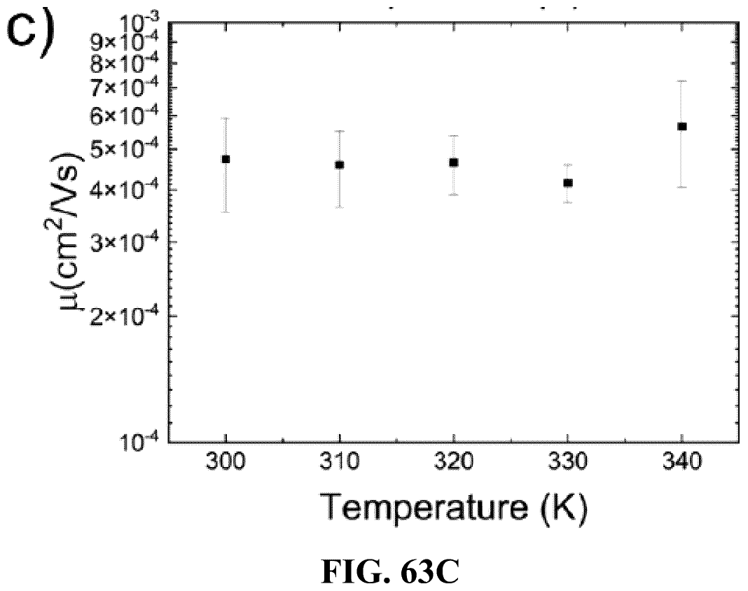

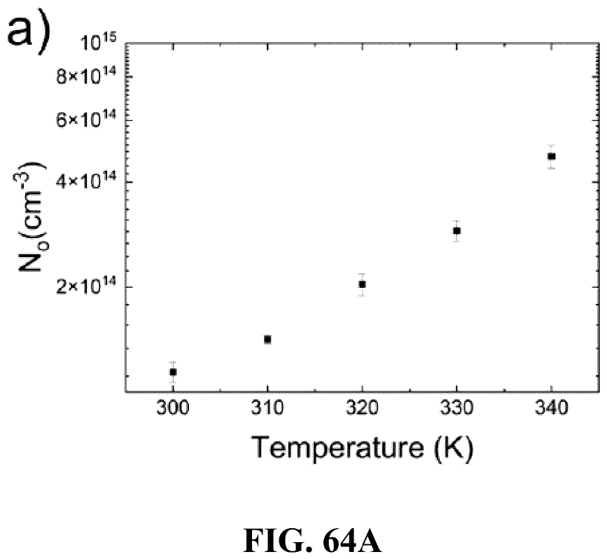

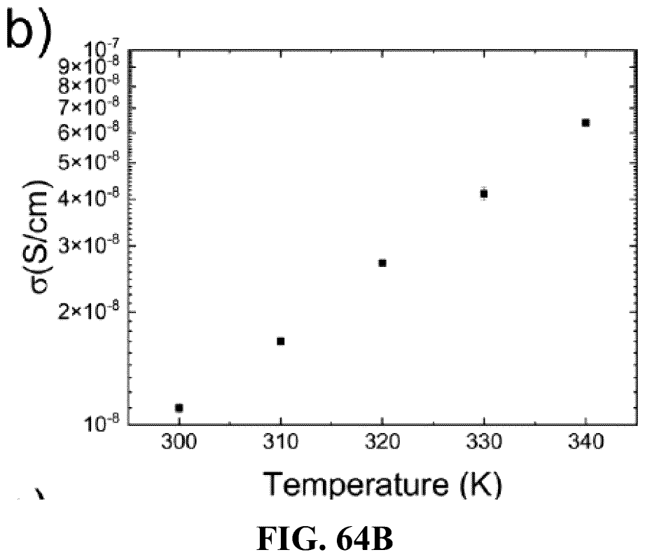

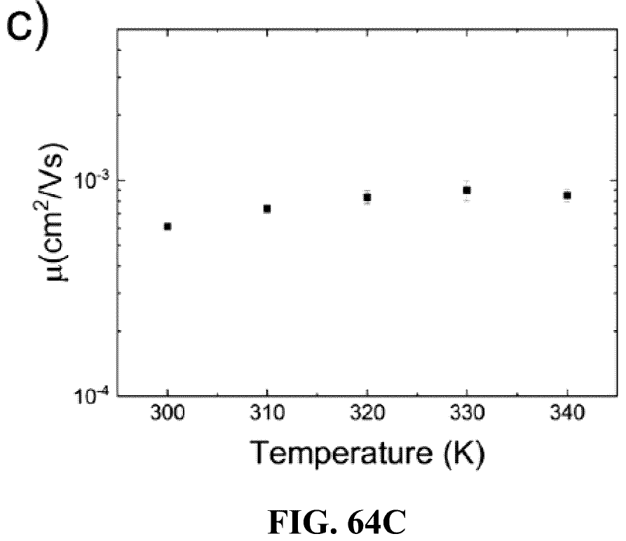

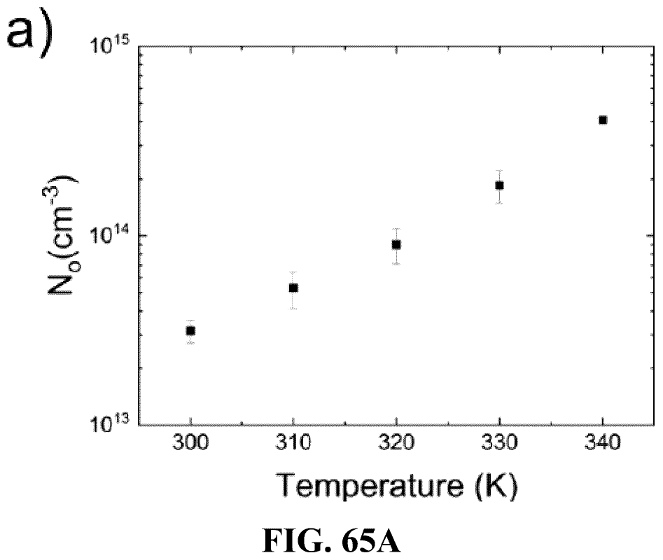

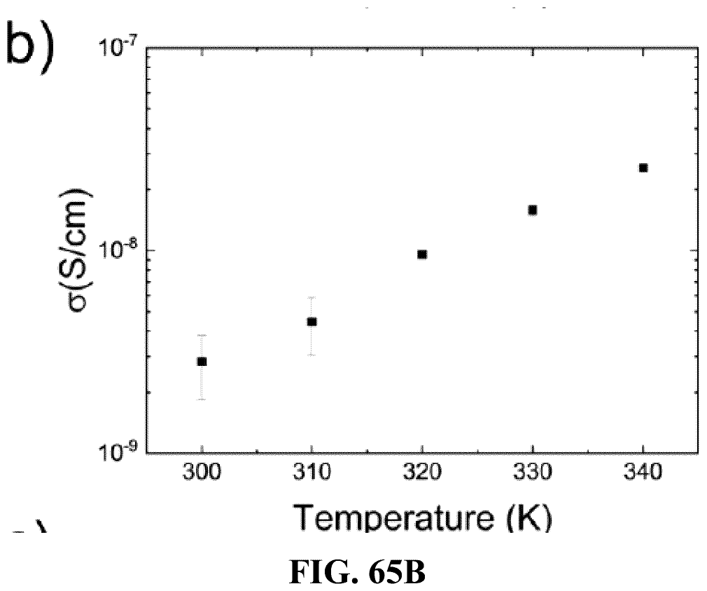

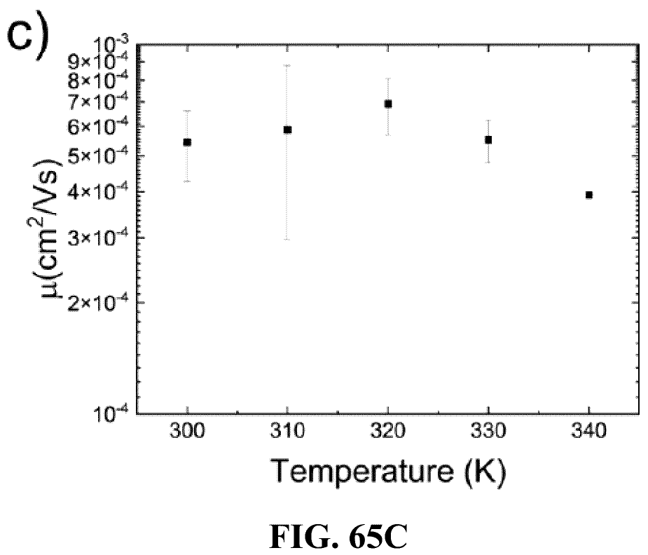

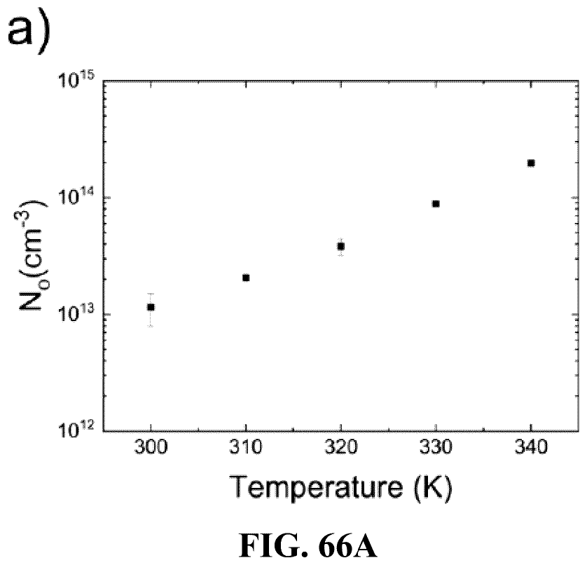

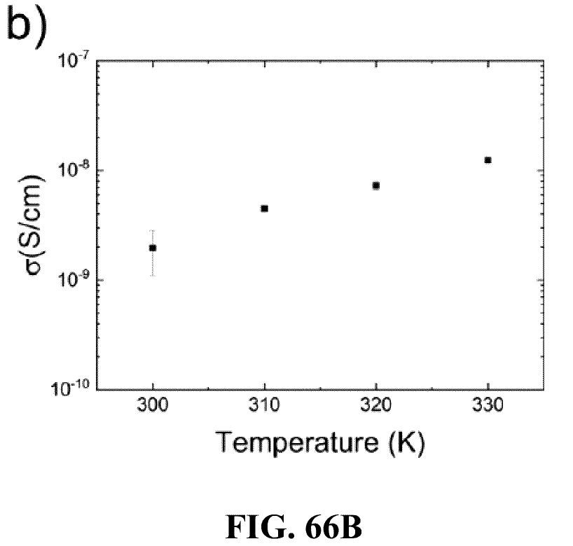

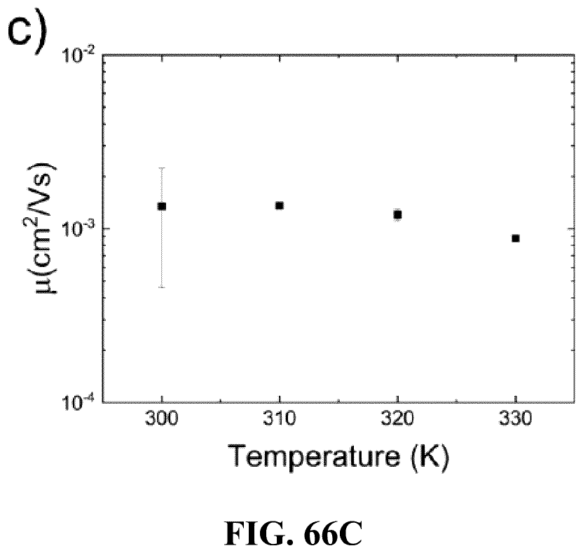

The activation energy (EA) of PSCs was determined using in-situ ionic conductivity (a) versus temperature measurements following a method we described previously.^{[24]} σ of the PSCs is determined by performing electrochemical impedance spectroscopy (EIS) and extracting ionic resistance from the obtained Nyquist plot by equivalent circuit fitting. EA was then determined using an Arrhenius plot between log(σ) and inverse of temperature (1/T) based on the equation (1), where σ-ionic conductivity, T-temperature in kelvin, K-Boltzmann constant, EA-activation energy. As shown in FIG. 61, the EA of the control PSC was 0.166 eV, the EA of the PSC with a Br4TmI 2D interlayer was 0.181 eV, the EA of the PSC with a BAI 2D interlayer was 0.228 eV, and the EA of the PSC with a 4TmI 2D interlayer was 0.234 eV (with fits for EA calculations and in-situ ionic measurements versus temperature are shown in FIGS. 62A-66C). It is evident from these values that the introduction of a ligand interlayer in the device structure is improving the formation energy of additional mobile ions when compared to the other PSC architectures. An increase in EA implies that ion formation is suppressed under heating.

$$log ( σ T ) = \frac{- {E}_{A}}{K} * ( 1 / T ) \qquad ( 1 )$$

Considering the activation energy comparisons along with the triple stress test, mobile ion evolution, and device stability under light and heat, we conclude that 4TmI is the most effective ligand at inhibiting mobile ion formation and MHP degradation.

### Non-Limiting Conclusions

As summarized in Table 8, it was found that 4TmI-2D perovskite has the highest stability under extreme conditions that combines light, heat, air, and moisture. Meanwhile, (4Tm)₂PbI₄2D perovskite has the highest G_{c} among all the 2D perovskite materials, much higher than (BA)₂PbI₄ and (Br4Tm)₂PbI₄, indicating improved bonding and/or plastic deformation in the 4TmI. Besides, devices with (4Tm)₂PbI₄2D/3D heterostructures have the lowest mobile ion concentration with the highest activation energy of mobile ions. These results highlight that 2D perovskite materials, despite having similar lattice structures, can have large differences in environmental and mechanical stability. The presence of thiophene-based large, conjugated cations in 2D perovskite can substantially enhance both the environmental and mechanical stability, as well as help decrease mobile ion concentration and alleviate ionic migration in the as-fabricated solar cells. Some embodiments described herein are structure-property relationships, ranging from the stability of 2D perovskite, interlayer mechanical robustness, and the resulting ionic properties in solar cells. Without wishing to be bound by theory, this can be used in the design of MHPs for thermomechanical reliability in addition to performance through control of the structure of 2D perovskite materials for 2D/3D heterostructures. There do remain challenges towards advancing the promise of stable perovskite solar cells with commercially viable lifetimes, a large part of which relies on the lack of validated reliability metrics that are specific to perovskites. Without wishing to be bound by theory, the quantification of mobile ions and mechanical adhesion as described herein can be used as indicators of durable device design.

### Experimental Section

Ionic measurements: All the ionic measurements were performed using PAIOS, an all-in-one measurement equipment for photovoltaic devices and LEDs. Variation in temperature for determining EA was provided by a temperature control stage and module (T96) from Linkam in integration with PAIOS. Nₒ was measured using the transient current method.^{[24,25]} The ionic charge (Qᵢₒₙ) of the PSCs was measured by letting them equilibrate at 0.8 V for 10 ms in the dark and then the applied bias (Vₐₚₚ) was removed, and the resulting dark transient current was recorded. The drift (ionic) current was considered from the recorded transient current and is integrated over time to obtain Qᵢₒₙ of the PSCs. After Qᵢₒₙ is obtained, then Nₒ is calculated based on the equation (2), where q-electronic charge, εₒ—permittivity of free space, εᵣ—permittivity of material, V_{T}—thermal voltage, V_{bi}—built-in-potential, and Vₐₚₚ—applied bias (0.8V).

$${Q}_{i o n} = \frac{\sqrt{q {N}_{o} {ε}_{o} {ε}_{r} {V}_{T}}}{8} * [ \sqrt{1 + 16 * ( \frac{{V}_{b i}}{{V}_{T}} ) - \sqrt{1 + 16 * \frac{{V}_{b i} - {V}_{a p p}}{{V}_{T}}}} ] \qquad ( 2 )$$

EA was determined by measuring ionic conductivity (σ) over a temperature range and measuring the slope of the Arrhenius plot of log (σ) vs inverse of temperature. σ of the PSCs was determined by performing electrochemical impedance spectroscopy (EIS) on the PSCs and extracting the ionic resistance from the obtained Nyquist plot by equivalent circuit fitting and using the equation (3), where σ—ionic conductivity, t—thickness of perovskite, Ri—ionic resistance, and A—area of the electrode.

$$σ = \frac{t}{{R}_{i} * A} . \qquad ( 3 )$$

EA of the PSCs was then determined by performing EIS over a temperature range of 300K to 340K using the temperature control module. Measured σ was plotted in log form vs inverse of temperature and a linear fit was performed on the plot to extract the slope of the plot, which was used to calculate EA based on the equation (1). An LED solar simulator (Newport) was used for aging the PSCs at 1.0 sun AM 1.5G in N2 and a hot plate was used to age PSC at 85° C. in an N₂ glovebox for 192 h with ex-situ measurements of Nₒ using PAIOS. The light was incident on the PSCs through the glass substrate to simulate operational conditions.

2D MHP films preparation: Organic ligands (0.2 M, 10.6 mg for 4TmI) and PbI₂ (0.1 M, 4.6 mg) were dissolved 100 μl DMF/DMSO 4/1 mixed solvents. The mixture is fully dissolved after heating at 70° C. for 2 hours. 1.25×1 cm glass substrates were treated with UVO for 15 minutes before spin coating. Then, 8 μl of the mixed solution was applied onto a glass substrate. Spin-coating was performed at a speed of 2000 rpm for 30 seconds, followed by thermal annealing at 150° C. for 10 minutes (For BAI, thermal annealing is performed at 100° C.). For fracture energy measurement, the glass substrate used was 3 cm×3 cm. Before coating the 2D MHP, a SnO₂ layer was coated. For SnO₂ layer coating, SnO₂ solution was diluted 7 times by mixing 350 μl SnO₂ aqueous solution (15% in H₂O), 1050 μl of D.I. H₂O, and 1050 μl of isopropanol. Then, 100 μl of the diluted SnO₂ solution was applied onto the large glass substrate, spin-coated at a speed of 3000 rpm, followed by thermal annealing at 150° C. for 30 minutes. After SnO₂ coating, the organic ligand and PbI2 mixture was spin-coated on top, following the same spin-coating method as the small substrates. To ensure full coverage, 100 μl of the ligand-PbI2 mixed solution was used.

Fracture energy test: G_{c} was measured with a standard fracture specimen configuration called double cantilever beam (DCB). The DCB samples adopted the following structure: glass/SnO₂/2D MHP/polymethyl methacrylate (PMMA)/epoxy/glass. The dimension of the glass substrate is 30 mm length×15 mm width×1 mm thickness. PMMA (MW: ˜350,000 g/mol) was dissolved in chlorobenzene (CB) and vortexed to form PMMA solution (10 wt % in CB). The PMMA layer was deposited to protect 2D MHP layer from epoxy by spin-coating the PMMA solution at 3000 rpm for 60 s. Then the as-prepared samples were left to cure in a N₂-filled drybox for 6 h. To create a DCB sample, a layer of thin epoxy (Epo-Tek 301) was applied to a cover glass superstrate with the identical dimensions as the substrate glass for the device/stack and then bonded to the device/stack to create a sandwich-like structure with the device layers bonded between glass at room temperature. After 24 h for curing the epoxy in the same drybox, the edges of DCB samples were cleaned to remove the excessive epoxy. Before the fracture energy test was conducted, a pre-crack was introduced to the DCB samples along the width in order to initiate the crack by inserting the tip of a razor blade in between the two glass substrates of DCB samples. Stainless steel tabs were glued to both sides of the DCB samples for mounting them to a delamination testing system (DTS, USA). In the measurement, the cracked DCB samples were loaded in tension at a constant displacement rate (1 μm/s). When a unit of well-defined mode I fracture occurred cohesively in the 2D MHP layer, the DCB samples were unloaded and loaded again until a complete separation of the two glass substrates that formed the sandwich-structured DCB samples was observed. The load (PP)—displacement (Δ) curves were continuously recorded and used to extract the fracture energy (G_{c}), which was then calculated and averaged to obtain multiple data points per sample in the following equation (4):

$${G}_{c} = \frac{12 {P}_{c}^{2} {a}^{2}}{{B}^{2} {E}^{′} {h}^{3}} {( 1 + 0.64 \frac{h}{α} )}^{2} . \qquad ( 4 )$$

where P_{c} is the critical load that deviates from the linear part in the load-displacement plot during the loading cycle; a is the crack length; B and h are the widths and half height of the sample, respectively; and E′ (69 GPa) is the plane-strain elastic modulus of the glass substrate and superstrate. One non-limiting, exemplary benefit of this method is that no elastic properties (or thicknesses) of the thin films are needed, which greatly simplifies the analysis. Additionally, the process is identical regardless of the number/thickness of the films assuming they remain much thinner than the substrate thickness of 1 mm, which is always the case for PSCs.

The crack length was estimated by a compliance method:

$$α = {( \frac{d Δ}{d P} \cdot \frac{{BE}^{′} {h}^{3}}{8} )}^{\frac{1}{3}} 6.0 \; 64 h . \qquad ( 5 )$$

The G_{c} tests were performed under laboratory air environment.

Film characterization: UV-vis spectroscopy was performed on Agilent Cary-5000 spectrometer. X-ray diffraction (XRD) measurements were conducted on a Rigaku Smart Lab using Cu Kα source. The SEM sample substrate is glass fully covered with ITO, then coated with SnO₂ (using the same method as previously discussed) before applying the 2D MHP coating. The SEM images were captured using a Hitachi S-4800 SEM operating at a 10.0 kV acceleration voltage with a secondary electron detector.

2D/3D heterostructure PSCs fabrication: The glass/ITO substrates were cleaned by 15-20 minutes of sonication in soap water, D.I. water, acetone, isopropanol, acetone (2^{nd} time), isopropanol (2^{nd} time) sequentially. Before use, the clean substrates were treated by UVO reactor for 30 minutes. SnO₂ was coated on top of ITO substrate as the first layer. For SnO₂ layer coating, SnO₂ solution was diluted 7 times by mixing 350 μl SnO₂ aqueous solution (Alfa Aesar, 15% in H₂O), 1050 μl of D.I. H₂O, and 1050 μl of isopropanol. Then, 30 μl of the diluted SnO₂ solution was applied, spin-coated at a speed of 3000 rpm, followed by thermal annealing at 150° C. for 30 minutes. After cooling and 10 minutes of UVO treatment, a 10 mM KOH solution was applied on top of the SnO₂ layer via spin coating (3k rpm, 30 s) and annealed for 30 minutes for passivation. For 2-step perovskite coating with a composition of FA_{0.9}MA_{0.05}Cs_{0.05}PbI₃, a PbI₂ solution was prepared by dissolving 691.5 mg PbI₂ (1.5M) and 19.5 mg CsI (0.075 M, 5%) in 1 ml DMSO/DMF with 1 to 9 volume ratio at 70° C. Cation solution was prepared by dissolving 180 mg FAI (0.52 M), 21.6 mg MACI (0.16 M) and 10 mg MAI (0.03 M) in 2 ml IPA at room temperature. Following 10 minutes of UVO treatment on KOH passivated SnO₂ surface, 35 μl PbI₂ solution was first spin-coated onto substrate and annealed at 70° C. for 1 minute (static spin). Then, 100 μl of the cation solution was dispensed onto the PbI₂-coated substrates with static spin at 1800 rpm for 30 s. The perovskite films were transferred out of the glove box and annealed at 150° C. in ambient air for 17 minutes, the environmental humidity is between 40%-60%. For ligand passivation, all ligand solutions were prepared at a concentration of 0.5 mg/ml, dissolved in a mixed solvent of IPA/CB with a ratio of 1:9. The ligand is dynamically spin-coated at 4000 rpm for 30 seconds and then annealed at 100° C. for 2 minutes. A PTAA solution was prepared by making 40 mg/ml solution in chlorobenzene, doped overnight with 11.1 wt. % of 4-isopropyl-4′-methyldiphenyliodonium tetrakis(pentafluorophenyl)borate (TPFB) in chlorobenzene at 45° C. TPFB for doping was prepared at room temperature in a concentration of 100 mg/ml. For spin-coating, 32 μL of the doped PTAA solution was dynamically coated at 3000 rpm for 30 seconds, followed by annealing at 80° C. for 5 minutes. Lastly, 90 nm of gold was thermally evaporated as contact electrodes using a customized shadow mask.

Device characterization: J-V scans were conducted under calibrated 1.0 sun intensity, with AM 1.5G irradiation based on xenon-lamp solar simulator (Enlitech SS-F5-3A) in glove box. The light intensity (100 mW cm-2) was calibrated each time via a standard Si reference cell certified by NREL. The active area of each device was measured using an Olympus microscope. The reverse scan ranged from 1.2 V to −0.1 V, while the forward scan ranged from −0.1 V to 1.2 V, with an average scan rate of approximately 0.17 V/s. The voltage step is 40 mV from −0.1 V to 0.8 V and 10 mV from 0.8 V to 1.2 V.

Statistical analysis: Pre-processing of the data—normalization was performed on the PCE values of the samples after exposure to heat and light in FIGS. 43E and 43F respectively by using the ratio PCE_{normalized}=PCE(t)/PCE(t=0). Data presentation—All the PCE values and G_{c} values in the document are presented as mean±SD, and the Nₒ values are presented as mean±SE. Sample size—G_{c} measurements were performed on 6 samples for each type of 2D MHP films but only the measurements that had valid loading-unloading curves were included to the calculation of G_{c} of the respective 2D MHP film. So G_{c} for 4TmI films has measurements from 4 samples, G_{c} for Br4TmI films has measurements from 4 samples, and G_{c} for BAI films has measurements from 3 samples. Each device has 5 pixels on it, Nₒ measurements were performed on two such devices for the Nₒ vs heat, and Nₒ vs light analysis for all the PSCs. That is 10 pixels were measured each time for their Nₒ and then the mean±SE of these values has been calculated. For EA a single pixel was measured but it was measured twice, once while increasing the heat from 300 K to 340 K and once while reducing the temperature from 340 K to 300 K. PCE measurement statistics are based on 16 devices for each of the PSCs.

### REFERENCES CITED HEREIN

[1] M. Grätzel, Acc. Chem. Res. 2017, 50, 487.
[2] K. Aitola, G. Gava Sonai, M. Markkanen, J. Jaqueline Kaschuk, X. Hou, K. Miettunen, P. D. Lund, Solar Energy 2022, 237, 264.
[3] Y. Rong, Y. Hu, A. Mei, H. Tan, M. I. Saidaminov, S. Il Seok, M. D. McGehee, E. H. Sargent, H. Han, Science 2018, 361, 1214.
[4] R. Wang, M. Mujahid, Y. Duan, Z. K. Wang, J. Xue, Y. Yang, Adv. Funct. Mater. 2019, 29, 1808843.
[5] M. De Bastiani, G. Armaroli, R. Jalmood, L. Ferlauto, X. Li, R. Tao, G. T. Harrison, M. K. Eswaran, R. Azmi, M. Babics, A. S. Subbiah, E. Aydin, T. G. Allen, C. Combe, T. Cramer, D. Baran, U. Schwingenschlögl, G. Lubineau, D. Cavalcoli, S. De Wolf, ACS Energy Lett. 2022, 7, 827.
[6] C. C. Boyd, R. Cheacharoen, T. Leijtens, M. D. McGehee, Chem. Rev. 2018, 5, 3418.
[7] L. Meng, J. You, Y. Yang, Nat. Comm. 2018, 9, 5265.
[8] E. Bi, Z. Song, C. Li, Z. Wu, Y. Yan, Trends Chem. 2021, 3, 575.
[9] H. Zai, Y. Ma, Q. Chen, H. Zhou, Journal of Energy Chemistry 2021, 63, 528.
[10] Y. Zhao, W. Zhou, Z. Han, D. Yu, Q. Zhao, Phys. Chem. Chem. Phys. 2021, 23, 94.
[11] L. Mao, C. C. Stoumpos, M. G. Kanatzidis, J. Am. Chem. Soc. 2019, 141, 1171.
[12] J. Sun, K. Wang, K. Ma, J. Y. Park, Z. Y. Lin, B. M. Savoie, L. Dou, J. Am. Chem. Soc. 2023, 145, 20694.
[13] R. Azmi, E. Ugur, A. Seitkhan, F. Aljamaan, A. S. Subbiah, J. Liu, G. T. Harrison, M. I. Nugraha, M. K. Eswaran, M. Babics, Y. Chen, F. Xu, T. G. Allen, A. Rehman, C. Wang, T. D. Anthopoulos, U. Schwingenschlögl, M. De Bastiani, E. Aydin, S. De Wolf, Science 2022, 5784, 73.
[14] Y. Zhao, F. Ma, Z. Qu, S. Yu, T. Shen, H. X. Deng, X. Chu, X. Peng, Y. Yuan, X. Zhang, J. You, Science 2022, 377, 531.
[15] F. Zhang, S. Y. Park, C. Yao, H. Lu, S. P. Dunfield, C. Xiao, S. Ulitni, X. Zhao, L. Du Hill, X. Chen, X. Wang, L. E. Mundt, K. H. Stone, L. T. Schelhas, G. Teeter, S. Parkin, E. L. Ratcliff, Y. L. Loo, J. J. Berry, M. C. Beard, Y. Yan, B. W. Larson, K. Zhu, Science 2022, 375, 71.
[16] S. Sidhik, Y. Wang, M. De Siena, R. Asadpour, A. J. Torma, T. Terlier, K. Ho, W. Li, A. B. Puthirath, X. Shuai, A. Agrawal, B. Traore, M. Jones, R. Giridharagopal, P. M. Ajayan, J. Strzalka, D. S. Ginger, C. Katan, M. A. Alam, J. Even, M. G. Kanatzidis, A. D. Mohite, Science 2022, 377, 1425.
[17] X. Zhao, T. Liu, Y. L. Loo, Adv. Mater. 2022, 34, 1.
[18] F. Zhang, H. Lu, J. Tong, J. J. Berry, M. C. Beard, K. Zhu, Energy Environ. Sci. 2020, 13, 1154.
[19] M. Li, S. Johnson, L. Gil-Escrig, M. Sohmer, C. A. Figueroa Morales, H. Kim, S. Sidhik, A. Mohite, X. Gong, L. Etgar, H. J. Bolink, A. Palmstrom, M. D. McGehee, N. Rolston, Energy Advances 2023, 3, 273.
[20] Y. Gao, E. Shi, S. Deng, S. B. Shiring, J. M. Snaider, C. Liang, B. Yuan, R. Song, S. M. Janke, A. Liebman-Peliez, P. Yoo, M. Zeller, B. W. Boudouris, P. Liao, C. Zhu, V. Blum, Y. Yu, B. M. Savoie, L. Huang, L. Dou, Nat. Chem. 2019, 11, 1151.
[21] K. Ma, H. R. Atapattu, Q. Zhao, Y. Gao, B. P. Finkenauer, K. Wang, K. Chen, S. M. Park, A. H. Coffey, C. Zhu, L. Huang, K. R. Graham, J. Mei, L. Dou, Advanced Materials 2021, 33, 2100791.
[22] J. Sun, K. Ma, Z. Lin, Y. Tang, D. Varadharajan, A. X. Chen, R. Harindi, Y. H. Lee, K. Chen, B. W. Boudouris, K. R. Graham, D. J. Lipomi, B. M. Savoie, L. Dou, Adv. Mater. 2023, 2300647.
[23] K. Ma, J. Sun, R. H. Atapattu, W. B. Larson, H. Yang, D.; Sun, K. Chen, K. Wang, Y. Lee, Y. Tang, A. Bhoopalam, L. Huang, R. K. Graham, J. Mei, L. Dou, Sci. Adv.
2023, 9, eadg0032.
[24] S. Penukula, R. Estrada Torrejon, N. Rolston, Molecules 2023, 28, 5026.
[25] L. Bertoluzzi, C. C. Boyd, N. Rolston, J. Xu, R. Prasanna, B. C. O'Regan, M. D.
McGehee, Joule 2020, 4, 109.
[26] R. H. Dauskardt, J.-H. Kim, T.-S. Kim, I. Lee, N. Rolston, B. L. Watson, MRS Bull.
2017, 42, 115.
[27] N. Rolston, B. L. Watson, C. D. Bailie, M. D. McGehee, J. P. Bastos, R. Gehlhaar, J.-E. Kim, D. Vak, A. T. Mallajosyula, G. Gupta, A. D. Mohite, R. H. Dauskardt, Extreme Mech. Lett. 2016, 9, 353.
[28] Z. Dai, S. K. Yadavalli, M. Chen, A. Abbaspourtamijani, Y. Qi, N. P. Padture, Science 2021, 372, 618.
[29] N. Rolston, A. D. Printz, J. M. Tracy, H. C. Weerasinghe, D. Vak, L. J. Haur, A. Priyadarshi, N. Mathews, D. J. Slotcavage, M. D. McGehee, R. E. Kalan, K. Zielinski, R. L. Grimm, H. Tsai, W. Nie, A. D. Mohite, S. Gholipour, M. Saliba, M. Grätzel, R. H. Dauskardt, Adv. Energy Mater. 2018, 8, 1702116.
[30] Z. Dai, S. K. Yadavalli, M. Hu, M. Chen, Y. Zhou, N. P. Padture, Scr. Mater. 2020, 185, 47.

### Materials:

Lead(II) iodide (99.99% trace metals basis) with a purity of 98.0% or higher and 4-isopropyl-4′-methyldiphenyliodonium tetrakis(pentafluorophenyl)borate (TPFB) were obtained from TCI America. Tin(IV) oxide (15% colloidal solution) was purchased from Alfa Aesar. Poly(triarylamine) (PTAA) with a molecular weight of 20-40k g/mol was purchased from 1-Material. Gold (Au) with a purity of 99.999% was acquired from Kurt J. Lesker. Potassium hydroxide, cesium iodide (99.999% trace metals basis), anhydrous solvents including chlorobenzene, isopropanol, dimethylformamide, dimethyl sulfoxide were from Sigma Aldrich and used directly without further purification. Formamidinium iodide, methylammonium iodide, methylammonium chloride, and n-butylammonium iodide were purchased from GreatCell Solar and used directly without further purification. 4TmI and Br4TmI were synthesized and purified based on our previous work.^{[1,2]}

TABLE 8
Stability summary for 2D MHPs and 2D/3D heterostructure
PSCs, ranking 1 to 4: best to least.

| | G_{c} | Nₒ | Heat | Light | E_{A} | Triple-stress |
|---|---|---|---|---|---|---|
| Films/devices | (J/m²) | (cm⁻³) | Stability | Stability | (eV) | test stability |
| Control | <1.5 (3) | 7 × 10¹³ (2) | (4) | (3) | 0.154 (4) | (4) |
| Br4TmI | ~2.9 (2) | 2.5 × 10¹⁴ (4) | (2) | (1) | 0.169 (3) | (2) |
| BAI | ~2.0 (2) | 1.5 × 10¹⁴ (3) | (3) | (4) | 0.216 (2) | (3) |
| 4TmI | ~6.3 (1) | 2.5 × 10¹³ (1) | (1) | (2) | 0.222 (1) | (1) |

### REFERENCES

[1] K. Ma, J. Sun, R. H. Atapattu, W. B. Larson, H. Yang, D.; Sun, K. Chen, K. Wang, Y. Lee, Y. Tang, A. Bhoopalam, L. Huang, R. K. Graham, J. Mei, L. Dou, Sci Adv 2023, 9, eadg0032.
[2] Y. Gao, E. Shi, S. Deng, S. B. Shiring, J. M. Snaider, C. Liang, B. Yuan, R. Song, S. M. Janke, A. Liebman-Peliez, P. Yoo, M. Zeller, B. W. Boudouris, P. Liao, C. Zhu, V. Blum, Y. Yu, B. M. Savoie, L. Huang, L. Dou, Nat Chem 2019, 11, 1151.

### Example 6

### Use of Carbon Electrodes to Reduce Mobile Ion Concentration and Improve Reliability of Metal Halide Perovskite Photovoltaics

Ion migration is one of the prime reasons for the rapid degradation of metal halide perovskite solar cells (PSCs), and we report on a method for quantifying mobile ion concentration (Nₒ) using a transient dark current measurement. We perform both ex-situ and in-situ measurements on PSCs and study the evolution of Nₒ in films and devices under a range of temperatures. We also study the effect of device architecture, top electrode chemistry, and metal halide perovskite composition and dimensionality on Nₒ. Two-dimensional perovskites are shown to reduce the ion concentration along with inert C electrodes that do not react with halides by ˜99% while also improving mechanical reliability by ˜250%. This work can provide design guidelines for the development of stable PSCs through the lens of minimizing mobile ions and their evolution over time under operational conditions.

### INTRODUCTION

Currently, commercialized solar panels operate at approximately 21% efficiency with top consumer brands boasting ˜24.9% efficiency^{[1]}. However, the manufacturing process for consumer solar panels is expensive with limited efficiency improvements possible for incumbent technology^{[2]}. To combat this, researchers are investigating alternative solar technologies including different photovoltaic semiconductor materials such as metal halide-based perovskite solar cells (PSCs). PSCs offer promising prospects due to their cost-effectiveness and near-comparable efficiency to traditional silicon-based cells^{[3]} with the current highest efficiency being 26.1%^{[4]}. The main reason for their lack of widespread use in industry is their limited lifespan. PSCs in their current form degrade more quickly to replace silicon-based solar cells at the consumer level but there is ongoing research into the underlying mechanisms that cause this degradation including ion migration^{[5-7]}.

Ion migration is a phenomenon that happens in metal halide perovskites (MHPs) because of the soft crystal lattice of the material leading to the formation of ionic defects (such as vacancies and interstitials) that act as mobile ions in the lattice^{[8,9]}. The primary mechanism for this is through halide vacancies that exhibit low activation energies in the MHP lattice both intrinsically and under the influence of external stimuli such as heat and light. The consequences of ion migration are phase separation and electrochemical reactions with transport layers and electrodes, affecting their extraction properties that induce material degradation and electronic losses^{[7,10-13]}. It has been shown in our previous work that ion migration in PSCs and MHPs can be quantified in terms of a mobile ion concentration (Nₒ)^{[6]}.

Compositional changes to the structure of the perovskite such as two-dimensional (2D) MHPs where the A-site cations of the MHP are replaced by larger organic cations leading to the formation of a layered structure with increased bandgaps are more stable than their three-dimensional (3D) counterparts^{[14-16]}. Part of this effect is due to the reduced volatility and hydrophobicity of the bulky 2D cations that can improve the operational stability of PSCs in terms of chemical, thermal, and environmental stability^{[17,18]}. To enable improved stability without reducing the performance of PSCs, 2D/3D heterostructures are commonly used^{[19]}.

Metal top electrodes in PSCs, particularly silver (Ag), are prone to irreversible corrosion due to ion migration by the reaction of metal with the halide components in the MHP, leading to PSC performance losses^{[20-22]}. It has also been shown that metal ions can diffuse into the MHP and cause irreversible degradation^{[23,24]}. Alternative metal electrodes, such as copper (Cu), gold (Au), and aluminum (Al), are also known to form metal-halide complexes with the MHP and are also prone to oxidation in the presence of oxygen and moisture that degrade PSC performance^{[25,26]}. Carbon (C) electrodes in place of their metal counterparts are shown to be more stable thermally and chemically and are less prone to oxidation and corrosion^{[20,27,28]}. PSCs utilizing C electrodes offer a promising solution due to their potential for extended durability and cost-effectiveness. Various C-based materials have been used, including pure carbon ink, graphite, carbon nanotubes, and graphene^{[29-33]}. C-based materials safeguard the perovskite layer from both moisture and heat-induced degradation, thereby enhancing the long-term stability of these solar cells^{[34,35]}. However, the performance of PSCs utilizing C electrodes typically lags behind that of those employing metal electrodes. This is attributed to the elevated resistivity of C materials and the relatively lower quality of the C/hole-transport layer (HTL) interface compared to the metal/HTL interface. Although C-based materials are generally more economical than noble metals, the large-scale industrial production of high-performance C-based PSCs continues to be a challenge^{[36,37]}. In this work, we selected a low-cost, commercially available C-based ink as the top electrode for PSCs to quantify the impact that C electrodes have on the ionic and thermomechanical stability of PSCs.

Described herein is a method of using a transient dark current response to extract Nₒ from MHP thin films or PSCs, and how Nₒ can serve as a metric to determine the onset of degradation in MHP thin films based on its evolution with aging. Compositional effects of Nₒ such as dependence on the dimensionality of the MHP and compositional tuning are demonstrated. We also describe using C electrodes in place of Ag electrodes to reduce Nₒ in the PSCs over a wide range of temperatures and with aging along with an increase in the mechanical robustness.

### EXPERIMENTAL

The substrate preparation steps before depositing the perovskite precursors or any of the transport layers are as follows: Indium tin oxide coated glass (ITO-glass) substrates (Xin Yan Technologies) are initially cleaned with an industry-grade soap solution of Extran mixed with water in the ratio of 1:10 for 10 min in an ultrasonic cleaner. After that, the ITO-glass slides are cleaned with de-ionized water, and the surface of the slides is cleaned with a brush to remove the residual soap. The glass slides are then cleaned with isopropyl alcohol (IPA) and acetone (Alfa Aesar—99.5%+) separately for 10 min and then subjected to ultraviolet and ozone treatment for 10 min.

Cesium Formamidinium Lead Iodide (Cs_{0.2}FA_{0.8}PbI₃)

The perovskite precursor solution for Cs_{0.2}FA_{0.8}PbI₃ films is prepared by mixing 0.2% Cesium Iodide (CsI) (Sigma-Aldrich—99.999% trace metals basis), 0.8% Formamidinium Iodide (FAI) (Greatcell Solar Materials), and Lead Iodide (PbI₂) (TCI America—99.99% trace metals basis). A measure of 1 mL, 1 M concentration solution is made by mixing 0.0519 gm of CsI, 0.1375 gm of FAI, and 0.461 gm of PbI2 in a solvent of 4:1 Dimethylformamide (DMF) (Sigma-Aldrich—Anhydrous 99.8%) and Dimethyl Sulfoxide (DMSO) (Sigma-Aldrich—Anhydrous >99.9%) with 800 μL of DMF and 200 μL of DMSO. A vortex mixer is used to mix the solution until a clear solution is formed. Cs_{0.2}FA_{0.8}PbI₃ films on ITO-glass were fabricated using spin coating. A two-step spin coating process with anti-solvent quenching was used where a measure of 100 μL of perovskite precursor was deposited on the glass substrate and spun at a speed of 1,000 rpm and acceleration of 500 rpm/s for 10 s and then the speed was stepped up to 5,000 rpm and acceleration of 1,500 rpm/s for 10 s. A measure of 100 μL of chlorobenzene (anti-solvent) (Sigma-Aldrich—Anhydrous 99.8%) was dropped on the sample at the last 3-5 s of the second step, and then the samples were annealed at 150° C. for 10 min.

### Methylammonium Lead Iodide (MAPbI₃)

The precursor solution for methylammonium lead iodide (MAPbI₃) is prepared by mixing methylammonium iodide (MAI) (Greatcell Solar Materials) and PbI₂. A measure of 1 mL, 1 M concentration solution is made by mixing 0.159 gm of MAI and 0.461 gm of PbI₂ in a solvent of 4:1 DMF to DMSO with 800 μL DMF and 200 μL DMSO, and the solution is mixed in a vortex mixer until a clear solution is formed. MAPbI₃ films on ITO-glass were fabricated following the same procedure showcased in previous work^{[6]}.

### Ruddlesden Popper 2D Perovskite

The precursor solution for [Ruddlesden Popper (RP), with butylammonium] phase n=1 [(BA)₂PbI₄] 2D perovskite is prepared by mixing butylammonium iodide (BAI) (Greatcell Solar Materials) and PbI₂. A measure of 1 mL, 1 M concentration solution is made by mixing 0.201 gm of BAI and 0.461 gm of PbI₂ in a solvent of 2:3 DMF to DMSO with 0.4 mL DMF and 0.6 mL DMSO. A 4 wt % polyvinylpyrrolidone (PVP with 10,000 average molecular weight) (Sigma-Aldrich) is then added to the solution and mixed in a vortex mixer until a clear solution is formed. A similar process is used to make RP phase n=2 [(BA)₂(MA)Pb₂I₇] 2D perovskite by mixing 0.201 gm of BAI, 0.0795 gm of MAI, and 0.461 gm of PbI₂.

### Dion-Jacobson 2D Perovskite

The precursor solution for [Dion-Jacobson (DJ), with propane-1,3-diammonium]phase n=1 2D perovskite is prepared by mixing propane-1,3-diammonium iodide (PDAI2) (Greatcell Solar Materials) and PbI₂. A measure of 1 mL, 1 M concentration solution is made by mixing 0.3295 gm of PDAI2 and 0.461 gm of PbI2 in a solvent of 2:3 DMF to DMSO with 0.4 mL DMF and 0.6 mL DMSO. A 4 wt % PVP (with 10,000 average molecular weight) is then added to the solution and mixed in a vortex mixer until a clear solution is formed. A similar process is used to make DJ phase n=4 [PDA(MA)₃Pb₄I₁₃] 2D perovskite by mixing 0.0824 gm of PDAI₂, 0.119 gm of MAL, and 0.461 gm of PbI₂.

Using spin coating, 2D MHP thin films (both RP and DJ phases) on ITO-glass were fabricated. A single-step spin coating process was used where 200 μL of perovskite ink was deposited on the substrate and spun at a speed of 2,000 rpm and acceleration of 500 rpm/s for 30 s and annealed at 100° C. for 10 min.

### Cesium Lead Iodide (CsPbI₃)

The precursor solution for CsPbI³ films is made by mixing CsI and PbI₂ following the recipe in the literature^{[38}]. A measure of 1 mL, 0.8 M concentration solution was made by mixing 0.2076 gm of CsI and 0.3688 gm of PbI₂ in a solvent of 1:4 DMF and DMSO with 200 μL DMF and 800 μL DMSO. A 3 wt % PVP is then added to the solution and mixed in a vortex mixer until a clear solution is formed. CsPbI₃ films on ITO-glass were fabricated following the same procedure showcased in previous work^{[38]}.

Double Halide Perovskite (Cs_{0.05}FA_{0.85}MA0.1PbI_{2.55}Br_{0.45})

The solution for the Cs_{0.05}FA_{0.85}MA0.1PbI_{2.55}Br_{0.45} precursor was prepared using molar ratios of PbI₂ (1.1 M), PbBr₂ (0.2 M), FAI (1 M), MABr (0.2 M), and CsI (1.5 M dissolved in DMSO). These compounds were dissolved in a mixed solvent of DMF and DMSO, with a volume ratio of 4:1. Subsequently, the prepared perovskite precursor underwent stirring at 70° C. for 4 h.

### Nickel-Oxide (NiOₓ)

NiOₓ solution for depositing the hole transport layer (HTL) is prepared by mixing 1 M NiNO₃·(H2O)6 (99.999% trace metals basis) in 94% ethylene glycol (EG) (thermo scientific—anhydrous 99.8%) and 6% ethylenediamine (EDA) (Thermo scientific—99%); the vial is then placed in a vortex mixer, and the solution is mixed until it turns into a dark blue color indicating the solubility of the precursor into the solvent.

### Perovskite Solar Cells (PSCs)

PSCs with the composition of MAPbI₃ with a device structure of Glass/ITO/NiOₓ/perovskite/C₆₀/Ag and with the composition of (Cs_{0.25}FA_{0.75})Pb(I_{0.8}Br_{0.2})₃+4 mol % MAPbCl₃^{[39]} with a device structure of Glass/ITO/poly-TPD/PFN/perovskite/C₆₀/Ag were fabricated in a p-i-n format following the same procedure showcased in the previous work^{[6]}. After the substrate preparation, the PSCs are fabricated in a step-by-step procedure where HTL and the perovskite absorber layers are deposited using spin coating, and the electron transport layer (ETL) and Ag top contact are deposited using evaporation in that order. A C top electrode is formed on the PSC by depositing it from the solvent-based C paste (solvent C) which is a mixture of graphite and carbon black (PELCO conductive carbon glue—Ted Pella).

PSCs with the composition of Cs_{0.05}FA_{0.81}MA_{0.14}PbI_{2.55}Br_{0.45} with a device structure of Glass/ITO/SnO₂/perovskite/2D MHP/solvent-free C were fabricated in an n-i-p format following the procedure showcased in the previous work^{[40]}. A 2D MHP precursor was made by making a solution containing 2.5 mg of phenethylammonium iodide (PEAI) dissolved in 1 mL of IPA. Additionally, 60 mL of this 2D solution was spin-coated onto the perovskite film at 3,000 rpm for 30 s. A 75 mm free-standing carbon film was created using a solvent exchange technique^{[41]}. The electrode was then hot-pressed onto the 2D MHP layer at 100 psi and 80° C. for 1 min^{[40]}.

### Characterization

All the ionic and electronic measurements were performed with PAIOS, an all-in-one measurement equipment for photovoltaic devices and light-emitting diodes (LEDs). In-situ ionic measurements were performed with the temperature control stage and module (LTS-420E) from Linkam in integration with PAIOS. The LTS-420E provided higher temperatures to the samples (from −195 to 420° C. with integrated electrical probes). A flow of liquid nitrogen (LN2) through the stage was used for cooling. A heating pad was used to age the MHP thin films and PSCs (aged as is) at 45 or 65° C. in a N2 glovebox for the period they were aged with ex-situ measurements on PAIOS at 24 h intervals. The aging process followed for MHP thin films involved aging a layer stack of ITO-Glass/MHP and then adding the electrode on the sample after aging while making the measurements; this was done to avoid any involvement from the solvents present in the C paste used for the electrode during aging. Nₒ was measured and calculated using the transient dark current method as described in our previous work^{[6]} in which a voltage bias of 800 mV is applied to the PSC in the forwards-bias configuration in the form of a pulse with the following characteristics: 1 ms settling time, 10 ms pulse time, 1 ms follow-up time. The entire measurement lasts around 13 ms with the measurement cut-off around 1 ms after the bias is taken away which gives the mobile ions in the PSC enough time to fully drift. The measured drift current can be time-integrated and divided by the elementary charge, area, and thickness of the MHP layer, respectively, to determine Nₒ.

Fracture energy (G_{c}) was measured with a standard fracture specimen configuration called a double cantilever beam (DCB). To create a DCB fracture sample, a layer of thin epoxy was applied to cover glass with the identical dimensions as the substrate glass for the device/stack and then bonded to the device/stack to create a sandwich-like structure with the device layers bonded between glass at room temperature. G_{c} was then calculated and averaged based on the method showcased elsewhere^{[42]}.

### Non-Limiting, Exemplary Results and Discussion

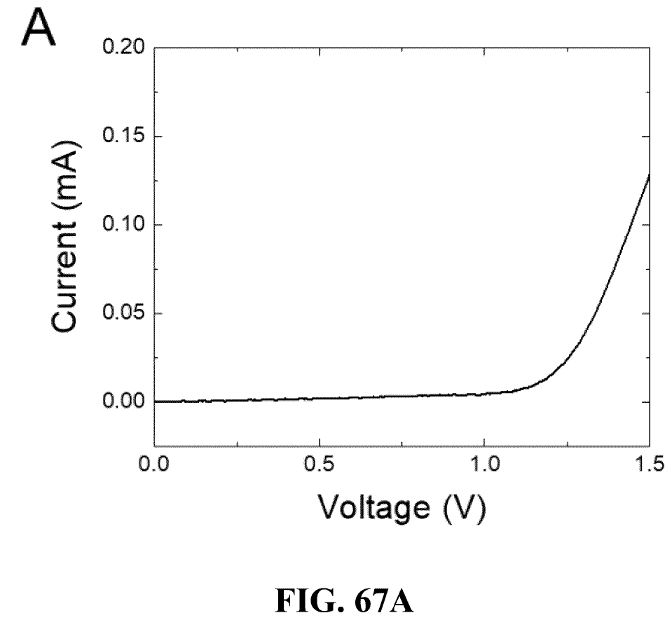

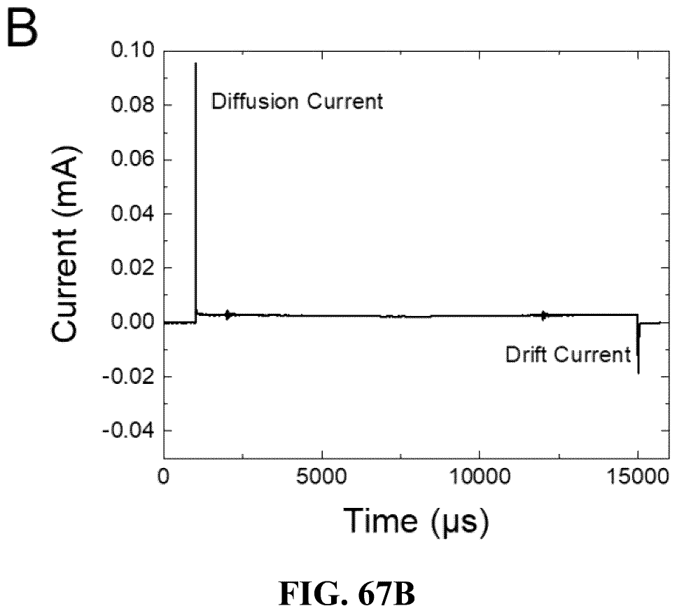

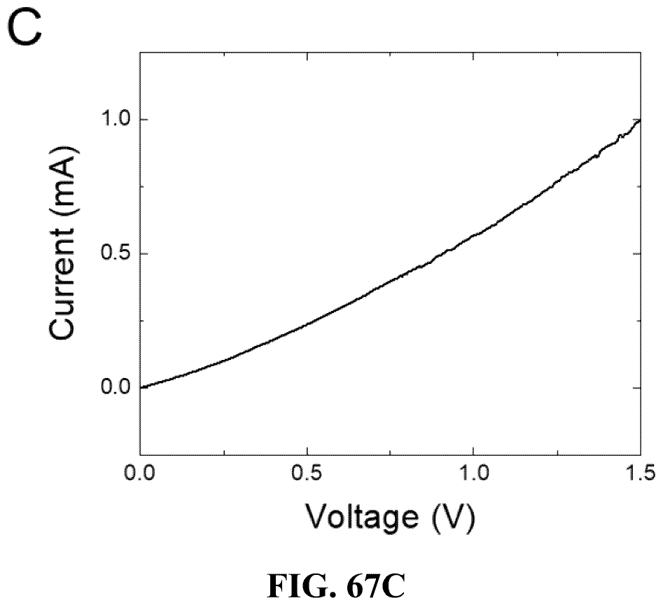

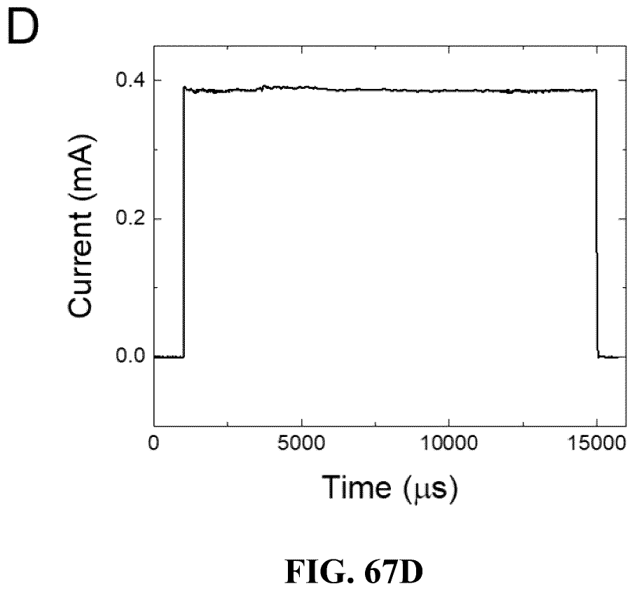

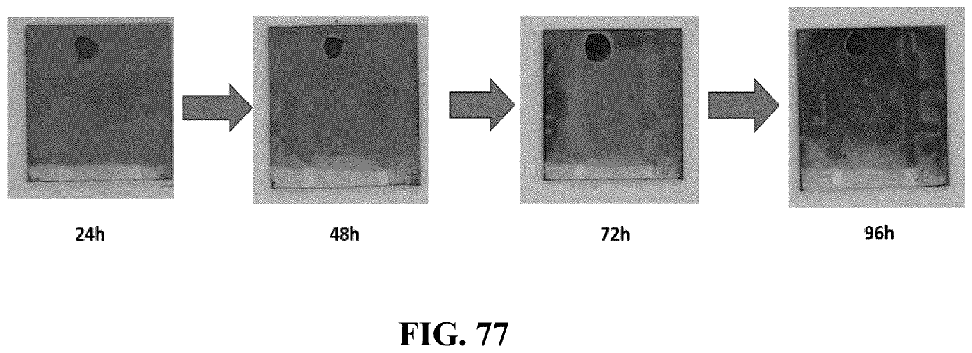

We first conducted ex-situ Nₒ and current-voltage (I-V) measurements on MAPbI₃ films with the layer stack of ITO-Glass/MHP/solvent C before and after exposure to 85° C. for a total of 96 h following the aforementioned aging procedure of the MHP thin films in a N₂ glove box to prevent moisture-induced degradation. The results of the I-V response and transient dark current shown in FIGS. 67A and 67B were obtained before any exposure. From the I-V curve, the film operated normally with around a 1.1 V turn-on voltage and a Nₒ value of 1.55×1012 cm-3 before exposure. However, after heat exposure, as shown in FIGS. 67C and 67D, there was no ionic (drift current) response due to the resistor-like behavior of the degraded MHP generating a current at the applied bias of 0.8 V. Since the Nₒ measurement comes from integrating the drift current response, there was no possible way to extract Nₒ after exposure. FIG. 77 shows images of the MHP throughout the heat exposure revealing noticeable visual changes as the film degraded.

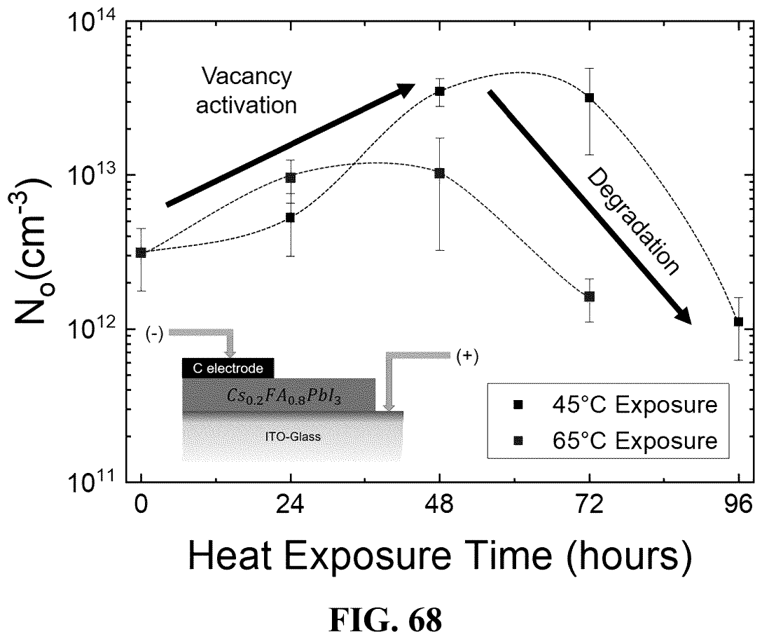

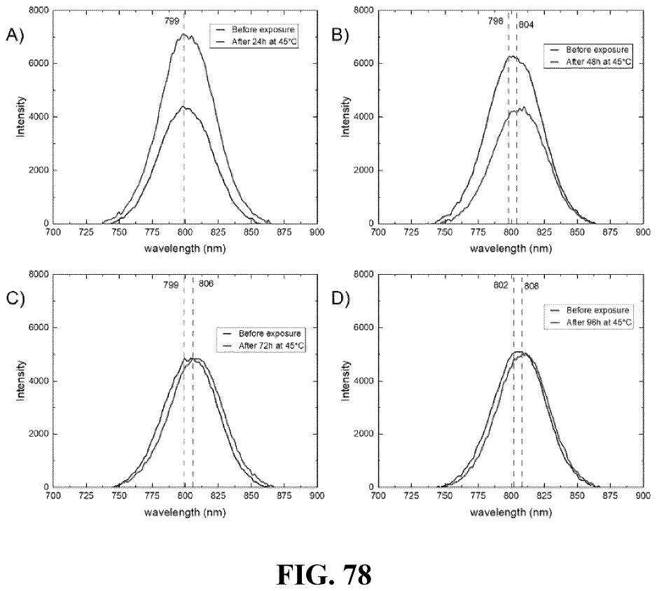

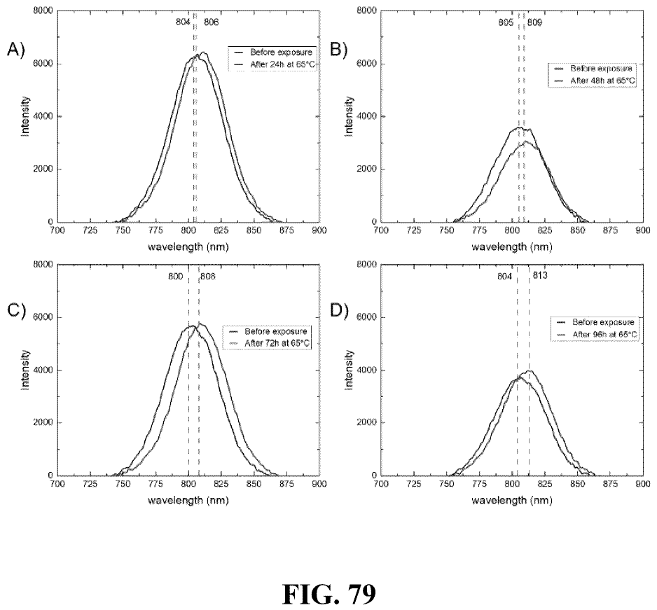

To study the effect of mobile ion changes in a more thermally stable MHP absorber under temperatures closer to operation, ex-situ Nₒ measurements were performed on Cs_{0.2}FA_{0.8}PbI₃ films with a layer stack of ITO-Glass/MHP/solvent C [FIG. 68 (inset)] before and after exposure to 45 and 65° C. separately for 96 h in a N₂ glovebox following the transient dark current method to understand the evolution of Nₒ with aging. Note that in all cases, the solvent C electrode was added after each aging step to prevent interactions with the MHP layer. The films were aged with a glass substrate placed on top to simulate encapsulation/device integration without adding layers that could electrochemically interact with the MHP. This prevented the expulsion of iodine from the MHP lattice with a surface directly above the film and can, without wishing to be bound by theory, explain why the film degraded more without the additional glass substrate (as shown by the redshift in the photoluminescence peaks in FIGS. 78 and 79, Table 9).

TABLE 9
Shift in the PL wavelength towards the
right side after aging at 45° C. and 65° C.
respectively at each of the time stamps
(24 h, 48 h, 72 h, 96 h)

| | Shift in PL | Shift in PL |
|---|---|---|
| | wavelength | wavelength |
| Time | (nm) at 45° C. | (nm) at 65° C. |
| After 24 h | 0 | 2 |
| After 48 h | 6 | 4 |
| After 72 h | 7 | 8 |
| After 96 h | 6 | 9 |

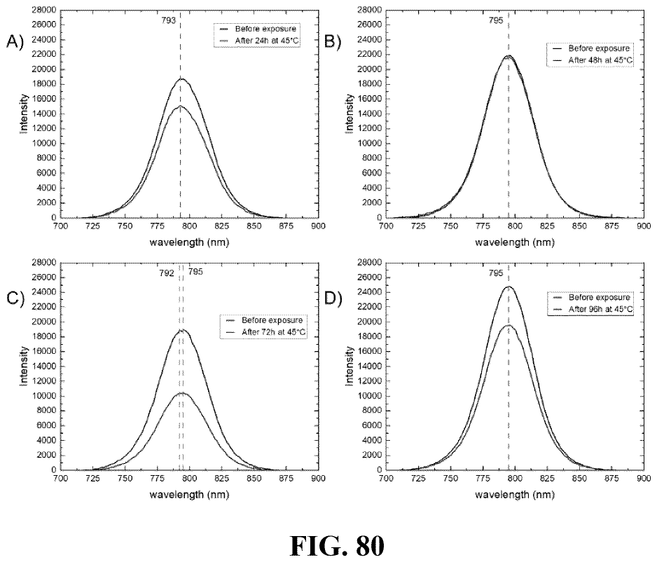

FIG. 68 shows the evolution of Nₒ in Cs_{0.2}FA_{0.8}PbI₃ films vs. time with aging, where the value of Nₒ has an initial increase after exposure to heat and then plateaus before eventually reducing in value with aging. Cs_{0.2}FA_{0.8}PbI₃ films did not have a Nₒ measurement at 96 h when subjected to 65° C. as the films did not have any electronic response after the aforementioned exposure. Without wishing to be bound by theory, the initial increase in the value of Nₒ is due to the creation of more iodide vacancies from heating and the eventual reduction is due to the degradation of the film with external stimuli leading to a loss of electronic response (corroborated by the decreased photoluminescence peaks in FIGS. 79 and 80, Table 10), which, in turn, affects the ionic measurement (as in FIG. 67C) rather than an inherent reduction in the number of halide vacancies.

TABLE 10
Shift in the PL wavelength (very minimal
change) after aging at 45° C. and 65° C.
respectively (with a glass substrateon
top) at each of the time stamps
(24 h, 48 h, 72 h, 96 h).

| | Shift in PL | Shift in PL |
|---|---|---|
| | wavelength | wavelength |
| Time | (nm) at 45° C. | (nm) at 65° C. |
| After 24 h | 0 | 0 |
| After 48 h | 0 | 0 |
| After 72 h | 3 | 2 |
| After 96 h | 0 | 1 |

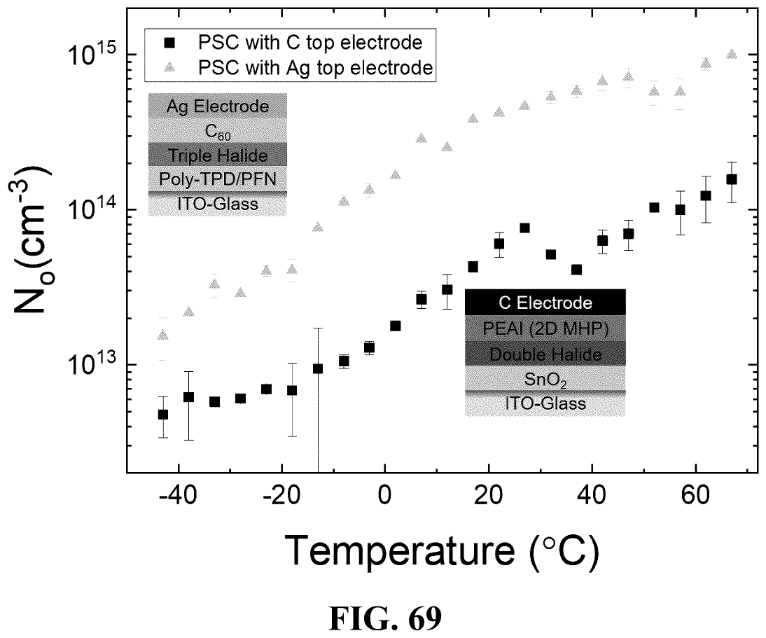

To understand the effect temperature has on Nₒ in PSCs, in-situ transient dark current measurements were taken as the PSCs underwent heating and cooling in a N2 glovebox with a comparison of the highly mobile/reactive Ag electrode compared to an inert solvent-free C electrode. As shown in FIG. 69, both PSCs showed a strong positive correlation with Nₒ vs. temperature with the C electrode PSC exhibiting ˜10× less mobile ions than the Ag electrode PSC. At the higher temperatures, the Ag electrode PSC had approximately ˜1.0×1015 and 1.0×1013 cm-3 mobile ions at lower temperatures while the C electrode device contained ˜1.0×1014 and ˜5.0×1012 cm-3, respectively. The PSCs exhibit higher activation energies at lower temperatures and activation energies at higher temperatures based on the distinct slopes of Nₒ in FIG. 69 for both Ag and C electrode PSCs where the slope of Nₒ vs. temperature is higher below 10° C. and is lower above 10° C. which is similar to the behavior of ion conductivity vs. temperature^{[43]}. The C electrode PSC had a lower ion concentration dependence on temperature with less than two orders of magnitude change from higher to lower temperatures as compared to the full two orders of magnitude change in the Ag electrode PSC. This can be attributed to the inertness of the C as compared to Ag but the difference in device composition (as the C electrode device had a 2D MHP layer) can also have had an effect in this case.

To study the effect of the top electrode on Nₒ in the same device architecture, we performed a follow-up study where solvent-free C and Ag electrodes were deposited on different parts of identical substrates, and Nₒ measurements were conducted. MAPbI₃ PSCs were subjected to heat for 72 h in which ex-situ/in-situ dark I-V and Nₒ measurements were conducted. Measurements were made either in-situ at 65° C. while aging or ex-situ at room temperature after aging at 65° C. Note that in all cases, the in-situ values were higher than the ex-situ values, an expected result due to ion activation at the higher temperature and observed in FIG. 3 for both Ag and C electrodes.

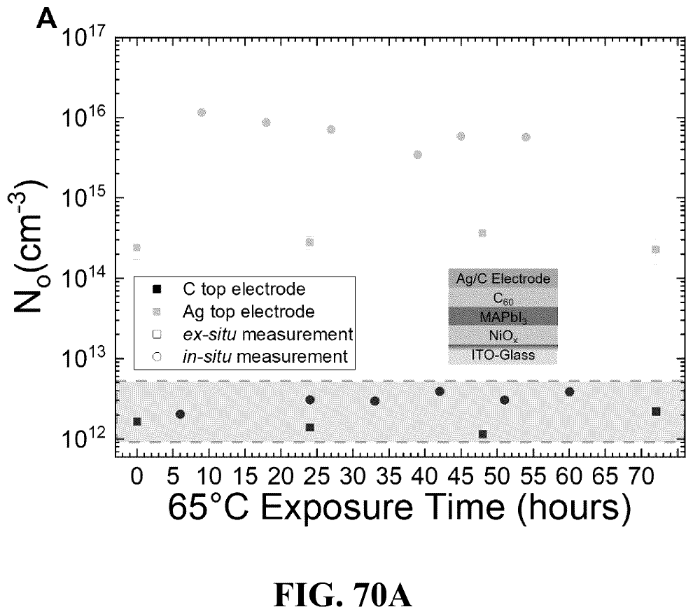

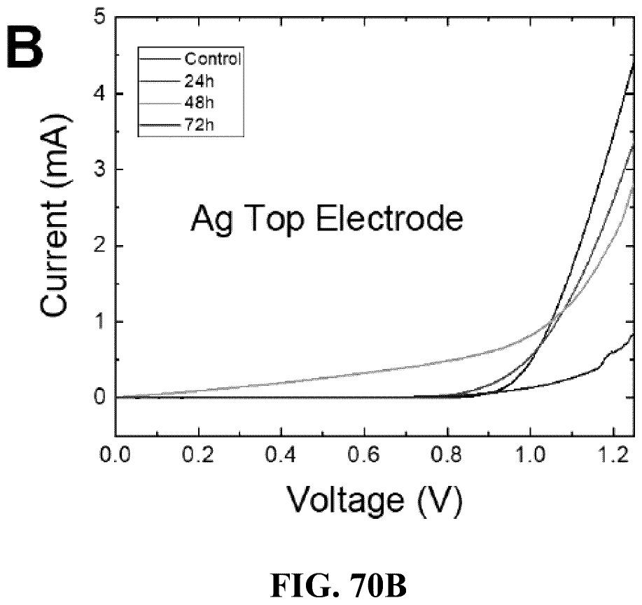

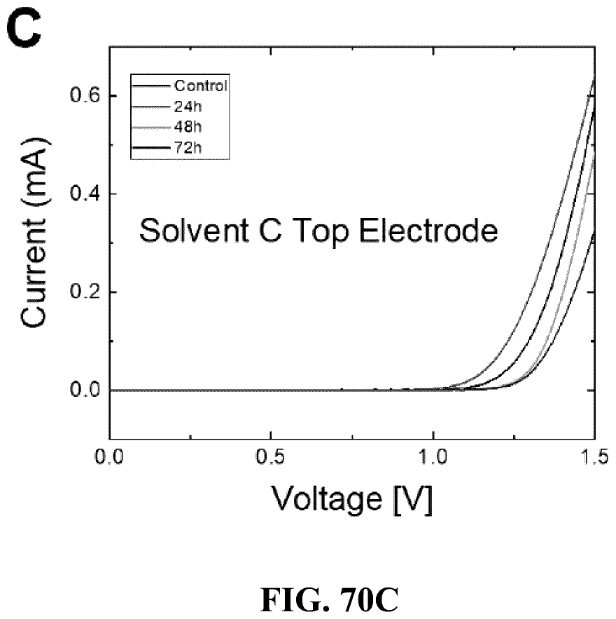

There were three Ag electrodes and one C electrode on the PSC where each was measured separately depicting a more accurate comparison of the experiment as a whole. In FIG. 70A, the C electrode showed a much tighter range of Nₒ values with the in-situ and ex-situ measurements residing within one order of magnitude of each other as compared to the wider range seen in Ag.

This contributes to the claim that Ag plays a large role in Nₒ at elevated temperatures due to its inherent ionic properties. The large overall increase in Nₒ from ex-situ to in-situ shown in Ag is, without wishing to be bound by theory, Ag ions becoming mobile in the PSC in conjunction with the already mobile halide ions^{[24]}. More investigation is needed to validate this possible effect, but the results indicate a clear effect of electrode composition on Nₒ. The dark I-V curves in FIGS. 70B and 70C further illustrate the degradation occurring in the Ag electrode PSCs compared to the thermally stable C electrode PSCs.

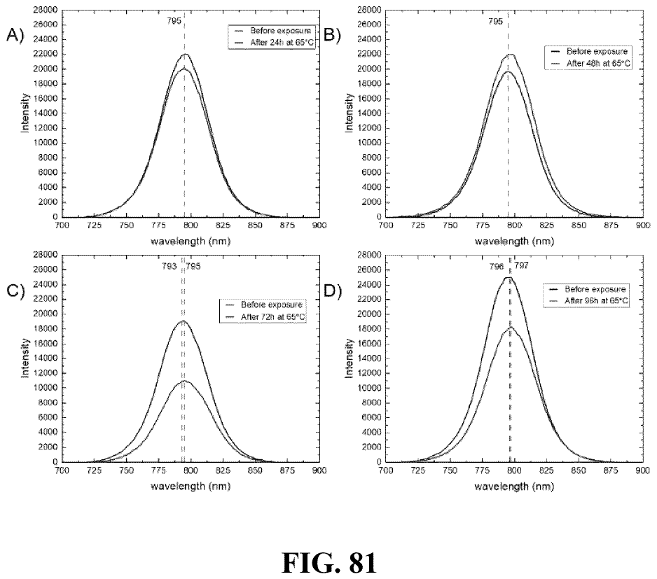

The dark I-V curves were obtained by measuring the same electrode at each time stamp in the heat exposure process. The 48 h I-V measurement for the Ag electrode in FIG. 70B shows a heavily decayed response compared to the 72 h measurement. Without wishing to be bound by theory, this can be due to uneven degradation of the measured Ag electrode surface causing slight variations in measurement due to probe contact location. This was not present in the C electrode where there was no variation across the surface as shown with the identically shaped I-V curves in FIG. 70C. Note that when focusing on the higher voltage section of the curves (past turn-on voltage), we can see that both electrodes show a decrease in slope as aging time increases indicating an increase in series resistance across the PSC^{[44]}, an effect that is more dramatic for Ag than C [Table 11]. In addition, FIG. 81 shows the changes in electronic and ionic properties of PSCs with Ag electrode with exposure time at 65° C., where Jsc drops continually over the course of the 72 h exposure. These results show that with this MAPbI₃ PSC, the C electrode is more stable both ionically and electronically.

TABLE 11
Resistance tables show increasing series resistance with silver over time
with an overall 10 times lower shunt resistance than the carbon electrode
excluding the 48-hour measurement. Carbon maintains a relatively constant
series resistance with a slight increase in shunt resistance from 0 to 72 hours.

| | Carbon Electrode | | Silver Electrode | |
|---|---|---|---|---|
| Aging | Series | Shunt | Series | Shunt |
| Time | Resistance | Resistance | Resistance | Resistance |
| (hours) | (Rₛ) (Ω) | (Rₛₕ) (Ω) | (Rₛ) (Ω) | (Rₛₕ) (Ω) |
| 0 | 382 | 2.68 × 10⁶ | 67.8 | 4.89 × 10⁵ |
| 24 | 519 | 3.05 × 10⁶ | 65.5 | 3.52 × 10⁵ |
| 48 | 287 | 3.97 × 10⁶ | 76.9 | 8.19 × 10³ |
| 72 | 416 | 3.69 × 10⁶ | 245 | 2.87 × 10⁵ |

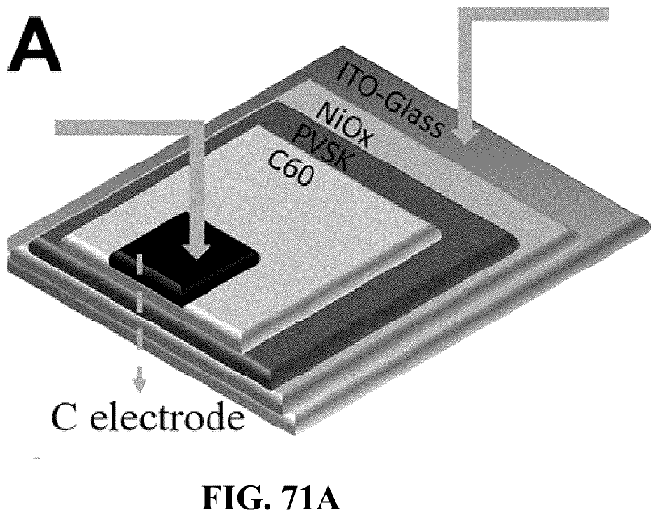

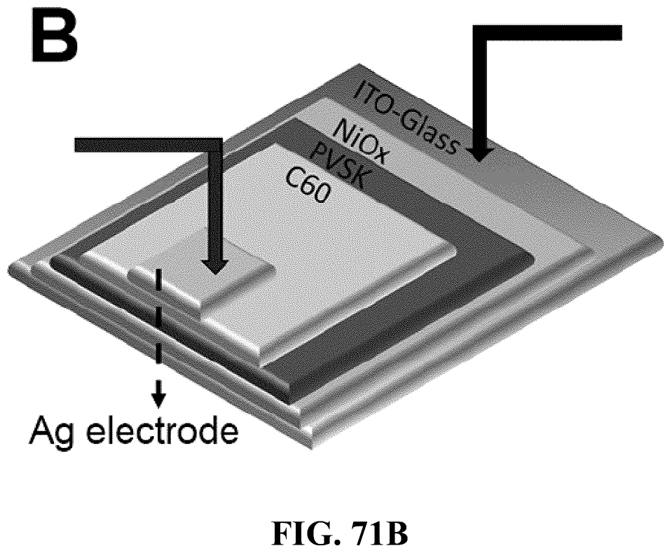

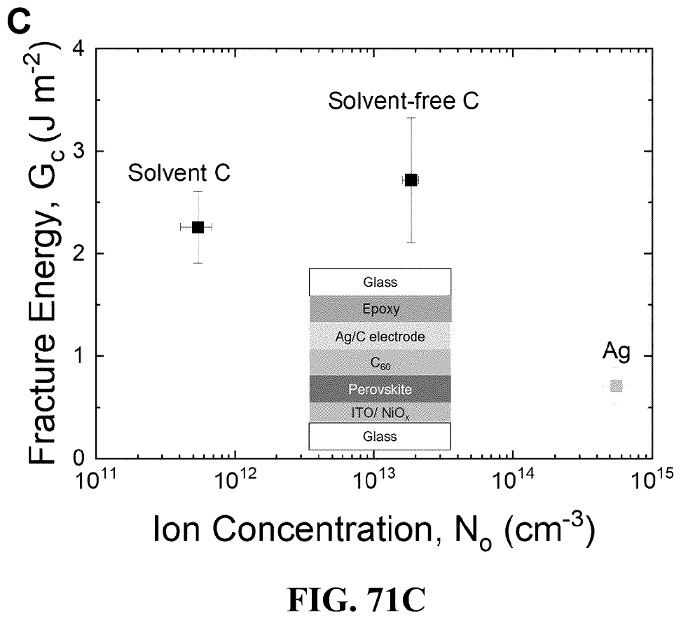

To understand the effects of Nₒ on other MHP properties such as mechanical durability and material composition, and without wishing to be bound by theory, the reduction in Nₒ resulting from robust bonding in the MHP can lead to fewer chemical changes in the MHP and hence can improve interfacial adhesion. Gc is a key metric of thermomechanical reliability and quantifies adhesion in thin film materials and devices. Nₒ measurements of the PSCs [FIGS. 71A and 71B] were performed along with Gc measurements of the PSCs by sandwiching them between glass substrates [FIG. 71C] to correlate GC with Nₒ. The following device stacks were used for the above measurements ITO-Glass/NiOₓ/MAPbI₃/C₆₀/(Ag/solvent-C/solvent-free C). These device stacks were chosen to measure and understand the variation in Nₒ based on the top electrode observed from our previous work^{[6]}. From FIG. 71C, the Nₒ with a Ag top electrode is ˜6.0×1014 cm-3 and GC is 0.8 J m-2, the Nₒ with a solvent-free C electrode is ˜2.0×1013 cm-3 and GC is 2.8 J m-2, and the Nₒ with a solvent C electrode is ˜5.0×1011 cm⁻³ and GC is 2.3 J m-2. As such, PSCs with an Ag top electrode have a higher Nₒ and lower Gc than PSCs with a C top electrode, which has a lower Nₒ and higher Gc. Using C as the top electrode instead of Ag is beneficial because it suppresses ion migration and improves bonding. The main challenge limiting the usage of C electrodes in PSCs is to achieve comparable electronic conductivity to Ag^{[40]}.

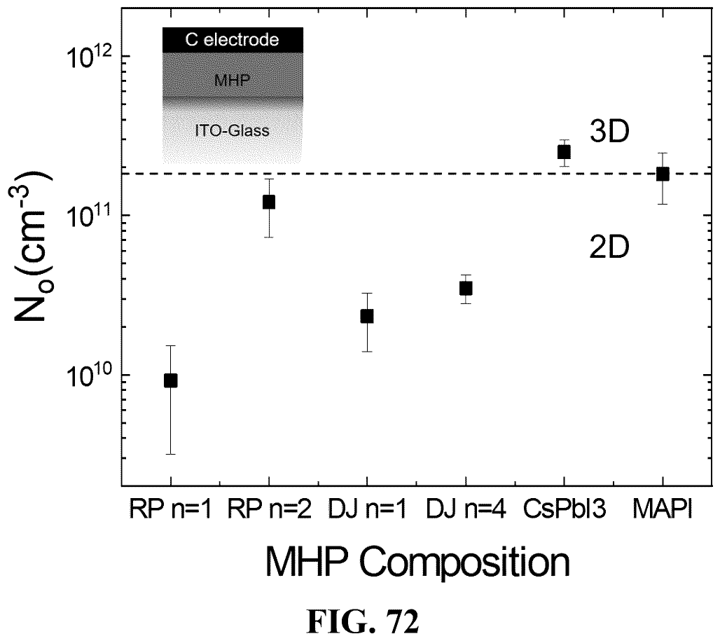

Lastly, Nₒ measurements were performed on MHP films of different compositions to correlate mobile ions with the composition of the MHP [FIG. 72 (inset)]. Nₒ was quantified for various compositions of 2D MHPs such as RP phase (with butylammonium) n=1, n=2, and DJ phase (with propane-1,3-diammonium) n=1, n=4^{[45]}, and 3D MHPs such as CsPbI₃ in addition to MAPbI₃. From FIG. 6, Nₒ of the 2D MHPs is lower than the 3D MHPs, where the former ranges from ˜9.0×109 to ˜1.0×1011 cm-3, and the latter falls between ˜1.8×1011 and ˜2.5×1011 cm-3 for the measured samples. These values of Nₒ across different compositions of MHPs indicate variation according to the composition. We conclude that 2D MHPs have lower Nₒ than the 3D MHPs, indicating that MHP dimensionality and structure also affect Nₒ in these materials. This could be due to the 2D MHP lattice creating more tightly bound halides due to the constraint imposed by the bulky organic cations, thus reducing the concentration of mobile halide vacancies that dominate the MHP film^{[14]}. As shown in FIG. 72, n=1 2D RP MHP exhibits a lower Nₒ than n=1 2D DJ MHP. Additionally, FIG. 72 illustrates the slope change in Nₒ with increasing n-value, which is lower for 2D DJ MHP than for 2D RP MHP. We attribute this difference in behavior to the hydrogen bonding with weak Van Der Waals forces of the monoammonium cation (butylammonium) in RP phase 2D MHP and the strong hydrogen bonding of the diammonium cation (1,3-propanediammonium) between the inorganic layers which, without wishing to be bound by theory, can more effectively prevent the activation and movement of mobile ions^{[46]}.

### NON-LIMITING CONCLUSIONS

We demonstrated that our mobile ion characterization platform can quantify MHP properties in films and devices, where the dimensionality and composition of the MHP play a role on Nₒ. Additionally, Nₒ can characterize stability over time through vacancy formation and subsequent degradation. The use of C-based electrodes was shown to significantly reduce Nₒ across a range of temperatures and device architectures while simultaneously improving the mechanical reliability of the device stack.

Without wishing to be bound by theory, the presence of metal (specifically Ag) directly contributes to the increase in Nₒ values. The fundamental understanding from this work can help inform stable device design in MHPs and PSCs.

### REFERENCES CITED HEREIN

NREL. Champion photovoltaic module efficiency chart. Available from: https://www.nrel.gov/pv/module-efficiency.html [Last accessed on 5 Jun. 2024].
Bhattacharya S, John S. Beyond 30% conversion efficiency in silicon solar cells: a numerical demonstration. Sci Rep 2019; 9:12482. DOI PubMed PMC
Čulik P, Brooks K, Momblona C, et al. Design and cost analysis of 100 MW perovskite solar panel manufacturing process in different locations. ACS Energy Lett 2022; 7:3039-44. DOI
NREL. Best research-cell efficiency chart. Available from: https://www.nrel.gov/pv/cell-efficiency.html [Last accessed on 5 Jun. 2024].
Rivkin B, Fassl P, Sun Q, Taylor A D, Chen Z, Vaynzof Y. Effect of ion migration-induced electrode degradation on the operational stability of perovskite solar cells. ACS Omega 2018; 3:10042-7. DOI PubMed PMC
Penukula S, Estrada Torrejon R, Rolston N. Quantifying and reducing ion migration in metal halide perovskites through control of mobile ions. Molecules 2023; 28:5026. DOI PubMed PMC
Bi E, Song Z, Li C, Wu Z, Yan Y. Mitigating ion migration in perovskite solar cells. Trends Chem 2021; 3:575-88. DOI
Tayagaki T, Yamamoto K, Murakami T N, Yoshita M. Temperature-dependent ion migration and mobile-ion-induced degradation of perovskite solar cells under illumination. Solar Energy Mater Solar Cells 2023; 257:112387. DOI
Wu Z, Yuan S, Miao S, et al. Unraveling the rapid ion migration in perovskite solar cells by circuit-switched transient photoelectric technique. J Chem Phys 2024; 160:111101. DOI
Zai H, Ma Y, Chen Q, Zhou H. Ion migration in halide perovskite solar cells: mechanism, characterization, impact and suppression. J Energy Chem 2021; 63:528-49. DOI
Zhao Y, Zhou W, Han Z, Yu D, Zhao Q. Effects of ion migration and improvement strategies for the operational stability of perovskite solar cells. Phys Chem Chem Phys 2021; 23:94-106. DOI
Liu J, Hu M, Dai Z, Que W, Padture N P, Zhou Y. Correlations between electrochemical ion migration and anomalous device behaviors in perovskite solar cells. ACS Energy Lett 2021; 6:1003-14. DOI
Hossain M I, Tong Y, Shetty A, Mansour S. Probing the degradation pathways in perovskite solar cells. Solar Energy 2023; 265:112128. DOI
Mathew P, Cho J, Kamat P V. Ramifications of ion migration in 2D lead halide perovskites. ACS Energy Lett 2024; 9:1103-14. DOI
Huang Z, Proppe A H, Tan H, et al. Suppressed ion migration in reduced-dimensional perovskites improves operating stability. ACS Energy Lett 2019; 4:1521-7. DOI
Grancini G, Nazeeruddin M K. Dimensional tailoring of hybrid perovskites for photovoltaics. Nat Rev Mater 2019; 4:4-22. DOI
Zhao X, Liu T, Loo Y L. Advancing 2D perovskites for efficient and stable solar cells: challenges and opportunities. Adv Mater 2022; 34:e2105849. DOI
Ortiz-Cervantes C, Carmona-Monroy P, Solis-Ibarra D. Two-dimensional halide perovskites in solar cells: 2D or not 2D?ChemSusChem 2019; 12:1560-75. DOI
Ma K, Sun J, Atapattu H R, et al. Holistic energy landscape management in 2D/3D heterojunction via molecular engineering for efficient perovskite solar cells. Sci Adv 2023; 9:eadg0032. DOI PubMed PMC
Zouhair S, Clegg C, Valitova I, March S, Jailani J M, Pecunia V. Carbon electrodes for perovskite photovoltaics: interfacial properties, meta-analysis, and prospects. Solar RRL 2024; 8:2300929. DOI
Besleaga C, Abramiuc L E, Stancu V, et al. Iodine migration and degradation of perovskite solar cells enhanced by metallic electrodes. J Phys Chem Lett 2016; 7:5168-75. DOI
Domanski K, Correa-Baena J P, Mine N, et al. Not all that glitters is gold: metal-migration-induced degradation in perovskite solar cells. ACS Nano 2016; 10:6306-14. DOI
Parashar M, Sharma M, Saini D K, et al. Probing elemental diffusion and radiation tolerance of perovskite solar cells via non-destructive Rutherford backscattering spectrometry. APL Energy 2024; 2:016109. DOI
Kerner R A, Cohen A V, Xu Z, et al. Electrochemical doping of halide perovskites by noble metal interstitial cations. Adv Mater 2023; 35:e2302206. DOI
Sun X, Lin T, Ding C, et al. Fabrication of opaque aluminum electrode-based perovskite solar cells enabled by the interface optimization. Org Electron 2022; 104:106475. DOI
Svanström S, Garcia-Fernandez A, Jacobsson T J, et al. The complex degradation mechanism of copper electrodes on lead halide perovskites. ACS Mater Au 2022; 2:301-12. DOI PubMed PMC
Chen H, Yang S. Stabilizing and scaling up carbon-based perovskite solar cells. J Mater Res 2017; 32:3011-20. DOI
Hadadian M, Smitt J, Correa-baena J. The role of carbon-based materials in enhancing the stability of perovskite solar cells. Energy Environ Sci 2020; 13:1377-407. DOI
Baghestani E, Tajabadi F, Saki Z, et al. A conductive adhesive ink for carbon-laminated perovskite solar cells with enhanced stability and high efficiency. Solar Energy 2023; 266:112165. DOI
Zhu A, Chen L, Zhang A, et al. Playdough-like carbon electrode: a promising strategy for high efficiency perovskite solar cells and modules. eScience 2024; 4:100221. DOI
Jeon I, Seo S, Sato Y, et al. Perovskite solar cells using carbon nanotubes both as cathode and as anode. J Phys Chem C 2017; 121:25743-9. DOI
Zhang J, Hu X G, Ji K, et al. High-performance bifacial perovskite solar cells enabled by single-walled carbon nanotubes. Nat Commun 2024; 15:2245. DOI PubMed PMC
Zhang C, Wang S, Zhang H, et al. Efficient stable graphene-based perovskite solar cells with high flexibility in device assembling via modular architecture design. Energy Environ Sci 2019; 12:3585-94. DOI
Gan Y, Sun J, Guo P, et al. Advances in the research of carbon electrodes for perovskite solar cells. Dalton Trans 2023; 52:16558-77. DOI
Pandey S, Karakoti M, Bhardwaj D, et al. Recent advances in carbon-based materials for high-performance perovskite solar cells: gaps, challenges and fulfillment. Nanoscale Adv 2023; 5:1492-526. DOI PubMed PMC
Fagiolari L, Bella F. Carbon-based materials for stable, cheaper and large-scale processable perovskite solar cells. Energy Environ Sci 2019; 12:3437-72. DOI
Yu Y, Hoang M T, Yang Y, Wang H. Critical assessment of carbon pastes for carbon electrode-based perovskite solar cells. Carbon 2023; 205:270-93. DOI
Nguyen H, Penukula S, Mahaffey M, Rolston N. All inorganic CsPbI3 perovskite solar cells with reduced mobile ion concentration and film stress. MRS Commun 2024; 14:208-14. DOI
Xu J, Boyd C C, Yu Z J, et al. Triple-halide wide-band gap perovskites with suppressed phase segregation for efficient tandems. Science 2020; 367:1097-104. DOI
Vijayaraghavan S N, Wall J, Xiang W, et al. Carbon electrode with sputtered Au coating for efficient and stable perovskite solar cells. ACS Appl Mater Interfaces 2023; 15:15290-7. DOI
Zhang H, Xiao J, Shi J, et al. Self-adhesive macroporous carbon electrodes for efficient and stable perovskite solar cells. Adv Funct Mater 2018; 28:1802985. DOI
Li M, Johnson S, Gil-escrig L, et al. Strategies to improve the mechanical robustness of metal halide perovskite solar cells. Energy Adv 2024; 3:273-80. DOI
Han B, Yuan S, Cai B, et al. Green perovskite light-emitting diodes with 200 hours stability and 16% efficiency: cross-linking strategy and mechanism. Adv Funct Mater 2021; 31:2011003. DOI
Morales-aragones JI, Alonso-garcia MDC, Gallardo-saavedra S, et al. Online distributed measurement of dark I-V curves in photovoltaic plants. Appl Sci 2021; 11:1924. DOI
Liu R, Hu X, Xu M, Ren H, Yu H. Layered low-dimensional ruddlesden-popper and dion-jacobson perovskites: from material properties to photovoltaic device performance. ChemSusChem 2023; 16:e202300736. DOI
Ahmad S, Fu P, Yu S, et al. Dion-jacobson phase 2D layered perovskites for solar cells with ultrahigh stability. Joule 2019; 3:794-806. DOI
Chen K, Xiao X, Liu J, et al. Record-efficiency printable hole-conductor-free mesoscopic perovskite solar cells enabled by the multifunctional schiff base derivative. Adv Mater 2024; 36:e2401319. DOI

### Example 7

All Inorganic CsPbI₃ Perovskite Solar Cells with Reduced Mobile Ion Concentration and Film Stress

Here, we study the impact of a polyvinylpyrrolidone (PVP) additive on cesium-based lead halide perovskites. We demonstrate the control of phase, morphology, film stress, and ion concentration under accelerated aging with the use of PVP in CsPbI₃. The addition of PVP in all-inorganic metal halide perovskites (MHP) further induces a residual compressive film stress, a factor that is correlated with improved film stability. The removal of PVP increased the stress based on a contraction in the film. Under thermal cycling, thermal aging, and light-induced aging, all-inorganic MHP films experienced negligible bandgap change and comparable ion behavior with and without PVP removal.

### INTRODUCTION

Metal halide perovskites (MHP) are a next-generation photo-voltaic technology due to their intrinsic passivating proper-ties of high charge carrier lifetimes, absence of deep-level trap states, and large charge carrier mobilities.^{[1,2]} Yet, organic-inorganic MHP (ABX₃, A=MA, FA, B═Pb, ×=I) suffer from degradation due to thermal, moisture, oxygen, and ultraviolet (UV) light exposure^{[1,3]} in part due to the weak hydrogen bonds between the monovalent organic cations and the octahedral metal halide structure.^{[1,3]} Therefore, the characteristically high thermal stability and improved bonding in all-inorganic cesium-based (Cs) lead halide perovskites (CsPbX3, ×=I, Br, Cl) has resulted in a recent surge in their interest.^{[2]}

Stabilized α-CsPbI₃ has a bandgap of ˜1.73 eV, making it ideal for inclusion in tandem solar cells with silicon-based photo absorbers^{[2,4-8]} However, a desired cubic black phase α-CsPbI₃ can only form and be preserved at over 320° C., causing the material to transition to an intermediate undesired tetragonal β-CsPbI₃ at lower temperatures, then to an orthorhombic yellow phase γ-CsPbI₃ at room temperature.^{[8,9]}

This structural instability can be attributed to the Goldschmidt tolerance factor, defined by the equation^{[5,9,10]}:

$$t = \frac{{r}_{A} + {r}_{x}}{\sqrt{2 ( {r}_{B} + {r}_{X} )}}$$

where r_{A}, r_{B}, and r_{X} are the ionic radii for their respective sites in the ABX₃ structure.

The Goldschmidt tolerance factor is a conventional empirical metric used to quantify the relative closeness of perovskite compositions to an ideal cubic phase. Generally, inorganic-organic compositions with tolerance factors of 0.8<t<1.0 are cubic, whereas t<0.8 are orthorhombic and in a non-photoactive phase at room temperature.^{[5,9,10]} Due to the small A-site cation Cs+, CsPbI₃ tends to convert into a non-photoactive phase with a tolerance factor t<0.8. Methods to alter the tolerance factor via X-site engineering by introducing Br and Cl halides have been proven to improve the thermo-dynamic stability of Cs MHP into a photoactive α-phase, but have the consequence of further increasing the composition's bandgap, thus making the material less ideal for tandem solar cells.^{[5,10]} Additionally, these halide alloyed materials have increased susceptibility to light-induced halide segregation.^{[11]} Another approach is A-site engineering, which has been widely employed by alloying with formamidinium (FA); however, there has been evidence of phase segregation between the cations under operation.^{[12]} As stated above, the addition of organic cations is generally undesirable from a stability perspective.

The use of polymer additives has proven to be an effective strategy in enhancing the phase stability and film morphology of CsPbI₃ while also maintaining its optoelectronic properties. Polyvinylpyrrolidone (PVP) has also been introduced as a precursor additive to maintain a stabilized α-CsPbI₃ through surface passivation engineering; the PVP additive further demonstrated a strong promise in CsPbI₃ processing by reducing the crystal formation energy while reaching power conversion efficiencies (PCE) up to 14.9%.^{[7]} While PVP has been effective for film processing, PVP is often removed from CsPbI₃ devices via an isopropanol (IPA) bath for increased efficiencies.^{[4]} However, studies have also found that devices retaining PVP can still reach PCE up to 10% with 3% added PVP CsPbI₃.^{[8]} This indicates an opportunity to leverage PVP-induced surface passivation without significantly impacting device performance. Furthermore, PVP has also been used in the electron transport layer^{[13]} and in other perovskite compositions at non-negligible amounts with improved performance and stability.^{[14]} Even in very small amounts (fractions of mg/mL), PVP-based additives have demonstrated impressive effects on perovskite performance and behavior.^{[15]}

Of the remaining stability challenges that face MHP, a key area of improvement is in controlling residual film stress. The significance of residual stresses is more prevalent on the module scale, acting as the driving force in delamination and fracture, ultimately reducing cell efficiencies and mechanical stabilities through defect evolution and degradation in the MHP phase.^{[16-19]} Due to the high thermal coefficient of MHP-especially for all-inorganic CsPbI₃^{[20]}—a large thermal expansion mismatch occurs between the film and substrate (when glass or silicon is used) during crystal growth, ultimately leading to residual tensile stresses upon cooling to room temperature.^{[16-19]} On the contrary, compressive residual stresses have proven to heal defects and improve film stability when exposed to external stresses such as heat.^{[18]} Therefore, inducing an intrinsic compressive stress is desired to enhance film stability. Ion mobility is also known to play a significant role in film degradation. Mobile ion concentration (Nₒ), defined to be the number of mobile ions per unit volume, has a negative correlation with operational stability based on device architectures^{[21]}; that is, with a higher Nₒ, it is expected that device stability will decrease due to ion migration. The degradation can be traced to an electrochemical reaction within the MHP system in which free mobile ions deteriorate the MHP crystalline structure, leading to decomposition and reduced device stability.^{[21]} Thus, in addition to maintaining phase stability, controlling ion migration via a reduction in Nₒ must also be controlled to further enhance the stability of CsPbI₃ devices. The connection between film stress and ion migration is still not well understood.

Embodiments herein describe the role of PVP in mechanical and device stability for CsPbI₃. We describe a reproducible methodology for controlling the phase stability of α-CsPbI₃ while simultaneously tuning the film stress and Nₒ by additive engineering. A series of accelerated tests reveal that thermal cycling from—40 to 85° C., thermal aging at 85° C., and light-induced aging at 1.0 sun AM1.5G illumination all produce negligible bandgap shifts in CsPbI₃ films and minimal differences in ion concentration between PVP-added and PVP-removed CsPbI₃ devices. Furthermore, we show that PVP can be used to create residual compressive stress within the perovskite in addition to improved morphology with the PVP additive and enhanced ambient-air stability.

### Materials and Methods

The perovskite precursor solution was made by mixing cesium iodide (CsI) (Sigma Aldrich, 99.999% pure) and lead iodide (PbI2) (TCI, 99.99% pure). Following literature,^{[8]} a measure of 1 mL, 0.8 molar concentration solution was made by mixing 0.2076 gm of CsI and 0.3688 gm of PbI2 in a solvent of 1:4 dimethyl fluoride (DMF) from Sigma Aldrich and dimethyl sulfoxide (DMSO) from Sigma Aldrich with 200 μL DMF and 800 μL DMSO. A vortex mixer was used for mixing the precursor solution until a clear solution was formed. PVP (Sigma Aldrich, 10,000 average molecular weight) was then added to the precursor solution for films made with PVP, measured by its weight percentage with respect to the solution.

The substrate preparation steps can be, for example, as follows: silica glass or indium tin oxide (ITO)-coated glass from Xin Yan Technologies coating were initially cleaned with an industrial-grade soap solution of extran and water at a ratio of 1:10 for 10 min in an ultrasonic cleaner. After sonication, the ITO-coated glass was cleaned with deionized water and a brush to remove the residual soap. Then, the ITO-coated glass was cleaned with IPA and acetone for 10 min in that order. Finally, the ITO-coated glass was cleaned with UV Ozone treatment for 15 min.

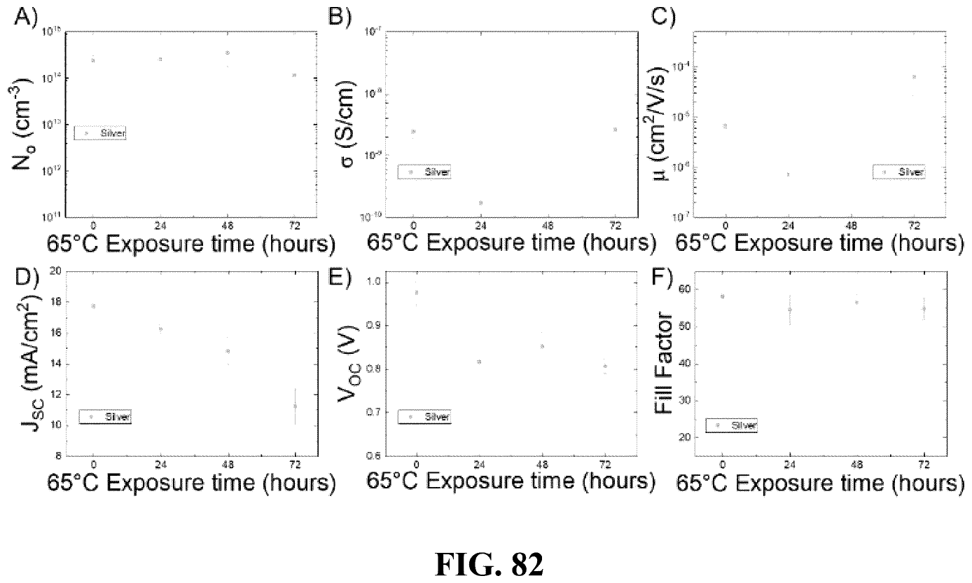

Perovskite on top ITO-coated glass and glass was fabricated using spin coating. The perovskite precursor solution was pre-heated at 60° C. for 5 min before deposition onto the substrate and a subsequent spin coating. 200 μL of perovskite precursor solution was deposited on the cleaned substrate, which was then spin-coated at a speed of 3000 rpm at an acceleration of 1000 rpm/s for 30 s inside an N₂ glovebox. The films were annealed on a hotplate for 5 min at a temperature of 160° C. for films made with the PVP-added precursor and 315° C. for solutions with no added PVP in the precursor. Perovskites with a composition of 0.8M of CsPbI₃+3% PVP were fabricated to quantify ion migration. The architecture of these solar cells were as follows: Glass/ITO/NiOₓ/0.8 M CsPbI₃+3% PVP/C60/Ag. Images of these can be seen in FIG. 82.

The NiOₓ solution for depositing the HTL was prepared by mixing 1M nickel (ii) nitrate hexahydrate (Ni(NO₃)₂·6H₂O) (Sigma Aldrich, 99.999% pure) in 94% ethylene glycol (EG) and 6% ethylene diamine (EDA) from Sigma Aldrich; the vial was then placed in a vortex mixer until it turned into a dark blue color, which indicated the solubilzation of the precursor into the solvent.

Once the substrate preparation is done, perovskite solar cells (PSC) were fabricated in a step-by-step process. The hole trans-port layer (HTL) was formed by depositing 50 μL of NiOₓ onto the cleaned substrate (with the process mentioned about) and spin-coating at a speed of 5000 rpm at an acceleration of 2500 rpm/s for 30 s in ambient air. The HTL layer was then annealed at 315° C. for 1 h. The perovskite absorber layer was formed on top of the HTL layer using the same spin-coating process mentioned above for 3% PVP in 0.8M CsPbI₃. The electron transport layer (ETL) was formed by evaporating 45 nm of C60 (Lumtec) on top of perovskite layer inside an Angstrom evaporator inside an N2 glove box with a custom mask. The top electrode was made by evaporating 100 nm of silver (Ag) on top of the ETL layer through a different custom mask that layered Ag directly above the ITO trace. To quantify film stress, we used a curvature-based laser scanning tool (Tencor FLX-2350FP) to determine changes in surface radii which are then linked with film stress of via Stoney's equation:

$${σ}_{f} = {( \frac{E}{1 - v} )}_{s} \frac{{t}_{s}^{2}}{6 {t}_{f}} {Δ}_{k}$$

where E is Young's Modulus, ν is Poisson's ratio, tₛ and t_{f} are respective the substrate and film thickness, and Δ_{κ} is the change in the substrate's curvature. Silicon wafer substrates were first exposed to UV Ozone for 15 min for cleaning. The thickness of the substrates were then measured using a Keyence VK-X3000 3D Surface Profiler, followed by an initial measurement of substrate curvature, all done in a class 1000 clean room. The precursor solution described herein, deposition method, and spin coating process was done with 0, 3, and 5% PVP on the silicon wafer substrates. The film thicknesses and substrate curvatures were then measured to obtain the stress value due to film deposition. The wafers were then fully submerged in IPA for 1 h to remove PVP from the films. Afterward, the films were left in a controlled N2 environment for >24 h for drying and film thickness and film stress were remeasured to obtain a stress value due to IPA submersion and PVP removal.

Photoluminescence (PL) was measured using an in-house BLACK-Comet UV-Vis Spectrometer from StellarNet with a laser wavelength of 425 nm. CsPbI₃ films with PVP concentrations of 3, 5, 3% submerged in IPA, and 5% submerged in IPA deposited onto ITO-coated glass were aged using an LED solar simulator (Newport) at 1.0 sun AM1.5G in N2 for 96 h. PL measurements were taken at 24 h intervals in ambient air. PVP removal was done in the same way as mentioned above for the specified samples. For thermal cycling, the same PVP compositions were deposited onto ITO-coated glass and encapsulated with a layer of poly methyl methacrylate (PMMA) (spin-coated at 4000 rpm with an acceleration of 1000 rpm/s), EPO-TEK 301 epoxy, and another layer of glass. These samples were placed in a Thermotron environmental chamber with the temperature cycling from—40 to 85° C. The films were exposed to temperature changes for 150 cycles with 50-cycle intervals of ambient air PL measurements.

The ionic property of the CsPbI₃ measured was No. All measurements for No were performed with PAIOS, an all-in-one measurement equipment for photovoltaic devices and LEDs. An LED solar simulator (Newport) was used for aging the PSC at 1.0 sun AM1.5G in N2 and a heating pad was used to age the PSC at 60° C. in an N2 glove box for 96 h with ex-situ measurements on PAIOS at 24 h intervals. PVP removal was done in the same way as mentioned above for the specified PSC. The method for measuring and calculating No were used as described in our work.^{[21]}

The microscope images were captured by using our in-house optical microscope (Olympus) by transilluminating the samples and magnifying with a reference scale of 90 μm 90. External radiative efficiencies (ERE) of the films were measured using a quasi-steady-state PL tool.^{[22]}

### Non-Limiting, Exemplary Results

### Surface Passivation Phase Stability

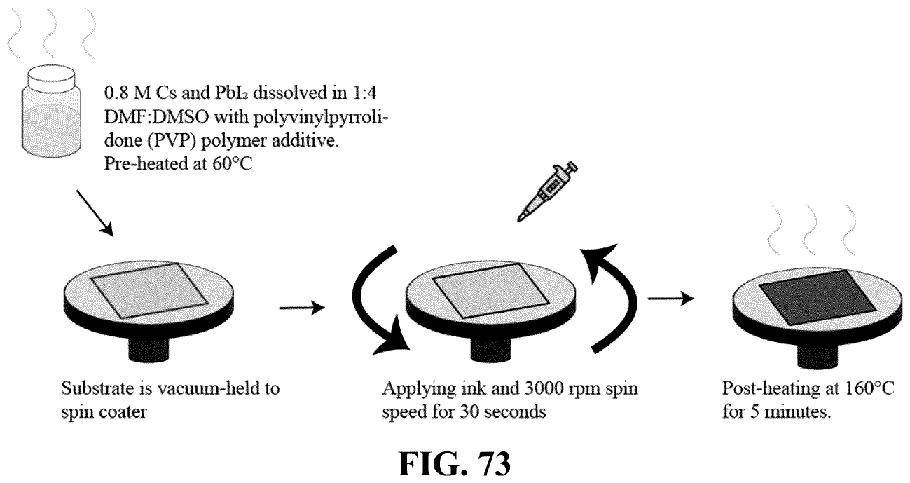

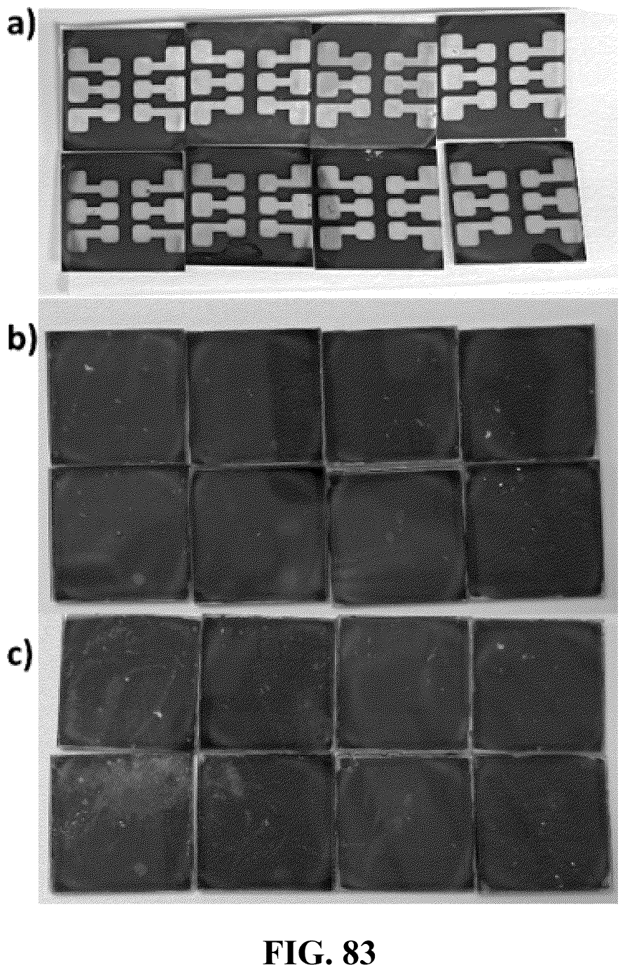

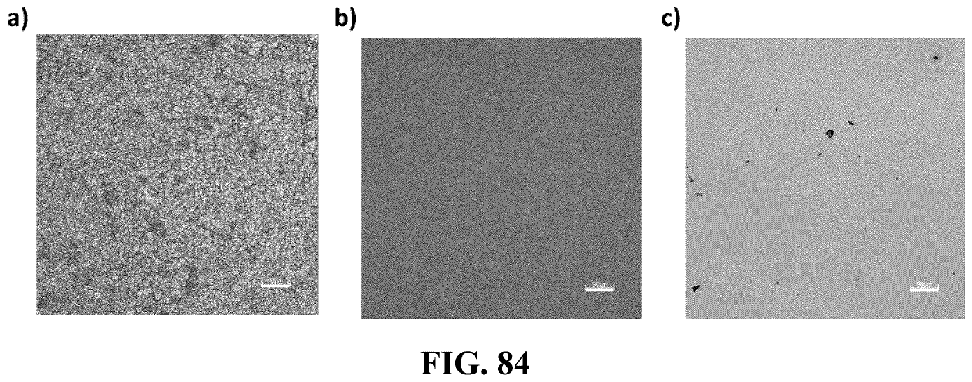

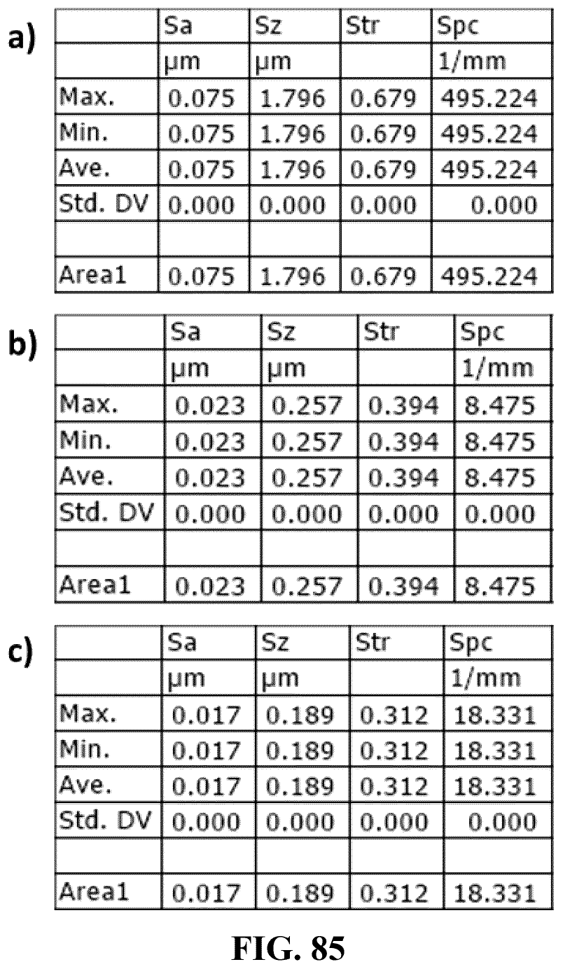

Ambient air stable black-phase CsPbI₃ was formed by introducing PVP in concentrations varying from 0, 3, and 5% into a 0.8M CsI and PbI2 1:4 DMF:DMSO precursor. The precursor was then deposited onto a substrate through a simple one-step spin coating process (FIG. 73). The PVP aided in stabilizing CsPbI₃ during both crystal formation and after cooling to RT in conjunction with improving film morphology and ambient air processability. In FIG. 83, it is shown that both PVP-added CsPbI3 and pure CsPbI3 films demonstrated full coverage on glass. However, FIG. 84 shows that the addition of PVP drastically reduces the film roughness in comparison to pure black phase CsPbI₃ films; 0%-PVP was shown to have an arithmetic mean height (Sa) of 75 nm, whereas 3%-PVP had an Sa of 23 nm, and 5%-PVP CsPbI₃ had an Sa of 17 nm. In pure CsPbI3, films were also visibly rougher with non-uniform features (FIG. 85). With the addition of PVP, the film crystallized with more uniform feature sizes and a smoother morphology. The PVP-added films also required far less crystal formation energy, annealing at 160° C., whereas pure CsPbI₃ required at least 315° C. to crystallize into a black phase. Ambient air stability improved with the addition of PVP, as the films retained their black phase over extensive periods of ambient air exposure, whereas the pure CsPbI₃ films immediately transformed into a yellow, non-photoactive PbI2 phase when exposed to ambient air. Furthermore, film PL improved significantly with an increase in PVP concentration; in Fig. S5, we show that the ERE of PVP-added CsPbI₃ films increased with greater PVP concentrations, reaching up to 2.49% for 12%-PVP, which corresponds to less than 120 mV in quasi-Fermi level splitting from the theoretical Ve maximum.

### Film Stress Study

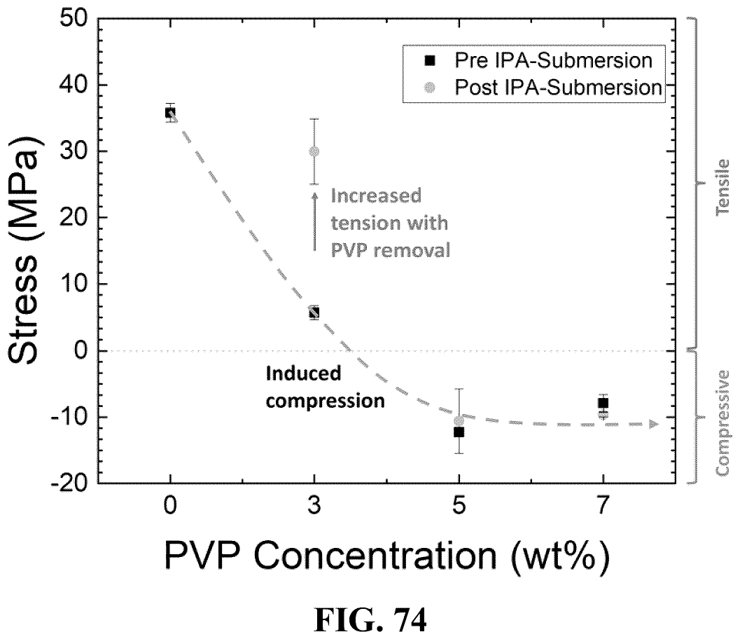

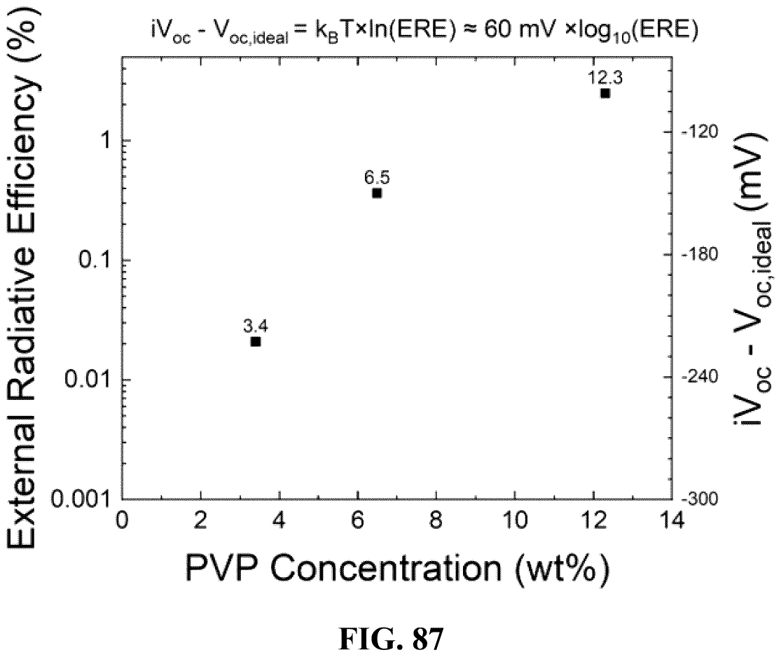

The residual film stresses for 0%-PVP to 5%-PVP are shown in FIG. 74. CsPbI₃ with no PVP had high residual stresses of 35.8±1.0 MPa. This result was expected and is in accordance with previous work on other perovskite compositions (such as CH3NH3PbI3) as a result of the large thermal expansion coefficient mismatch between perovskites and silicon.^{[16-18]} In contrast, 3%-PVP films had significantly reduced residual stresses (5.75±0.53 MPa), and 5%-PVP films were compressive (−12.25±0.15 MPa). This compression can likely be attributed to the combination of a lower crystallization temperature that reduces the thermal stress and a modification of the intrinsic stress of the perovskite[23,24] with the PVP additive, thus indicated a threshold value between tensile and compressive residual stresses lying between 3%-PVP and 5%-PVP in 0.8 M CsPbI₃ films. In FIG. 87, a similar trend was observed when processing with blade coating, demonstrating reduced residual stresses with the increase in PVP concentration and implying that processing techniques did not have a significant impact on residual stresses in relation to the PVP concentrations. However, due to the insulating properties of PVP, CsPbI₃ films fabricated with a PVP additive are often fully submerged to dissolve and remove the PVP from the films with the prospect of improving device and film performance.^{[7]} Upon IPA submersion, we found that the removal of PVP resulted in an increase in residual stress in the CsPbI₃ films. 3%-PVP increased in residual stress magnitude to 30.0±2.8 MPa and 5%-PVP slightly decreased in magnitude to—10.6±4.9 MPa. The lesser impact in the 5%-PVP demonstrates a stability in residual stresses when films were under an induced compression, whereas the large change in magnitudes in the tensile 3%-PVP reflected the variability in stability for tensile films. The change in the magnitude of stress is unexpected and warrants further investigation. Without wishing to be bound by theory, the results indicate that MHP films in compression are more resilient to stress changes than those in tension. However, in FIG. 82, it is clear that the films submerged in IPA did not visually degrade into a yellow phase to attribute any significant degradation. Therefore, the implication is that incorporating PVP as an additive and stress engineering for compression can improve the thermomechanical properties of CsPbI3.

### Thermal and Light Stability Optoelectronic Studies

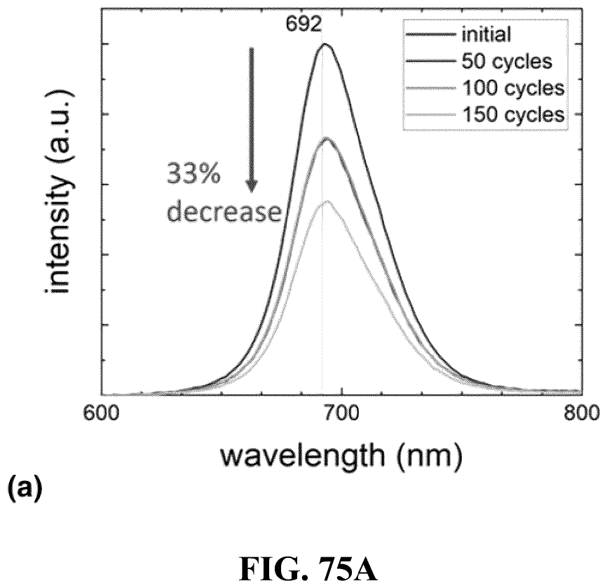

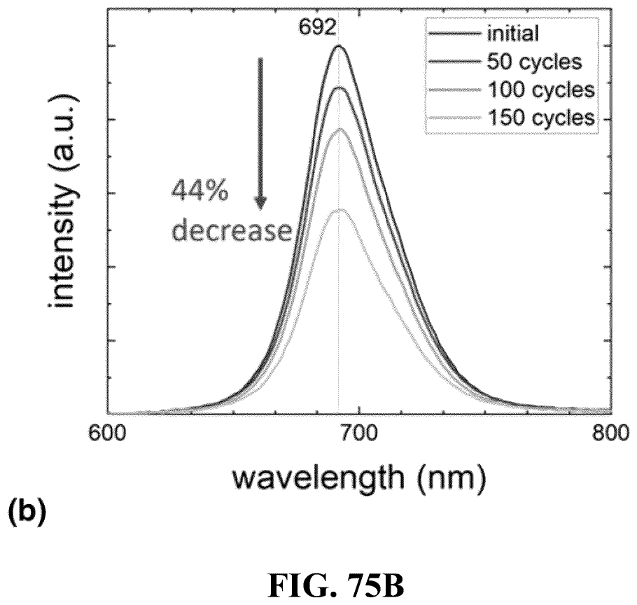

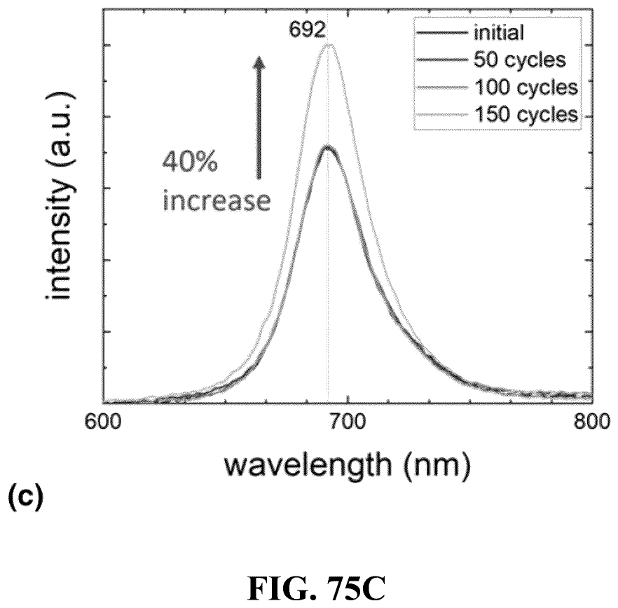

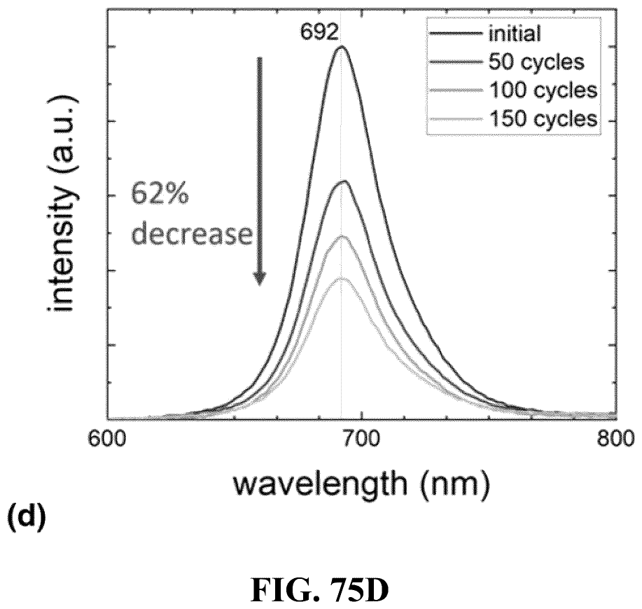

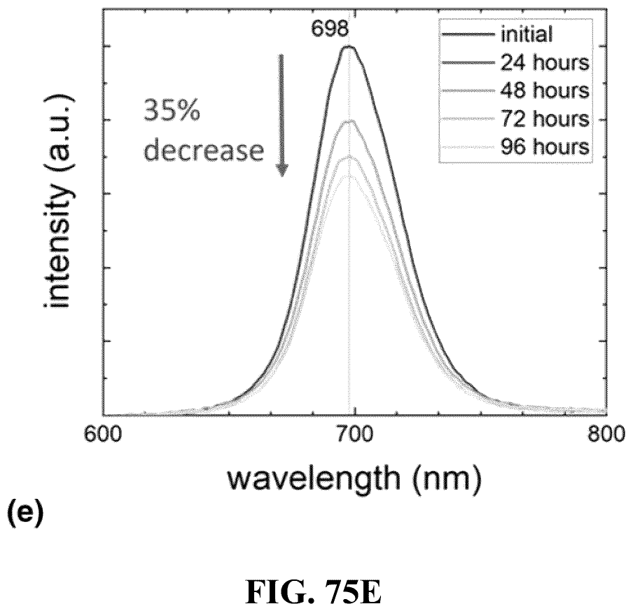

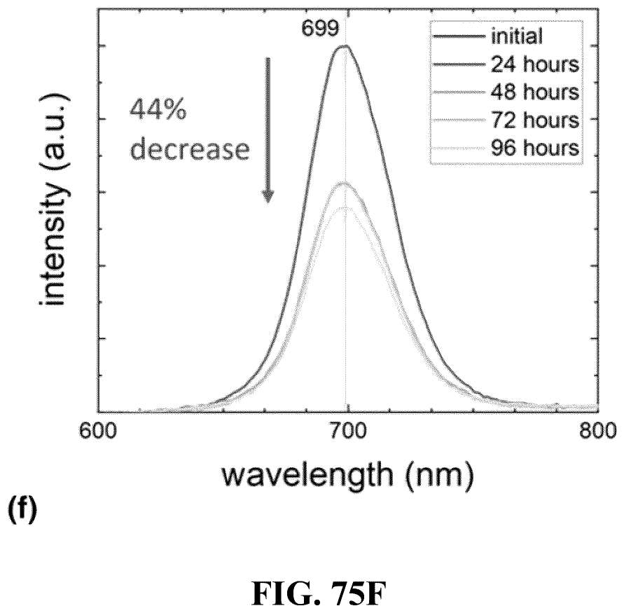

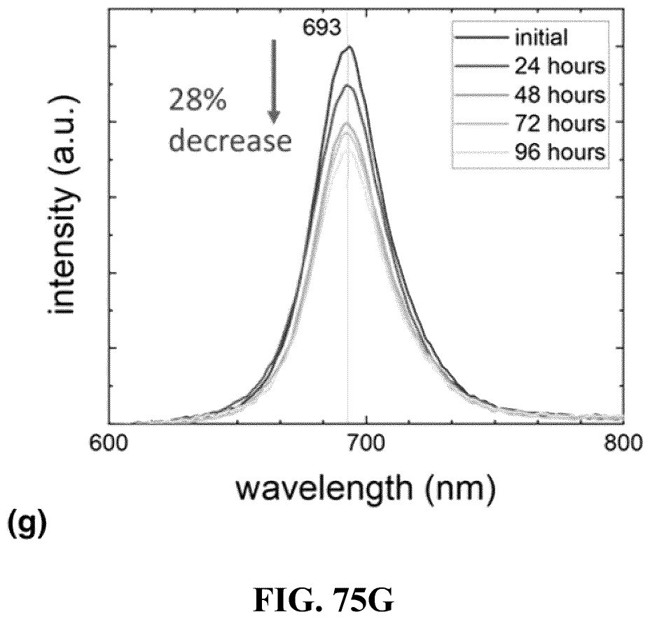

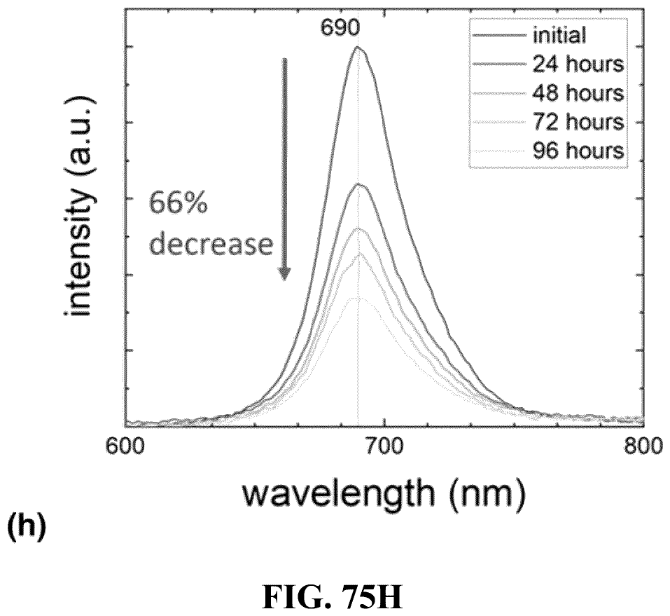

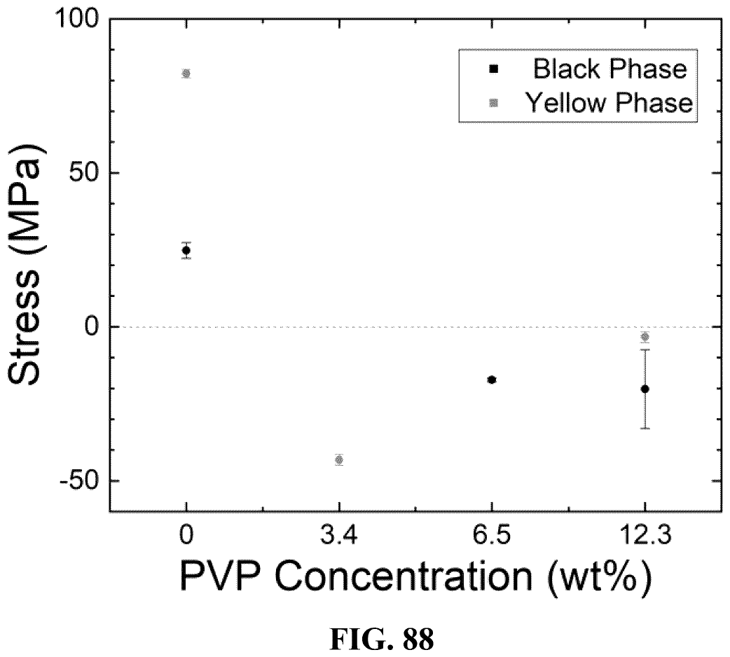

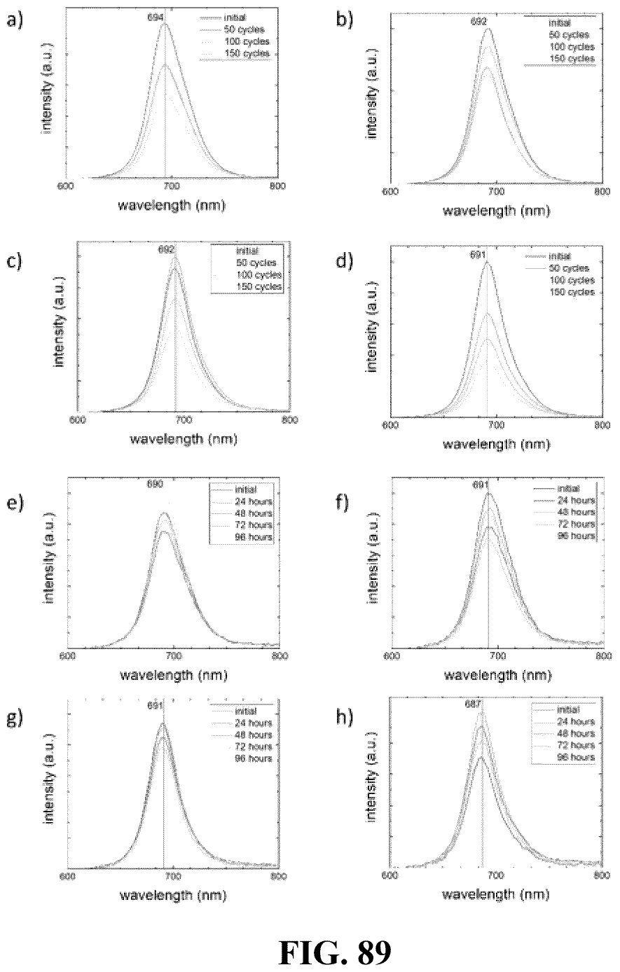

To further understand the impact of PVP on CsPbI₃ film stability, we aged films fabricated with 3%-PVP, 5%-PVP, 3%-PVP immersed in IPA, and 5%-PVP immersed in IPA. Both 3%-PVP and 5%-PVP films were submerged in IPA to determine how films with different PVP concentrations retain their optoelectronic properties after PVP removal. A thermal cycling expo-sure test was done with films both on ITO and silica glass, the latter of which can be found in FIG. 88. FIG. 75A-75H shows the periodic PL measurements of the films that underwent thermal cycling. Here, we found negligible bandgap shifts from any thermal aging, regardless of PVP concentration, therefore demonstrating that PVP removal does not significantly impact the bandgap of the CsPbI₃ films. In FIG. 89, the optical responses improved with 3%-PVP removed films, whereas 3%-PVP retained films decreased under thermal cycling. However, in the 5%-PVP batch of films, the 5%-PVP retained films consistently maintained a higher ratio of the initial PL response when compared to the PL responses of the 5%-PVP removed films after each aging interval. FIG. 75A-75H also shows how PL intensity changes due to light-induced aging. The films that underwent light-induced accelerated aging were deposited on both ITO-coated and silica glass (FIG. 88) but not encapsulated. The films were exposed to 1.0 AM1.5G sun of light exposure in a controlled N2 glovebox for 96 h, with 24-h intervals of ambient in-air measurements. This test revealed slight bandgap shifts due to the substrate, with the samples on ITO-coated glass slightly blue-shifted. (FIG. 88) Additionally, PL intensity in the light-induced aging tended to decrease with longer expo-sures over time, indicating that the optoelectronic properties of the films did degrade due to light-induced aging. In FIG. 89, the ratio between peak intensities at various aging intervals to initial peak intensity reveals a similar behavior between the both 3%-PVP retained and 3%-PVP removed films during light-induced aging, both decreasing over time. Although the magnitudes of the 3%-PVP retained films are slightly lower than the 3%-PVP removed films, they are not significant enough to claim major deviations in optical properties between the films.

### Ion Concentration Studies

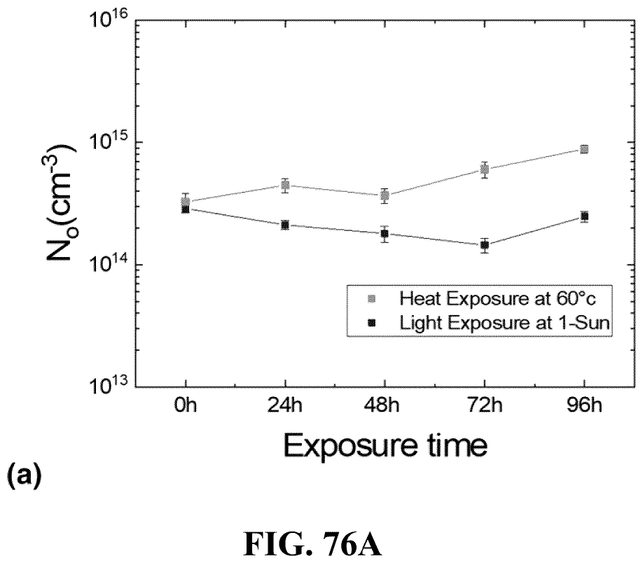

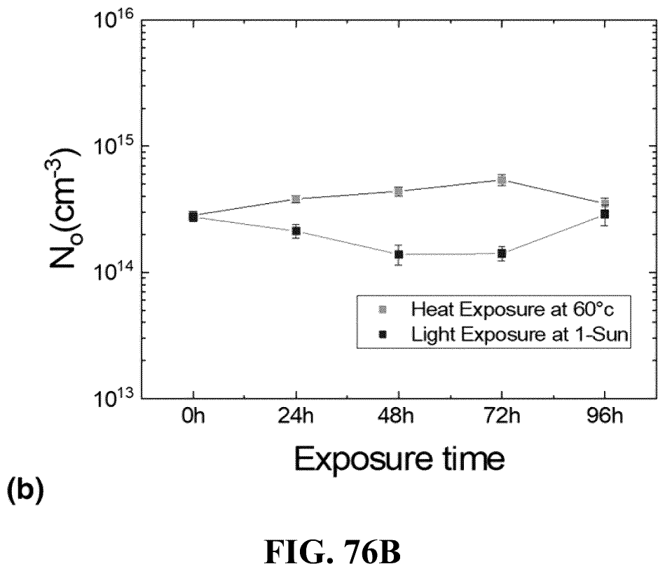

Lastly, ion concentration (N0) measurements were performed on 3%-PVP CsPbI₃ devices (ITO/NiOₓ/PVSK/C60/Ag) before and after the removal of PVP underwent heat and light expo-sures (FIG. 76A-76B). This technique was shown previously to correlate with increased stability for reduced N0 values in perovskites.^{[21]} The Nₒ values were lower than methylammonium lead iodide (MAPbI₃), which has an N0 value of ˜10¹⁵ cm⁻³. The magnitude of the changes in ion behavior was comparable under both exposures for both samples up to 72 h.

### Discussion

Interestingly, a decrease in Nₒ was observed under light exposure while an increase was observed under heat exposure. Without wishing to be bound by theory, this relates to separate degradation mechanisms, whereby metal ions diffuse into the perovskite to increase N0 under heating while the mobile iodine vacancies are gradually depleted from the film under light exposure. The change in behavior at 96 h with heating indicates an acceleration in the loss of iodine vacancies in the case of the PVP-removed perovskite device overtaking the introduction of metal ions.

Without wishing to be bound by theory, increasing the amount of PVP above the threshold value to create compression in the film can both reduce initial ion concentration and the rate of change of ion concentration when aged under either light or heat due to the proven stability induced from the compressive effects of PVP. While removing PVP can enhance device performance, our findings suggest that controlled incorporation of PVP in the CsPbI3 films can enhance the thermomechanical properties of CsPbI3 films with minimal compromise in device efficiency. Previous studies corroborate this, indicating that 5%-PVP largely maintains the same efficiency as 3%-PVP for CsPbI₃.^{[8]}

Our work emphasizes PVP as an additive for improved thermomechanical properties. These properties are essential in mitigating modular delamination and fracture in CsPbI3 devices. To best achieve an optimization between intrinsic stress properties and optoelectrical responses, we propose utilizing 5%-PVP films device stacks. Additionally, we seek to fine-tune film residual stresses via additive engineering optimizing optoelectronic properties through techniques such as deep level transient spectroscopy (DLTS) measurements. DLTS can allow for a comprehensive characterization of deep-level defects induced by thermal cycles or electrical pulses, which is critical to better enhancing device performance by understanding these defects.

### REFERENCES

J. J. Yoo, S. S. Shin, J. Seo, Toward efficient perovskite solar cells: progress, strategies, and perspectives. ACS Energy Lett. 7(6), 2084-2091 (2022). https://doi.org/10.1021/acsenergylett.2c00592
K. Wang et al., All-inorganic cesium lead iodide perovskite solar cells with stabilized efficiency beyond 15%. Nat. Commun. 9(1), 4544 (2018). https://doi.org/10.1038/s41467-018-06915-6
R. Sharma, A. Sharma, S. Agarwal, M. S. Dhaka, Stability and efficiency issues, solutions and advancements in perovskite solar cells: a review. Sol. Energy 244, 516-535 (2022). https://doi.org/10.1016/j.solener.2022.08.001
B. Li et al., Surface passivation engineering strategy to fully-inorganic cubic CsPbI₃ perovskites for high-performance solar cells. Nat. Commun. 9(1), 1076 (2018). https://doi.org/10.1038/s41467-018-03169-0
Z. Li, M. Yang, J.-S. Park, S.-H. Wei, J. J. Berry, K. Zhu, Stabilizing perovskite structures by tuning tolerance factor: formation of formamidinium and cesium lead iodide solid-state alloys. Chem. Mater. 28(1), 284-292 (2016). https://doi.org/10.1021/acs.chemmater.5b04107
P. Yang et al., Improving the phase stability of CsPbI₃ nanocrystalline films via polyvinylpyrrolidone additive engineering for photodetector application. J. Phys. D Appl. Phys. 54(20), 205501 (2021). https://doi.org/10.1088/1361-6463/abe3b2
X. Zhao et al., Accelerated aging of all-inorganic, interface-stabilized perovskite solar cells. Science 377(6603), 307-310 (2022). https://doi.org/10.1126/science.abn5679
T. Ye et al., Below 200° C. fabrication strategy of black-phase CsPbI₃ film for ambient-air-stable solar cells. Solar RRL (2020). https://doi.org/10. 1002/solr.202000014
J. A. Steele et al., Thermal unequilibrium of strained black CsPbI₃ thin films. Science 365(6454), 679-684 (2019). https://doi.org/10.1126/science. aax3878
B. Wang, A. Navrotsky, P. A. Rock, Thermodynamics of cesium lead halide (CsPbX3, ×=I, Br, Cl) perovskites (2020). https://www.elsevier.com/open-access/userlicense/1.0/
E. T. Hoke, D. J. Slotcavage, E. R. Dohner, A. R. Bowring, H. I. Karunadasa, M. D. McGehee, Reversible photo-induced trap formation in mixed-halide hybrid perovskites for photovoltaics. Chem. Sci. 6(1), 613-617 (2015). https://doi.org/10.1039/C4SC03141E
Y. Deng, S. Xu, S. Chen, X. Xiao, J. Zhao, J. Huang, Defect compensation in formamidinium-caesium perovskites for highly efficient solar mini-modules with improved photostability. Nat. Energy 6(6), 633-641 (2021). https://doi.org/10.1038/s41560-021-00831-8
M. Zhang, F. Wu, D. Chi, K. Shi, S. Huang, High-efficiency perovskite solar cells with poly(vinylpyrrolidone)-doped SnO₂ as an electron transport layer. Mater Adv 1(4), 617-624 (2020). https://doi.org/10.1039/DOMA0 0028K
M. Zhong, L. Chai, Y. Wang, J. Di, Enhanced efficiency and stability of perovskite solar cell by adding polymer mixture in perovskite photoactive layer. J. Alloys Compd. 864, 158793 (2021). https://doi.org/10.1016fj.jallcom.2021.158793
D.-H. Kang, C. Ma, N.-G. Park, Antiseptic povidone-iodine heals the grain boundary of perovskite solar cells. ACS Appl. Mater. Interfaces 14(7), 8984-8991 (2022). https://doi.org/10.1021/acsami.1c21479
M. F. Doerner, W. D. Nix, Stresses and deformation processes in thin films on substrates. Crit. Rev. Solid State Mater. Sci. 14(3), 225-268 (1988). https://doi.org/10.1080/10408438808243734
M. Dailey, Y. Li, A. D. Printz, Residual film stresses in perovskite solar cells: origins, effects, and mitigation strategies. ACS Omega 6(45), 30214-30223 (2021). https://doi.org/10.1021/acsomega.1c04814
N. Rolston et al., Engineering stress in perovskite solar cells to improve stability. Adv. Energy Mater. (2018). https://doi.org/10.1002/aenm.20180 2139
J. Zhao et al., Strained hybrid perovskite thin films and their impact on the intrinsic stability of perovskite solar cells. Sci. Adv. (2017). https://doi.org/10.1126/sciadv.aao5616
D.-J. Xue et al., Regulating strain in perovskite thin films through charge-transport layers. Nat. Commun. 11(1), 1514 (2020). https://doi.org/10.1038/s41467-020-15338-1
S. Penukula, R. Estrada Torrejon, N. Rolston, Quantifying and reducing ion migration in metal halide perovskites through control of mobile ions. Molecules 28(13), 5026 (2023). https://doi.org/10.3390/molecules28135026
M. Mahaffey, A. Onno, C. Reich, A. Danielson, W. Sampath, Z. C. Holman, Measuring the absorber doping concentration of Si, CdSeTe, and perovskite solar cells using injection-dependent quasi-steady-state photo-luminescence. IEEE J Photovolt. (2023). https://doi.org/10.1109/JPHOT OV.2023.3313109
H. Liu et al., A 0D additive for flexible all-inorganic perovskite solar cells to go beyond 60,000 flexible cycles. Adv. Mater. (2023). https://doi.org/10.1002/adma.202300302
L. Wang et al., Strain modulation for light-stable n-i-p perovskite/silicon tandem solar cells. Adv. Mater. (2022). https://doi.org/10.1002/adma.202201315

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A method for determining mobile ion characteristics of a material, the method comprising:
attaching the material to a measurement device, wherein the measurement device is configured to administer a stability test to the material, wherein the first test assesses current voltage characteristics, wherein the second test measures transient current response;
determining for each administration of the stability test a mobile ion concentration (Nₒ) of the material using information of the second test;
iteratively administrating the stability test at a series of temperatures increasing at intervals until detecting the material's transition to a failed state using information of the administered stability tests;
identifying at least one of the temperature and corresponding mobile ion concentration (Nₒ) at transition to the failed state as a threshold operating condition of the material.

2. The method of claim 1, wherein each stability test is conducted in a forward bias configuration.

3. The method of claim 1, wherein the first test is conducted at a voltage range of 0-1.5 volts.

4. The method of claim 3, wherein the first test is conducted over a sweep of three light intensity values of 0%, 50%, and 100%.

5. The method of claim 1, wherein the second test is conducted at light intensity of zero.

6. The method of claim 5, wherein the second test comprises sweep offset voltage values of 0, 0.8, and 0.

7. The method of claim 6, wherein the second test is conducted using a light pulse length of 10 milliseconds with a follow up and settling time of 1 millisecond each.

8. The method of claim 7, wherein the first temperature of the series comprises room temperature.

9. The method of claim 8, wherein the interval of increase comprises 10 degrees Kelvin.

10. The method of claim 1, wherein the determining the mobile ion concentration (Nₒ) comprises isolating a negative current response in the transient current response graph.

11. The method of claim 10, wherein the determining the mobile ion concentration (Nₒ) comprises replotting the negative current response graph to plot drift current by time.

12. The method of claim 11, wherein the determining the mobile ion concentration (Nₒ) comprises integrating the replotted graph to determine ionic charge (Qᵢₒₙ).

13. The method of claim 12, wherein the determining the mobile ion concentration (Nₒ) comprises solving the following equation:
$${Q}_{i o n} = \frac{\sqrt{q {N}_{o} {ε}_{o} {ε}_{r} {V}_{T}}}{8} * [ \sqrt{1 + 16 * ( \frac{{V}_{b i}}{{V}_{T}} )} - \sqrt{1 + 16 * \frac{{V}_{b i} - {V}_{a p p}}{{V}_{T}}} ]$$
wherein q comprises electronic charge,
wherein εₒ comprises permittivity of free space,
wherein εᵣ comprises permittivity of material,
wherein V_{T} comprises thermal voltage (0.026),
wherein V_{bi} comprises built in potential (1.2V), and
wherein Vₐₚₚ comprises applied bias (0.8V).

14. The method of claim 1, wherein the failed state comprises a current (mA)/voltage (V) plot with substantially constant slope.

15. The method of claim 1, wherein the failed state comprises a square wave current (mA)/time (μS) plot.

16. The method of claim 1, wherein the stability test comprises a third test, wherein the third test is a repeat of the first test, wherein the third test assesses changes in the material's current voltage characteristics after administration of the second test, wherein the third test comprises a repeat of the first test, wherein the detecting the material's transition to a failed state uses information of the third test.

17. The method of claim 1, wherein the material comprises a perovskite solar cell.

18. The method of claim 1, wherein the material comprises a memristor.

19. The method of claim 1, wherein the material comprises mining ore.

20. The method of claim 1, wherein the material comprises battery material.
